(19) United States
(12) Patent Application Publication
(10) Pub. No.: US 2026/0313533 A1
(43) Pub. Date: Oct. 8, 2026

(54) METHOD AND APPARATUS AND FOR SUPPORTING NETWORK ENERGY SAVING IN WIRELESS COMMUNICATION SYSTEM

(71) Applicant: SAMSUNG ELECTRONICS CO., LTD., Suwon-si, Gyeonggi-do (KR)

(72) Inventors: Yanru WANG, Beijing (CN); Lixiang XU, Beijing (CN)

(21) Appl. No.: 18/880,751

(22) PCT Filed: Aug. 3, 2023
(86) PCT No.: PCT/KR2023/011418

§ 371 Date: Jan. 2, 2025

(30) Foreign Application Priority Data
Aug. 5, 2022 (CN) 202210939309.1
Sep. 23, 2022 (CN) 202211168225.9
Oct. 11, 2022 (CN) 202211243196.8
Nov. 11, 2022 (CN) 202211414286.9
Feb. 15, 2023 (CN) 202310125997.2

(51) Int. Cl. H04W 52/02

(52) U.S. Cl. CPC H04W 52/0206

(57) ABSTRACT

The disclosure relates to a 5G or 6G communication system for supporting a higher data transmission rate. The present disclosure provides a node in a wireless communication system and a method performed by the same. A method performed by a first node in a wireless communication system according to embodiments of the present disclosure includes: receiving a second message from a second node, wherein the second message includes a network energy saving configuration; and transmitting a fifth message to a user equipment based on receiving the second message. The methods performed by a first node and/or a second node in a wireless communication system provided by the present disclosure can enable the network side to update configuration to achieve a purpose of energy saving by exchanging network energy saving configuration and/or network energy saving related information used for a request to activate a network in an energy saving state and/or deactivate a network in a non-energy saving state between nodes.

### TECHNICAL FIELD

The present disclosure relates to a technical field of wireless communication. More specifically, the present disclosure relates to a node in a wireless communication system and a method performed by the same.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz (THz) bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources. activate

### DISCLOSURE OF INVENTION

### Technical Problem

Currently, there are needs to enhance supporting network energy saving in a wireless communication system.

### Solution to Problem

Embodiments of the present disclosure provide a method performed by a first node in a wireless communication system, including: receiving a second message from a second node, wherein the second message includes a network energy saving configuration; and transmitting a fifth message to a user equipment based on receiving the second message.

Embodiments of the present disclosure provide a method performed by a second node in a wireless communication system, including: transmitting a second message to a first node, wherein the second message includes a network energy saving configuration; wherein the first node transmits a fifth message to a user equipment based on receiving the second message.

Embodiments of the present disclosure provide a method performed by a first node in a wireless communication system, including: receiving, from a second node, at least one message of a second message including a network energy saving configuration and a third message including a request to activate a network in an energy saving state and/or deactivate a network in a non-energy saving state, wherein the at least one message is associated with at least one of the second node and other nodes except the second node.

Embodiments of the present disclosure provide a method performed by a second node in a wireless communication system, including: transmitting, to a first node, at least one message of a second message including a network energy saving configuration and a third message including a request to activate a network in an energy saving state and/or deactivate a network in a non-energy saving state, wherein the at least one message is associated with at least one of the second node and other nodes except the second node.

Embodiments of the present disclosure provide a first node in a wireless communication system, including a transceiver configured to transmit and receive signals; and a processor coupled to the transceiver and configured to perform methods performed by a first node in a wireless communication system according to embodiments of the present disclosure.

Embodiments of the present disclosure provide a second node in a wireless communication system, including a transceiver configured to transmit and receive signals; and a processor coupled to the transceiver and configured to perform methods performed by a second node in a wireless communication system according to embodiments of the present disclosure.

Embodiments of the present disclosure provide a computer-readable medium having stored thereon computer-readable instructions which, when executed by a processor, are used to implement methods performed by a first node and/or a second node in a wireless communication system according to embodiments of the present disclosure.

The methods performed by a first node and/or a second node in a wireless communication system provided by the present disclosure can enable the network side to update configuration to achieve a purpose of energy saving by exchanging network energy saving configuration and/or network energy saving related information used for a request to activate a network in an energy saving state and/or deactivate a network in a non-energy saving state between nodes.

### Advantageous Effects of Invention

According to various embodiments of the disclosure, supporting network energy saving in a wireless communication system can be efficiently enhanced.

### BRIEF DESCRIPTION OF DRAWINGS

The above and other aspects, features and advantages of certain embodiments of the present disclosure will be more apparent from the following description taken in con-junction with the accompanying drawings, in which:

FIG. 1 is an exemplary system architecture 100 of System Architecture Evolution (SAE);

FIG. 2 is an exemplary system architecture 200 according to various embodiments of the present disclosure;

FIG. 3A shows a flowchart of a method 300 performed by a first node in a wireless communication system according to embodiments of the present disclosure;

FIG. 3B shows a flowchart of a method 310 performed by a second node in a wireless communication system according to embodiments of the present disclosure;

FIG. 4A shows a flowchart of a method 400 performed by a first node in a wireless communication system according to embodiments of the present disclosure;

FIG. 4B shows a flowchart of a method 410 performed by a second node in a wireless communication system according to embodiments of the present disclosure;

FIG. 5A shows a schematic diagram of an aspect of a method for supporting network energy saving according to embodiments of the present disclosure;

FIG. 5B shows a schematic diagram of an aspect of a method for supporting network energy saving according to embodiments of the present disclosure;

FIG. 5C shows a schematic diagram of an aspect of a method for supporting network energy saving according to embodiments of the present disclosure;

FIG. 5D shows a schematic diagram of an aspect of a method for supporting network energy saving according to embodiments of the present disclosure;

FIG. 6A shows a schematic diagram of an aspect of a method for supporting network energy saving according to embodiments of the present disclosure;

FIG. 6B shows a schematic diagram of an aspect of a method for supporting network energy saving according to embodiments of the present disclosure;

FIG. 6C shows a schematic diagram of an aspect of a method for supporting network energy saving according to embodiments of the present disclosure;

FIG. 6D shows a schematic diagram of an aspect of a method for supporting network energy saving according to embodiments of the present disclosure;

FIG. 7A shows a schematic diagram of an aspect of a method for supporting network energy saving according to embodiments of the present disclosure;

FIG. 7B shows a schematic diagram of an aspect of a method for supporting network energy saving according to embodiments of the present disclosure;

FIG. 7C shows a schematic diagram of an aspect of a method for supporting network energy saving according to embodiments of the present disclosure;

FIG. 8 shows a schematic diagram of a first node 800 according to embodiments of the present disclosure;

FIG. 9 shows a schematic diagram of a second node 900 according to embodiments of the present disclosure;

FIG. 10 illustrates a block diagram of a terminal (or a user equipment (UE)), according to embodiments of the present disclosure; and

FIG. 11 illustrates a block diagram of a base station (BS), according to embodiments of the present disclosure.

FIG. 12 is a block diagram illustrating a structure of a network entity according to an embodiment of the disclosure.

### BEST MODE FOR CARRYING OUT THE INVENTION

In order to meet an increasing demand for wireless data communication services since a deployment of 4G communication system, efforts have been made to develop an improved 5G or pre- 5G communication system. Therefore, the 5G or pre-5G communication system is also called “beyond 4G network” or “post LTE system”.

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

The prior art does not support various forms of energy saving, so an enhanced method is needed to support various forms of energy saving.

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

Embodiments of the present disclosure provide a method performed by a first node in a wireless communication system, including: receiving a second message from a second node, wherein the second message includes a network energy saving configuration; and transmitting a fifth message to a user equipment based on receiving the second message.

According to embodiments of the present disclosure, the method performed by a first node in a wireless communication system further includes: transmitting a first message to the second node, wherein the first message includes a request for the network energy saving configuration, wherein the second message is transmitted to the first node by the second node based on the first message.

According to embodiments of the present disclosure, the method performed by a first node in a wireless communication system further includes: transmitting a fifth message to a third node based on receiving the second message.

According to embodiments of the present disclosure, the fifth message includes an activation time of the network energy saving configuration.

According to embodiments of the present disclosure, the user equipment performs uplink transmission and/or downlink reception based on the activation time of the network energy saving configuration.

According to embodiments of the present disclosure, the third node performs network energy saving configuration updating of the third node based on the activation time of the network energy saving configuration, the network energy saving configuration updating of the third node including one or more of the following: entering and/or exiting an energy saving state based on the activation time; calculating and/or adjusting transmission power of the third node in advance based on the activation time.

According to embodiments of the present disclosure, the method performed by a first node in a wireless communication system further includes: receiving a third message from the user equipment, wherein the third message includes a request to activate a network in an energy saving state and/or deactivate a network in a non-energy saving state.

According to embodiments of the present disclosure, the method performed by a first node in a wireless communication system further includes: transmitting a request to activate a network in an energy saving state and/or deactivate a network in a non-energy saving state to at least one of the second node or a third node.

According to embodiments of the present disclosure, the method performed by a first node in a wireless communication system further includes: receiving a fourth message from at least one of the second node or the third node; and transmitting the fourth message to the user equipment, wherein the fourth message includes a response to the request to activate a network in an energy saving state and/or deactivate a network in a non-energy saving state.

According to embodiments of the present disclosure, the method performed by a first node in a wireless communication system further includes: receiving an eighth message from the second node, wherein the eighth message includes network performance of at least one of the second node or the third node, wherein the eighth message includes one or more of the following: reporting content and event that triggers reporting.

According to embodiments of the present disclosure, the method performed by a first node in a wireless communication system further includes: transmitting a sixth message to the second node, wherein the sixth message includes a request for network performance of at least one of the second node or the third node, wherein the eighth message is transmitted to the first node by the second node based on the sixth message, wherein the sixth message includes one or more of the following: identification of network performance request, scope corresponding to network performance request, reporting mode, reporting registration request, reporting interval, trigger event, reporting request information for predicted network performance, and requested reporting content.

According to embodiments of the present disclosure, the method performed by a first node in a wireless communication system further includes: receiving a seventh message from the second node, wherein the seventh message includes a response to the request for network performance of at least one of the second node or the third node, wherein the seventh message includes one or more of the following: scope corresponding to content that can be reported, content that can be reported, scope corresponding to content that cannot be reported, content that cannot be reported, and cause for request failure.

According to embodiments of the present disclosure, the method performed by a first node in a wireless communication system further includes: making a network energy saving and/or self-optimization decision based on the network performance of at least one of the second node or the third node.

According to embodiments of the present disclosure, the method performed by a first node in a wireless communication system further includes: making a network self-optimization decision based on the network energy saving configuration, wherein the network self-optimization decision includes at least one of network energy saving, load balancing, coverage optimization, mobility optimization and/or management, network configuration determination and/or network configuration updating.

According to embodiments of the present disclosure, the first message includes one or more of the following: identification of network energy saving configuration request, applicable scope of network energy saving configuration requested to be reported, reporting mode, reporting registration request, reporting interval, trigger event, reporting request information for predicted energy saving configuration, requested reporting content, request to set energy saving configuration autonomously, reporting request for information related to wake-up signal configuration, reporting request for information related to a configuration about whether to wake up after receiving a wake-up signal, reporting request for information related to a signal quality of a received wake-up signal, reporting request for information related to whether to wake up, reporting request for whether wake-up is requested, reporting request for that a wake-up operation is requested not to be performed, reporting request for an activation and/or applicable time of a configuration.

According to embodiments of the present disclosure, the second message includes one or more of the following: reporting content and event that triggers reporting.

According to embodiments of the present disclosure, the third message includes one or more of the following: activation identification, scope corresponding to an activation request, configuration requested for activation, condition for triggering activation, activation time, deactivation identification, scope corresponding to a deactivation request, configuration requested for deactivation, condition for triggering deactivation, deactivation time, suggested and/or requested energy saving related state and/or mode, configuration change identification, suggested and/or requested configuration, time corresponding to a configuration, suggested and/or requested energy saving configuration mode, triggering condition corresponding to application of a configuration, coverage state change identification, suggested and/or requested coverage state, scope corresponding to suggested and/or requested coverage state, time of change of a coverage state, triggering condition for coverage change, source of activation and/or deactivation and/or a request, cause for activation and/or deactivation and/or a request.

According to embodiments of the present disclosure, the fourth message includes one or more of the following: activation identification, corresponding scope that can be activated, configuration that can be activated, time that can be activated, entered energy saving related state and/or mode, time corresponding to an entered energy saving related state and/or mode, corresponding scope that is activated, activated configuration, activated time, energy saving configuration mode information, corresponding scope that cannot be activated, configuration that cannot be activated, deactivation identification, corresponding scope that can be deactivated, configuration that can be deactivated, time that can be deactivated, corresponding scope that is deactivated, deactivated configuration, deactivated time, corresponding scope that cannot be deactivated, configuration that cannot be deactivated, cause for “inactivatable”, configuration change identification, configuration that can be applied, application time corresponding to configuration that can be applied, trigger condition for triggering configuration application, configuration that cannot be applied, applied configuration, coverage state change identification, coverage state that can be changed, scope corresponding to a coverage state that can be changed, time of coverage state change, changed coverage state, scope corresponding to a changed coverage state, condition for triggering coverage change, coverage state that cannot be changed and scope corresponding to a coverage state that cannot be changed.

Embodiments of the present disclosure provide a method performed by a second node in a wireless communication system, including: transmitting a second message to a first node, wherein the second message includes a network energy saving configuration; wherein the first node transmits a fifth message to a user equipment based on receiving the second message.

Embodiments of the present disclosure provide a method performed by a first node in a wireless communication system, including: receiving, from a second node, at least one message of a second message including a network energy saving configuration and a third message including a request to activate a network in an energy saving state and/or deactivate a network in a non-energy saving state, wherein the at least one message is associated with at least one of the second node and other nodes except the second node.

According to embodiments of the present disclosure, the method performed by a first node in a wireless communication system further includes: transmitting a first message including a request for the network energy saving configuration to the second node, wherein the second message is transmitted to the first node by the second node based on the first message.

According to embodiments of the present disclosure, the method performed by a first node in a wireless communication system further includes: transmitting a fourth message including a response to the request to activate a network in an energy saving state and/or deactivate a network in a non-energy saving state to the second node based on receiving the third message.

According to embodiments of the present disclosure, the method performed by a first node in a wireless communication system further includes: making a network self-optimization decision based on the at least one message, wherein the network self-optimization decision includes at least one of network energy saving, load balancing, coverage optimization, mobility optimization and/or management, network configuration determination and/or network configuration updating.

According to embodiments of the present disclosure, the first message includes one or more of the following: transmitting node identification, receiving node identification, identification of network energy saving configuration request, applicable scope of network energy saving configuration requested to be reported, reporting mode, reporting registration request, reporting interval, trigger event, reporting request information for predicted energy saving configuration, requested reporting content, request to set energy saving configuration autonomously, reporting request for information related to wake-up signal configuration, reporting request for information related to a configuration about whether to wake up after receiving a wake-up signal, reporting request for information related to a signal quality of a received wake-up signal, reporting request for information related to whether to wake up, reporting request for whether wake-up is requested, reporting request for that a wake-up operation is requested not to be performed, reporting request for an activation and/or applicable time of a configuration.

According to embodiments of the present disclosure, the second message includes one or more of the following: transmitting node identification, receiving node identification, reporting content, event that triggers reporting, settings of setting energy saving configuration autonomously, information related to wake-up signal configuration, information related to a configuration about whether to wake up after receiving a wake-up signal, information related to a signal quality of a received wake-up signal, indication of whether to wake up, indication of whether to request wake-up, indication of requesting not to perform a wake-up operation, activation and/or applicable time of a configuration.

According to embodiments of the present disclosure, the third message includes one or more of the following: transmitting node identification, receiving node identification, activation identification, scope corresponding to an activation request, configuration requested for activation, condition for triggering activation, activation time, deactivation identification, scope corresponding to a deactivation request, configuration requested for deactivation, condition for triggering deactivation, deactivation time, suggested and/or requested energy saving related state and/or mode, configuration change identification, suggested and/or requested configuration, time corresponding to a configuration, suggested and/or requested energy saving configuration mode, triggering condition corresponding to application of a configuration, coverage state change identification, suggested and/or requested coverage state, scope corresponding to suggested and/or requested coverage state, time of change of a coverage state, triggering condition for coverage change, source of activation and/or deactivation and/or a request, cause for activation and/or deactivation and/or a request, interface instance indication.

According to embodiments of the present disclosure, the fourth message includes one or more of the following: transmitting node identification, receiving node identification, activation identification, corresponding scope that can be activated, configuration that can be activated, time that can be activated, entered energy saving related state and/or mode, time corresponding to an entered energy saving related state and/or mode, corresponding scope that is activated, activated configuration, activated time, energy saving configuration mode information, corresponding scope that cannot be activated, configuration that cannot be activated, deactivation identification, corresponding scope that can be deactivated, configuration that can be deactivated, time that can be deactivated, corresponding scope that is deactivated, deactivated configuration, deactivated time, corresponding scope that cannot be deactivated, configuration that cannot be deactivated, interface instance indication, cause for “inactivatable”, configuration change identification, configuration that can be applied, application time corresponding to configuration that can be applied, trigger condition for triggering configuration application, configuration that cannot be applied, applied configuration, coverage state change identification, coverage state that can be changed, scope corresponding to a coverage state that can be changed, time of coverage state change, changed coverage state, scope corresponding to a changed coverage state, condition for triggering coverage change, coverage state that cannot be changed and scope corresponding to a coverage state that cannot be changed.

Embodiments of the present disclosure provide a method performed by a second node in a wireless communication system, including: transmitting, to a first node, at least one message of a second message including a network energy saving configuration and a third message including a request to activate a network in an energy saving state and/or deactivate a network in a non-energy saving state, wherein the at least one message is associated with at least one of the second node and other nodes except the second node.

According to embodiments of the present disclosure, the method performed by a second node in a wireless communication system further includes: receiving a first message including a request for the network energy saving configuration from the first node, and transmitting the second message to the first node based on the first message.

According to embodiments of the present disclosure, the method performed by a second node in a wireless communication system further includes: receiving a fourth message including a response to the request to activate a network in an energy saving state and/or deactivate a network in a non-energy saving state from the first node, wherein the fourth message is transmitted to the second node by the first node based on the third message.

According to embodiments of the present disclosure, the at least one message is used for the first node to make a network self-optimization decision, wherein the network self-optimization decision includes at least one of network energy saving, load balancing, coverage optimization, mobility optimization and/or management, network configuration determination and/or network configuration updating.

According to embodiments of the present disclosure, the first message includes one or more of the following: transmitting node identification, receiving node identification, identification of network energy saving configuration request, applicable scope of network energy saving configuration requested to be reported, reporting mode, reporting registration request, reporting interval, trigger event, reporting request information for predicted energy saving configuration, requested reporting content, request to set energy saving configuration autonomously, reporting request for information related to wake-up signal configuration, reporting request for information related to a configuration about whether to wake up after receiving a wake-up signal, reporting request for information related to a signal quality of a received wake-up signal, reporting request for information related to whether to wake up, reporting request for whether wake-up is requested, reporting request for that a wake-up operation is requested not to be performed, reporting request for an activation and/or applicable time of a configuration.

According to embodiments of the present disclosure, the second message includes one or more of the following: transmitting node identification, receiving node identification, reporting content, event that triggers reporting, settings of setting energy saving configuration autonomously, information related to wake-up signal configuration, information related to a configuration about whether to wake up after receiving a wake-up signal, information related to a signal quality of a received wake-up signal, indication of whether to wake up, indication of whether to request wake-up, indication of requesting not to perform a wake-up operation, activation and/or applicable time of a configuration.

According to embodiments of the present disclosure, the third message includes one or more of the following: transmitting node identification, receiving node identification, activation identification, scope corresponding to an activation request, configuration requested for activation, condition for triggering activation, activation time, deactivation identification, scope corresponding to a deactivation request, configuration requested for deactivation, condition for triggering deactivation, deactivation time, suggested and/or requested energy saving related state and/or mode, configuration change identification, suggested and/or requested configuration, time corresponding to a configuration, suggested and/or requested energy saving configuration mode, triggering condition corresponding to application of a configuration, coverage state change identification, suggested and/or requested coverage state, scope corresponding to suggested and/or requested coverage state, time of change of a coverage state, triggering condition for coverage change, source of activation and/or deactivation and/or a request, cause for activation and/or deactivation and/or a request, interface instance indication.

According to embodiments of the present disclosure, the fourth message includes one or more of the following: transmitting node identification, receiving node identification, activation identification, corresponding scope that can be activated, configuration that can be activated, time that can be activated, entered energy saving related state and/or mode, time corresponding to an entered energy saving related state and/or mode, corresponding scope that is activated, activated configuration, activated time, energy saving configuration mode information, corresponding scope that cannot be activated, configuration that cannot be activated, deactivation identification, corresponding scope that can be deactivated, configuration that can be deactivated, time that can be deactivated, corresponding scope that is deactivated, deactivated configuration, deactivated time, corresponding scope that cannot be deactivated, configuration that cannot be deactivated, interface instance indication, cause for “inactivatable”, configuration change identification, configuration that can be applied, application time corresponding to configuration that can be applied, trigger condition for triggering configuration application, configuration that cannot be applied, applied configuration, coverage state change identification, coverage state that can be changed, scope corresponding to a coverage state that can be changed, time of coverage state change, changed coverage state, scope corresponding to a changed coverage state, condition for triggering coverage change, coverage state that cannot be changed and scope corresponding to a coverage state that cannot be changed.

Embodiments of the present disclosure provide a first node in a wireless communication system, including a transceiver configured to transmit and receive signals; and a processor coupled to the transceiver and configured to perform methods performed by a first node in a wireless communication system according to embodiments of the present disclosure.

Embodiments of the present disclosure provide a second node in a wireless communication system, including a transceiver configured to transmit and receive signals; and a processor coupled to the transceiver and configured to perform methods performed by a second node in a wireless communication system according to embodiments of the present disclosure.

Embodiments of the present disclosure provide a computer-readable medium having stored thereon computer-readable instructions which, when executed by a processor, are used to implement methods performed by a first node and/or a second node in a wireless communication system according to embodiments of the present disclosure.

The methods performed by a first node and/or a second node in a wireless communication system provided by the present disclosure can enable the network side to update configuration to achieve a purpose of energy saving by exchanging network energy saving configuration and/or network energy saving related information used for a request to activate a network in an energy saving state and/or deactivate a network in a non-energy saving state between nodes.

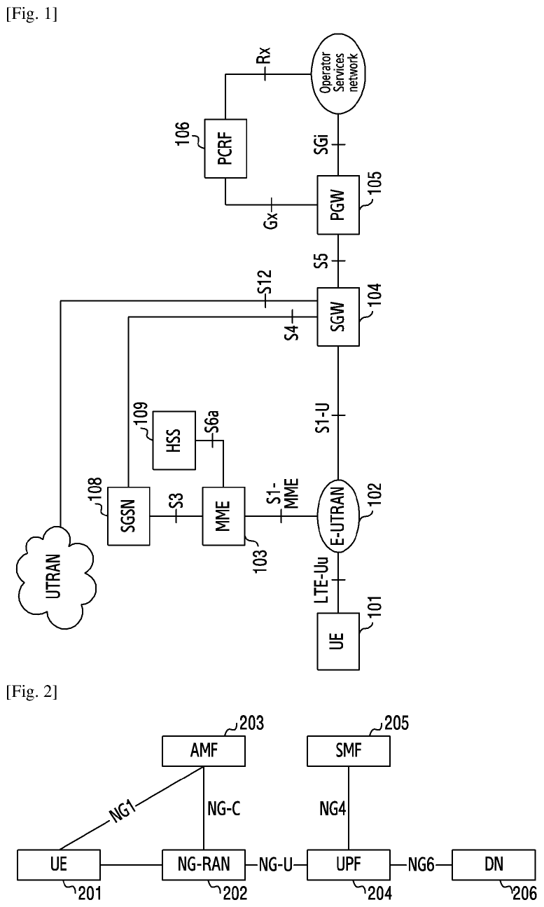

FIGS. 1 to 8 discussed below and various embodiments for describing the principles of the present disclosure in this patent document are only for illustration and should not be interpreted as limiting the scope of the present disclosure in any way. Those skilled in the art will understand that the principles of the present disclosure can be implemented in any suitably arranged system or device.

FIG. 1 is an exemplary system architecture 100 of system architecture evolution (SAE). User equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QOS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting user information including a current location of the user equipment, an address of a serving node, user security information, and packet data context of the user equipment, etc.

FIG. 2 is an exemplary system architecture 200 according to various embodiments of the present disclosure. Other embodiments of the system architecture 200 can be used without departing from the scope of the present disclosure.

User equipment (UE) 201 is a terminal device for receiving data. A next generation radio access network (NG-RAN) 202 is a radio access network, which includes a base station (a gNB or an eNB connected to 5G core network 5GC, and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties.

Nodes mentioned in the present disclosure may include gNB, gNB Central Unit (gNB-CU), gNB Distributed Unit (gNB-DU), gNB-CU-Control Plane (gNB CU-CP), gNB-CU-User Plane (gNB CU-UP), en-gNB, eNB, ng-eNB, UE, access and Mobility Management Function (AMF), Session Management Function (SMF), Mobility Management Entity (MME) and other network entities or network logic units.

The signal strength and/or signal quality mentioned in the present disclosure may be a Received Signal Strength Indicator (RSSI), Reference Signal Receiving Power (RSRP), Reference Signal Receiving Quality (RSRQ), Signal to Interference plus Noise Ratio (SINR), etc.

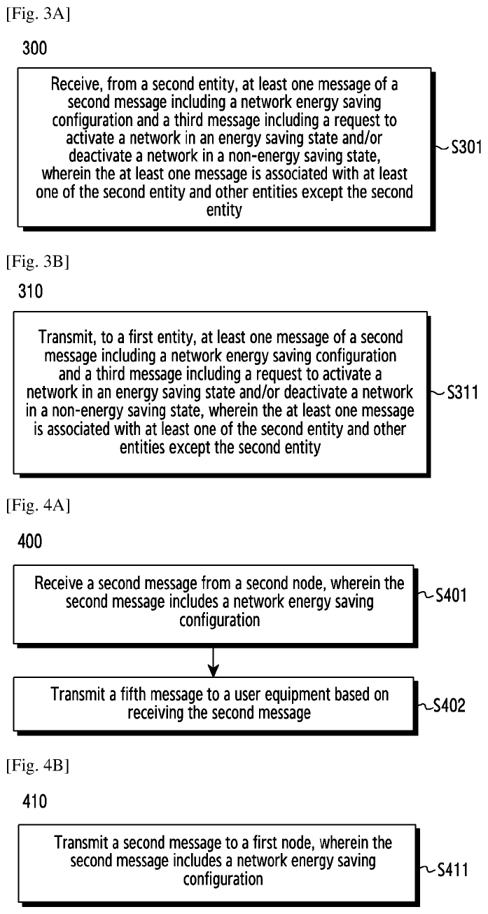

Next, FIG. 3A shows a flowchart of a method 300 performed by a first node in a wireless communication system according to embodiments of the present disclosure.

As shown in FIG. 3A, in step S301, a method 300 performed by a first node in a wireless communication system according to embodiments of the present disclosure may include: receiving, from a second node, at least one message of a second message including a network energy saving configuration and a third message including a request to activate a network in an energy saving state and/or deactivate a network in a non-energy saving state. In some implementations, the at least one message may be associated with at least one of the second node and other nodes other than the second node. For example, the network energy saving configuration received from the second node may be a network energy saving configuration of the second node and/or a network energy saving configuration of any other node collected or acquired by the second node in any way. For example, the request to activate a network in an energy saving state and/or deactivate a network in a non-energy saving state received from the second node may be a request issued by the second node to the first node, or a request issued by any other node to the first node forwarded by the second node. On the other hand, the request described herein may be directed to the first node, or directed to any other node, which is not limited herein. In addition, the other nodes mentioned herein may be any node in the wireless communication network except the second node. In addition, the first node, the second node and the other nodes mentioned herein may be any of the network nodes or network logic units cited above.

Additionally or alternatively, the method 300 may further include: transmitting a first message including a request for network energy saving configuration to the second node. In some implementations, the second message described above may be transmitted by the second node to the first node based on the first message.

Additionally or alternatively, the method 300 may further include: transmitting a fourth message including a response to the request to activate a network in an energy saving state and/or deactivate a network in a non-energy saving state to the second node based on receiving the third message.

Additionally or alternatively, the method 300 may further include: making a network self-optimization decision based on at least one message described above. In some implementations, the network self-optimization decision may include at least one of network energy saving, load balancing, coverage optimization, mobility optimization and/or management, network configuration determination and/or network configuration updating, etc.

FIG. 3B shows a flowchart of a method 310 performed by a second node in a wireless communication system according to embodiments of the present disclosure.

As shown in FIG. 3B, in step S311, the method 310 performed by a second node in a wireless communication system according to embodiments of the present disclosure may include: transmitting, to a first node, at least one message of a second message including a network energy saving configuration and a third message including a request to activate a network in an energy saving state and/or deactivate a network in a non-energy saving state. In some implementations, the at least one message may be associated with at least one of the second node and other nodes other than the second node. For example, the network energy saving configuration transmitted to the first node may be a network energy saving configuration of the second node and/or a network energy saving configuration of any other node collected or acquired by the second node in any way. For example, the request to activate a network in an energy saving state and/or deactivate a network in a non-energy saving state transmitted to the first node may be a request issued by the second node to the first node, or a request issued by any other node to the first node forwarded by the second node. The other node mentioned herein may be any node in the wireless communication network except the second node. In addition, the first node, the second node and the other nodes mentioned herein may be any of the network nodes or network logic units cited above.

Additionally or alternatively, the method 310 may further include: receiving a first message including a request for network power saving configuration from the first node, and transmitting a second message to the first node based on the first message.

Additionally or alternatively, the method 310 may further include: receiving a fourth message including a response to the request to activate a network in an energy saving state and/or deactivate a network in a non-energy saving state from the first node. In some implementations, the fourth message may be transmitted by the first node to the second node based on the third message.

FIG. 4A shows a flowchart of a method 400 performed by a first node in a wireless communication system according to embodiments of the present disclosure.

As shown in FIG. 4A, a method 400 performed by a first node in a wireless communication system according to embodiments of the present disclosure may include: in step S401, the first node receives a second message from a second node, where the second message includes a network energy saving configuration; and in step S402, the first node transmits a fifth message to a user equipment based on receiving the second message. In some implementations, the second message (or a network node configuration included in the second message) transmitted by the second node to the first node may be determined by the second node itself or received by the second node from any other node.

Additionally or alternatively, the method 400 may include: the first node transmitting a first message to the second node, where the first message includes a request for the network energy saving configuration. In some implementations, the second message is transmitted by the second node to the first node based on the first message.

Additionally or alternatively, the method 400 may include: the first node transmits a fifth message to a third node based on receiving the second message.

In some implementations, the fifth message described above may include an activation time of the network energy saving configuration. More generally, in some implementations, the fifth message may have the same fields or related information as the second message which will be described in detail below, or may have partial fields or related information included in the second message. In some implementations, the first node may determine a network energy saving configuration by itself and transmit for example a fifth message including the activation time of the network energy saving configuration to the user equipment or another node (e.g., a third node).

In some implementations, the user equipment may perform uplink transmission and/or downlink reception based on the received activation time of the network energy saving configuration. In some implementations, the third node may perform network energy saving configuration updating of the third node based on the activation time of the network energy saving configuration. The network energy saving configuration updating of the third node may include one or more of the following: entering and/or exiting an energy saving state based on the activation time; calculating and/or adjusting transmission power of the third node in advance based on the activation time, and so on.

Additionally or alternatively, the method 400 may include: the first node receiving a third message from the user equipment, where the third message includes a request to activate a network in an energy saving state and/or deactivate a network in a non-energy saving state.

Additionally or alternatively, the method 400 may include: the first node transmitting a request to activate a network in an energy saving state and/or deactivate a network in a non-energy saving state to at least one of the second node or the third node. In some implementations, the request to activate a network in an energy saving state and/or deactivate a network in a non-energy saving state transmitted by the first node to at least one of the second node or the third node may be received from the user equipment or initiated by the first node itself.

Additionally or alternatively, the method 400 may include: the first node receives a fourth message from at least one of the second node or the third node; and transmits a fourth message to the user equipment. In some implementations, the fourth message may include a response to the request to activate a network in an energy saving state and/or deactivate a network in a non-energy saving state.

Additionally or alternatively, the method 400 may include: the first node performs a network self-optimization decision based on the network energy saving configuration. In some implementations, the network self-optimization decision may include at least one of network energy saving, load balancing, coverage optimization, mobility optimization and/or management, network configuration determination and/or network configuration updating.

FIG. 4B shows a flowchart of a method 410 performed by a second node in a wireless communication system according to embodiments of the present disclosure.

As shown in FIG. 4B, the method 410 performed by a second node in a wireless communication system according to embodiments of the present disclosure may include: in step S411, the second node transmits a second message to a first node, where the second message includes a network energy saving configuration. In some implementations, the first node may transmit a fifth message to a user equipment based on receiving the second message. In some implementations, the second message (or a network node configuration included in the second message) transmitted by the second node to the first node may be determined by the second node itself or received by the second node from any other node. In addition, the method 410 performed by a second node in a wireless communication system as shown in FIG. 4B may further include various steps or operations corresponding to the method 400 performed by the first node in the wireless communication system as described above, which will not be repeated herein.

Steps of the methods 300, 310, 400 and 410 according to embodiments of the present disclosure as described above may be performed individually or jointly in any combination, and may be performed in any order, for example, simultaneously or in a reverse order of the listed order. In addition, various steps and various information described above will be further described below with specific examples. It should be understood that the ordinal numbers in the first node, the second node, the third node, etc. described herein is only used for distinguishing different nodes in specific scenarios. In different examples or implementations of the present disclosure, the first node, the second node, the third node, etc. may be used interchangeably or refer to each other.

The methods performed by a first node and/or a second node in a wireless communication system according to embodiments of the present disclosure will be described from various aspects with specific examples below. More generally, a method performed by a first node and/or a second node in a wireless communication system according to embodiments of the present disclosure may also be called a method for supporting network energy saving.

### Example 1

An example of the present disclosure proposes a method for supporting network energy saving, which may include: a first node transmits a first message including a request for network energy saving configuration to a second node to request the second node to transmit a network energy saving configuration of the second node and/or other nodes to the first node, so as to provide reference information for the first node to make a network energy saving decision or further forward it to other nodes.

In some implementations, the first message may be or be included in one or more of the following: an XN SETUP REQUEST message or an XN SETUP RESPONSE message of Xn; or an ENB CONFIGURATION UPDATE message or an ENB CONFIGURATION UPDATE ACKNOWLEDGE message or an EN-DC CONFIGURATION UPDATE message or an EN-DC CONFIGURATION UPDATE ACKNOWLEDGE message of X2; or an NG-RAN NODE CONFIGURATION UPDATE message or an NG-RAN NODE CONFIGURATION UPDATE ACKNOWLEDGE message of Xn; or a CELL ACTIVATION REQUEST message or a CELL ACTIVATION RESPONSE message or a CELL ACTIVATION FAILURE message of Xn or X2; or an EN-DC CELL ACTIVATION REQUEST message or an EN-DC CELL ACTIVATION RESPONSE message or an EN-DC CELL ACTIVATION FAILURE message of X2; or a RESET REQUEST message of X2 or Xn; or a MOBILITY CHANGE REQUEST message of X2; or an F1 SETUP REQUEST message or an F1 SETUP RESPONSE message or a GNB-DU CONFIGURATION UPDATE message or a GNB-DU CONFIGURATION UPDATE ACKNOWLEDGE message or a GNB-CU CONFIGURATION UPDATE message or a GNB-CU CONFIGURATION UPDATE ACKNOWLEDGE message or a GNB-DU RESOURCE COORDINATION REQUEST message or a GNB-DU RESOURCE COORDINATION RESPONSE message of F1; or a GNB-CU-UP E1 SETUP REQUEST message or a GNB-CU-UP E1 SETUP RESPONSE message or a GNB-CU-CP E1 SETUP REQUEST message or a GNB-CU-CP E1 SETUP RESPONSE message or a GNB-CU-UP CONFIGURATION UPDATE message or a GNB-CU-UP CONFIGURATION UPDATE ACKNOWLEDGE message or a GNB-CU-CP CONFIGURATION UPDATE message or a gNB-CU-CP CONFIGURATION UPDATE ACKNOWLEDGE message of E1; or a RESOURCE STATUS REQUEST message of X2 or Xn or F1 or E1, or an EN-DC RESOURCE STATUS REQUEST message of X2; or an UPLINK RAN CONFIGURATION TRANSFER message and a DOWNLINK RAN CONFIGURATION TRANSFER message of NG; or an other and/or newly defined Radio Resource Control (RRC) and/or Xn and/or X2 and/or F1 and/or E1 and/or NG message.

In some implementations, the first message may include one or more of the following fields and/or related information:
Transmitting node identification: an identification of a node that transmits the first message.
Receiving node identification: an identification of a node that receives the first message.
Identification of network energy saving configuration request: used to identify that the request is a request for reporting network energy saving configuration, and/or indicate whether it is required to report network energy saving configuration. It may be represented by a single bit. For example, when the bit is 1, it indicates that the network energy saving configuration is requested to be reported and/or needs to be reported; and when the bit is 0, it indicates that the network energy saving configuration is not requested to be reported and/or needs not to be reported; alternatively, when the bit is 0, it indicates that the network energy saving configuration is requested to be reported and/or needs to be reported; and when the bit is 1, it indicates that the network energy saving configuration is not requested to be reported and/or needs not to be reported. The network energy saving configuration request may be aimed at a current network energy saving configuration or a predicted network energy saving configuration.
Applicable scope of network energy saving configuration requested to be reported: it may be identifications and/or identification lists of one or more of the following: cell, slice (for example, it may be identified by Single Network Slice Selection Assistance Information (S-NSSAI)), Bandwidth Part (BWP), subframe, slot, symbol, carrier, service, Quality of Service (QOS) level, QoS flow, Protocol Data Unit (PDU) session, data Radio Bearer (DRB), beam, transmitting and receiving point, node, Synchronization Signal Block (SSB), Resource Block, etc. The network energy saving configuration request may be aimed at a current network energy saving configuration or a predicted network energy saving configuration. Herein, the QoS level and/or QoS type may be identified by one or more of the following: 5G QOS Identifier (5QI), Qos Flow Identifier (QFI), etc.
Reporting mode: used to indicate a reporting mode (of the network energy saving configuration), for example, it may include On-demand, single reporting, periodic reporting, event triggering, etc.
Reporting registration request: used to indicate the start, end, addition, decrease, etc. of the reporting (of the network energy saving configuration).
Reporting interval: used to indicate a reporting interval of periodic reporting (of the network energy saving configuration).
Trigger event: used to indicate an event that triggers the reporting (of the network energy saving configuration), for example, it may be a change of network energy saving configuration, a change of predicted network energy saving configuration, a change of coverage state of oneself and/or a neighboring cell, etc. When the trigger event is met, reporting will be performed.
Reporting request information for predicted energy saving configuration:
   Reporting mode of the requested predicted energy saving configuration: used to indicate the reporting mode of the requested predicted energy saving configuration, for example, it may include On-demand, single reporting, periodic reporting, event triggering, etc.
   Reporting registration request of the requested predicted energy saving configuration: used to indicate the start, end, addition, decrease, etc. of the reporting of the requested predicted energy saving configuration.
   Reporting interval of the requested predicted energy saving configuration: used to indicate the reporting interval of periodic reporting of the requested predicted energy saving configuration.
   Trigger event of the reporting of the requested predicted energy saving configuration: used to indicate the event that triggers the reporting of the predicted energy saving configuration, for example, it may be a change of network energy saving configuration, a change of predicted network energy saving configuration, a change of coverage state of oneself and/or a neighboring cell, etc. When the trigger event is met, reporting will be performed.
   Applicable (or validity) time of the predicted energy saving configuration requested to be reported: used to indicate an applicable time point and/or applicable time period of the predicted energy saving configuration requested to be reported. This time may be a relative time or an absolute time. If it is a time interval, it may be represented by 2*n bits, for example, the first n bits represent a start time and the last n bits represent an end time. It may also be represented by separate fields, including one or more of the following:
      Start time: used to indicate a start time. The start time may be a relative time or an absolute time.
      End time: used to indicate an end time. The end time may be a relative time or an absolute time.
   Accuracy of the predicted energy saving configuration requested to be reported: it may be an accuracy or a confidence. The accuracy may also be an accuracy corresponding to a model of the predicted energy saving configuration.
Requested reporting content: used to indicate the content requested for reporting. This content may be a current content or a predicted content. The content may include one or more of the following:
   Current network energy saving related state and/or mode: for example, it may include one or more of the following: energy saving state and/or mode, normal state and/or mode (or non-energy saving state and/or mode), switch-on, switch-off, activation, deactivation, energy saving state, non-energy saving state, sleep, non-sleep, deep sleep, light sleep, micro sleep, active uplink (active UL), active downlink (active DL), transmission power decrease and/or increase, coverage increase and/or decrease, etc. The state and/or mode may be for one or more of the following: uplink, downlink, uplink or downlink, uplink and downlink.
   Energy saving configuration: it may be a current energy saving configuration or a predicted energy saving configuration. It may include one or more of the following:
      not transmitting downlink channels (all or any downlink channels)
      not receiving uplink channels (all or any downlink channels)
      not transmitting a predefined downlink channel
      not receiving a predefined uplink channel
      transmitting downlink channels (all or any downlink channels)
      receiving uplink channels (all or any uplink channels)
      transmitting a predefined downlink channel
      receiving a predefined uplink channel
      Synchronization Signal Block (SSB) configuration: it may be a configuration in an energy saving mode or a configuration in a non-energy saving mode. This configuration may be a configuration in which SSB is transmitted or a configuration in which SSB is not transmitted. The SSB configuration may be one and/or a set of configuration parameters, which may include one or more of the following: cell identification, SSB frequency, SSB subcarrier spacing, SSB transmission power, SSB period, SSB half subframe index, SSB system frame number offset, initial time of system frame number, SSB position, etc. The SSB position may be an SSB Position in Burst, including one or more of the following: short bitmap, medium bitmap and long bitmap. The SSB configuration may also be a configuration index, where one index corresponds to a set of defined configuration parameters, which may include the above parameters of the SSB configuration, etc. The SSB configuration may also be an energy saving and/or non-energy saving mode that the SSB is in, which may include one or more of the following: switch-on, switch-off, activation, deactivation, network energy saving state, non-network energy saving state, sleep, non-sleep, deep sleep, light sleep, micro sleep, active uplink (active UL), active downlink (active DL), SSB normal state, SSB reduced (SSB-less and/or light SSB) state, SSB-free state, simplified SSB, partial SSB, transmission power decrease and/or increase, coverage increase and/ or decrease, etc. Herein, the SSB reduced state may identify the configuration of SSB by an index, or may identify the configuration of SSB by specific parameters.
      Master Information Block (MIB) configuration: it may be a configuration in an energy saving mode or a configuration in a non-energy saving mode. This configuration may be a configuration in which MIB is transmitted or a configuration in which MIB is not transmitted. The MIB configuration may be one and/or a set of configuration parameters, which may include one or more of the following: cell identification, MIB frequency, MIB subcarrier spacing, MIB transmission power, MIB period, MIB repetition, MIB position, etc. The MIB configuration may also be a configuration index, where one index corresponds to a set of defined configuration parameters, which may include the above parameters of the MIB configuration, etc. The MIB configuration may also be an energy saving and/or non-energy saving mode that the MIB is in, which may include one or more of the following: switch-on, switch-off, activation, deactivation, network energy saving state, non-network energy saving state, sleep, non-sleep, deep sleep, light sleep, micro sleep, active uplink (active UL), active downlink (active DL), MIB normal state, MIB reduced (MIB-less and/or light MIB) state, MIB-free state, simplified MIB, partial MIB, simplified MIB, partial MIB, transmission power decrease and/or increase, coverage increase and/or decrease, etc. Herein, the MIB reduced state may identify the configuration of MIB by an index, or may identify the configuration of MIB by specific parameters.
      System Information Block (SIB) configuration: it may be a configuration in an energy saving mode or a configuration in a non-energy saving mode. This configuration may be a configuration in which SIB is transmitted or a configuration in which SIB is not transmitted. The SIB configuration may be one and/or a set of configuration parameters, which may include one or more of the following: cell identification, SIB frequency, SIB subcarrier spacing, SIB transmission power, SIB period, SIB repetition, SIB position, etc. The SIB configuration may also be a configuration index, where one index corresponds to a set of defined configuration parameters, which may include the above parameters of the SIB configuration, etc. The SIB configuration may also be an energy saving and/or non-energy saving mode that the SIB is in, which may include one or more of the following: switch-on, switch-off, activation, deactivation, network energy saving state, non-network energy saving state, sleep, non-sleep, deep sleep, light sleep, micro sleep, active uplink (active UL), active downlink (active DL), SIB normal state, SIB reduced (SIB-less and/or light SIB) state, SIB-free state, simplified SIB, partial SIB, transmission power decrease and/or increase, coverage increase and/or decrease, etc. Herein, the SIB reduced state may identify the configuration of SIB by an index, or may identify the configuration of SIB by specific parameters.
      Transmission power configuration
      Channel and/or signal configuration
      Scope corresponding to the above configuration: it may include one or more of the following: service, QoS type, QoS level, etc. In an implementation, for example, one or more service types are applicable to the above configuration, and other services are not applicable to the above configuration; alternatively, one or more service types are not applicable to the above configuration, and other services are applicable to the above configuration. In another implementation, for example, one or more QoS types and/or QoS levels are applicable to the above configuration, and other services are not applicable to the above configuration. Alternatively, one or more QoS types and/or QoS levels are not applicable to the above configuration, and other services are applicable to the above configuration. Herein, the QoS level and/or QoS type may be identified by one or more of the following: 5G QOS Identifier (5QI), Qos Flow Identifier (QFI), etc.
      Time mode corresponding to the above configuration: it may include one or more of the following: part of time periods is applicable, part of time periods is inapplicable, applicable time periods, inapplicable time periods, mode index, time mode configuration, active time, inactive time, etc. Herein, one mode index corresponds to one configuration. The configuration may be that, for example, part of time periods is for transmission and/or part of time periods is not for transmission. Herein, the active time may be the time when reception and/or transmission can be performed. Herein, the inactive time may be the time when reception and/or transmission is not performed. This mode can be aimed at one configuration or multiple configurations of the above configurations. In an implementation, for example, it may be that the time not used for reception may be used for transmission. In another implementation, for example, it may be that part of the active time is for transmission, and another part is for reception, etc.
      Frequency mode corresponding to the above configuration: it may include one or more of the following: part of frequencies is applicable, part of frequencies is inapplicable, applicable frequencies, inapplicable frequencies, mode index, active frequencies, inactive frequencies, etc. Herein, one mode index corresponds to one configuration. For example, it may be that part of frequencies is for transmission and/or part of frequencies is not for transmission. Herein, an active frequency can be the frequency at which reception and/or transmission can be performed. Herein, an inactive frequency may be the frequency at which reception and/or transmission is not performed. This mode can be aimed at one configuration or multiple configurations of the above configurations. In an implementation, for example, it may be that frequencies not used for reception may be used for transmission. In another implementation, for example, it may be that part of the active frequencies is for transmission, and another part is for reception, etc.
      Indication of joint configuration: used to indicate whether the energy saving configuration is a joint configuration. In an implementation, for example, the configuration may be a joint configuration for reception and transmission. In an implementation, for example, a joint configuration mode can be predefined. Transmission of this indication enables that while part of the configuration is transmitted, another part of the configuration can be not transmitted, and a node receiving this message can derive another part of the configuration through the predefined joint configuration mode and the part of the configuration, thus achieving an effect of signaling saving. Modes of joint configuration may include but are not limited to:
Time and/or frequency bands not used for reception can be used for transmission.
A part of the active time and/or frequency bands is for transmission, and another part is for reception.
Active time and/or frequency bands are for reception, and inactive time and/or frequency bands are for transmission.
Inactive time and/or frequency bands are for reception, and active time and/or frequency bands are for transmission.
   Index of joint configuration: used to identify whether the configuration is a joint configuration and/or identify the index corresponding to the joint configuration. In an implementation, for example, the configuration may be a joint configuration for reception and transmission. In an implementation, for example, a variety of joint configuration modes can be predefined and identified by indexes. Transmission of this index enables that while part of the configuration is transmitted, another part of the configuration can be not transmitted, and a node receiving this message can derive another part of the configuration through the predefined joint configuration mode corresponding to the index and the part of the configuration, thus achieving an effect of signaling saving. Modes of joint configuration may include but are not limited to:
Time and/or frequency bands not used for reception can be used for transmission.
A part of the active time and/or frequency bands is for transmission, and another part is for reception.
Active time and/or frequency bands are for reception, and inactive time and/or frequency bands are for transmission.
Inactive time and/or frequency bands are for reception, and active time and/or frequency bands are for transmission.
   Condition for triggering energy saving configuration: when a certain condition is met, the above configuration is activated. For example, it may include one or more of the following: receiving a certain signaling, transmitting a certain signaling, being in a certain mode at present, meeting a timer, load situation and/or resource status being less than and/or less than or equal to and/or greater than and/or greater than or equal to a certain threshold, a change of coverage state of oneself and/or a neighboring cell, etc. It should be understood that the signaling, modes, timers, etc. described herein can be one or more of any existing or future signaling, modes, timers, etc. unless otherwise specified, and are not limited herein.
   Activation time applicable to energy saving configuration
   Deactivation time applicable to energy saving configuration
   Energy saving configuration mode: it may include static configuration, semi-static configuration, dynamic configuration, periodic configuration, aperiodic configuration, semi-periodic configuration, etc.
   Capability requirement of a UE that can be received: used to indicate the capabilities that a UE that can be received needs to have, that is, a UE that meets the capability requirement can perform handover. This capability requirement may be: a requirement for standard version, whether energy saving technology is supported, whether it is a traditional UE, etc. In some implementations, for example, the capability requirement of the UE that can be received indicates that a UE whose version is before a certain version will not be received, and when the UE does not meet this requirement, the UE may not be handed over to a corresponding node. This field may also be represented by a single bit. For example, when the bit is 1, it means that a UE supporting energy saving technology can be received and/or a traditional UE can be received; and when the bit is 0, it means that a UE supporting energy saving technology cannot be received and/or a traditional UE cannot be received. Herein, a traditional UE may be a UE that does not support a certain technology (for example, energy saving technology, etc.), or a UE whose version is before a certain standard version.
Request to set energy saving configuration autonomously: it may include one or more of the following:
   Request indication to set the energy saving configuration autonomously or not: used to request a node and/or a cell to set the energy saving configuration autonomously, and/or request a node and/or a cell to not set the energy saving configuration autonomously. The node may be a transmitting node, a receiving node or an other node. The cell may be a cell of the transmitting node, a cell of the receiving node, or a cell of an other node.
   Cell and/or node to request for setting the energy saving configuration autonomously: it may be identifications and/or an identification list of cells and/or nodes. The node may be a transmitting node, a receiving node or an other node. The cell may be a cell of the transmitting node, a cell of the receiving node, or a cell of an other node.
   Cell and/or node to request for not setting energy saving configuration autonomously: it may be identifications and/or an identification list of cells and/or nodes. The node may be a transmitting node, a receiving node or an other node. The cell may be a cell of the transmitting node, a cell of the receiving node, or a cell of an other node.
Reporting request for information related to wake-up signal configuration: it may indicate that the configuration related to wake-up signal is requested to be reported. The configuration may include one or more of the following:
   Power Saving (or Energy Saving) radio network temporary identifier: indicating a radio network temporary identifier for scrambling a Cyclic redundancy check of a DCI format used for power saving.
   Power saving offset
   Frequency configuration of wake-up signal: for example, it may include one or more of the following: start frequency, end frequency, frequency hopping information, frequency domain resources that can be transmitted, frequency domain resources that cannot be transmitted, frequency domain resources that can be received, frequency domain resources that cannot be received, etc.
   Time domain configuration and/or time information of wake-up signal: for example, it may include one or more of the following: start time, end time, period, time that can be transmitted, time that cannot be transmitted, time that can be received, time that cannot be received, etc.
   Transmitting position of the wake-up signal: it may include frequency configuration and/or time domain configuration, etc.
   Receiving position of the wake-up signal: it may include frequency configuration and/or time domain configuration, etc.
   Sequence of the wake-up signal
   Detecting sequence of the wake-up signal
   Applicable time for the configuration: indicates that the configuration is valid only within the applicable time.
Reporting request for information related to a configuration about whether to wake up after receiving a wake-up signal: used to indicate that it is required to report a related configuration about whether to wake up based on the received wake-up signal. This configuration may be a configuration used by the node to judge whether to wake up from an energy saving mode after receiving the wake-up signal. For example, it may include one or more of the following:
   Wake-up condition: when the wake-up condition is met, wake-up operation is performed. It may include one or more of the following:
      Threshold: it may be that a wake-up operation is performed when a received signal quality is greater than and/or greater than or equal to the wake-up threshold, and is not performed when the signal quality is less than and/or less than or equal to the wake-up threshold, or it may be that a wake-up operation is performed when a received signal quality is less than and/or less than or equal to the wake-up threshold, and is not performed when the signal quality is greater than and/or greater than or equal to the wake-up threshold. The threshold may be set based on the signal quality of the wake-up signal received from the node, or it may be set based on the signal quality of the wake-up signal received by oneself.
      Sequence: it may be that a wake-up operation is performed when a received signal sequence meets the condition of this signal sequence. Alternatively, it may be that a wake-up operation is performed when a received signal sequence meets the condition of this signal sequence after being processed. A processing method may be that the received signal sequence is mathematically processed with the signal sequence.
      Information of applicable time of the wake-up condition: indicates that the wake-up condition is valid only within the applicable time.
Reporting request for information related to a signal quality of a received wake-up signal: used to indicate information related to the signal quality and/or other parameters of the received wake-up signal is requested to be reported. For example, the information related to the signal quality and/or other parameters of the received wake-up signal may include one or more of the following:
   Signal quality of the received wake-up signal
   Request for information about a comparison between the signal quality of the received wake-up signal with a limitation value: the limitation value may be a predefined value or a signal quality of a wake-up signal received by a certain node received from the certain node. In some implementations, it may be a signal quality of a wake-up signal transmitted by a UE and received by a certain node received from the certain node. The comparison with the limitation value may be that it is greater than and/or greater than or equal to and/or equal to and/or less than and/or less than or equal to the limitation value.
   Limitation value information: the limitation value may be a predefined value or a signal quality of a wake-up signal received by a certain node received from the certain node. The limit value may be set based on the signal quality of the wake-up signal received from the node or the signal quality of the wake-up signal received by oneself.
   Trigger condition and/or event for reporting: when the trigger condition and/or event is met, reporting will be performed. For example, the trigger condition and/or event may be that the signal quality of the received wake-up signal is greater than and/or greater than or equal to and/or equal to and/or less than and/or less than or equal to a limitation value.
   Other parameters of the received wake-up signal: for example, it may include time delay, sequence, etc.
Reporting request for information related to whether to wake up: it may indicate a request for reporting whether a node will perform a wake-up operation. The request may also include a request for reporting time information when to perform the wake-up operation, and/or time information of an energy saving and/or non-energy saving state.
Reporting request for whether wake-up is requested: it may indicate a request for reporting related information about whether a node is requested to perform a wake-up operation. The request may also include a request for reporting time information when the wake-up operation is requested to be performed, and/or time information of an energy saving and/or non-energy saving state.
Reporting request for that a wake-up operation is requested not to be performed: it may indicate a request for reporting whether a node is requested not to perform a wake-up operation. The request may also include a request for reporting time information when the wake-up operation is not to be performed, and/or time information of an energy saving and/or non-energy saving state.
Reporting request for an activation and/or applicable time of a configuration: indicates a request for reporting the applicable time of one or more of the above configurations. It may include one or more of the following:
   Applicable activation time of a configuration: it may be an absolute time or a relative time.
   Applicable deactivation time of a configuration: it may be an absolute time or a relative time.
   Applicable time of a configuration: it may be an absolute time or a relative time.
   Inapplicable time of a configuration: it may be an absolute time or a relative time.

In some implementations, the second node may transmit a second message including a network energy saving configuration of the second node and/or other nodes to the first node according to its own situation and/or according to the received first message including a request for network energy saving configuration, so that the first node can obtain the network energy saving configuration of the second node and/or other nodes, and the first node may perform network energy saving configuration updating and/or self-optimization decision according to the received network energy saving configuration, For example, when receiving the network energy saving configuration of a neighboring cell, the first node may adjust the transmission power to achieve the purpose of energy saving while ensuring performance. In some implementations, for example, when receiving that the network energy saving configuration of the neighboring cell is been entered a network energy saving state, the first node may reduce its transmission power due to reduced interference, so as to achieve the purpose of energy saving. In other implementations, for example, after receiving the network energy saving configuration of the neighboring cell, the first node may select a node and/or cell that can support the UE performance as the target node and/or the target cell according to the network energy saving related state and/or mode of the neighboring cell; alternatively, if the neighboring cell has entered the energy saving state, the first node will not enter the energy saving state; alternatively, when performing load balancing, a neighboring cells that can support UE performance in the current state may be selected as the target node and/or target cell for Load Offloading and/or Traffic Offloading. In still other implementations, for example, the first node receives that the second node will take energy saving actions and/or enter an energy saving state at a certain time in the future (for example, the activation time of the network energy saving configuration), then the first node can take this information into account when making a self-optimization decision, for example, the first node will not take energy saving actions and/or not enter an energy saving state at this time to ensure the performance of the UE; alternatively, the first node does not regard the second node and/or a cell of the second node as the target node and/or the target cell for load offloading and/or traffic offloading when making a load balancing decision, so as to avoid offloading ping-pong and/or handover ping-pong, or it may be that the first node does not select the second node and/or the cell of the second node as the target node and/or the target cell for handover when making a mobility decision for UE (e.g. handover); alternatively, the first node may calculate the transmission power and/or prepare the adjustment of the transmission power in advance according to the energy saving actions and/or entrance of an energy saving state of the second node at a certain time in the future. In still other implementations, the first node receives the network energy saving configuration of the second node and/or that the second node will take energy saving actions and/or enter an energy saving state at a certain time in the future (for example, the activation time of the network energy saving configuration), then the first node transmits a request to activate a network in an energy saving state and/or deactivate a network in a non-energy saving state to the second node according to its own situation and/or a request received from other nodes. When receiving a Synchronization Signal Block (SSB) configuration of the neighboring cell, the first node may configure its own SSB according to the SSB configuration of the neighboring cell to avoid SSB configuration conflict. When receiving the current and/or predicted coverage state change of the neighboring cell, the first node may set an energy saving strategy according to the coverage state of the neighboring cell, for example, while ensuring coverage, it appropriately specifies an energy saving strategy to avoid coverage blank. Specifically, for example, when the coverage of the neighboring cell is reduced, the first node does not take energy saving actions to avoid forming coverage blank, or when the coverage of the neighboring cell is expanded and/or reduced by a small range, the first node may determine a suitable energy saving action. When receiving the transmission power of a neighboring cell, the first node may set an appropriate transmission power that can meet receiving requirements according to the transmission power of the neighboring cell, so as to achieve the purpose of energy saving. For example, when the transmission power of the neighboring cell decreases, the first node can appropriately lower the transmission power of its own cell, so as to achieve the purpose of energy saving by lowering the transmission power under the condition of meeting the receiving requirements, for example, meeting the receiving end's condition for the quality of the received signal. A node may refer to a node and/ or a cell managed by the node.

In some implementations, the second message may be or be included in one or more of the following: an XN SETUP REQUEST message or an XN SETUP RESPONSE message of Xn; or an ENB CONFIGURATION UPDATE message or an ENB CONFIGURATION UPDATE ACKNOWLEDGE message or an EN-DC CONFIGURATION UPDATE message or an EN-DC CONFIGURATION UPDATE ACKNOWLEDGE message of X2; or an NG-RAN NODE CONFIGURATION UPDATE message or an NG-RAN NODE CONFIGURATION UPDATE ACKNOWLEDGE message of Xn; or a CELL ACTIVATION REQUEST message or a CELL ACTIVATION RESPONSE message or a CELL ACTIVATION FAILURE message of Xn or X2; or an EN-DC CELL ACTIVATION REQUEST message or an EN-DC CELL ACTIVATION RESPONSE message or an EN-DC CELL ACTIVATION FAILURE message of X2; or a RESET REQUEST message of X2 or Xn; or a MOBILITY CHANGE REQUEST message of X2; or an F1 SETUP REQUEST message or an F1 SETUP RESPONSE message or a GNB-DU CONFIGURATION UPDATE message or a GNB-DU CONFIGURATION UPDATE ACKNOWLEDGE message or a GNB-CU CONFIGURATION UPDATE message or a GNB-CU CONFIGURATION UPDATE ACKNOWLEDGE message or a GNB-DU RESOURCE COORDINATION REQUEST message or a GNB-DU RESOURCE COORDINATION RESPONSE message of F1; or a GNB-CU-UP E1 SETUP REQUEST message or a GNB-CU-UP E1 SETUP RESPONSE message or a GNB-CU-CP E1 SETUP REQUEST message or a GNB-CU-CP E1 SETUP RESPONSE message or a GNB-CU-UP CONFIGURATION UPDATE message or a GNB-CU-UP CONFIGURATION UPDATE ACKNOWLEDGE message or a GNB-CU-CP CONFIGURATION UPDATE message or a gNB-CU-CP CONFIGURATION UPDATE ACKNOWLEDGE message of E1; or a RESOURCE STATUS REQUEST message of X2 or Xn or F1 or E1, or an EN-DC RESOURCE STATUS REQUEST message of X2; or a RESOURCE STATUS RESPONSE message or a RESOURCE STATUS FAILURE message or a RESOURCE STATUS UPDATE message of X2 or Xn or F1 or E1; or an RESOURCE STATUS RESPONSE message and/or an EN-DC RESOURCE STATUS FAILURE message and/or an EN-DC RESOURCE STATUS UPDATE message of X2; or an UPLINK RAN CONFIGURATION TRANSFER message and a DOWNLINK RAN CONFIGURATION TRANSFER message of NG; or an other and/or newly defined RRC and/or Xn and/or X2 and/or F1 and/or E1 and/or NG message.

In some implementations, the second message may include one or more of the following fields and/or related information:
Transmitting node identification: an identification of a node that transmits the second message.
Receiving node identification: an identification of a node that receives the second message.
Reporting content: indicates the reported content. This content may be a current content or a predicted content. It may include one or more of the following:
   Applicable scope: the scope corresponding to a network energy saving configuration and/or energy saving related state and/or mode, which may be identifications and/or identification lists of one or more of the following: cell, slice (for example, it may be identified by Single Network Slice Selection Assistance Information (S-NSSAI)), Bandwidth Part (BWP), subframe, slot, symbol, carrier, service, Quality of Service (QOS) level, QoS flow, Protocol Data Unit (PDU) session, data Radio Bearer (DRB), beam, transmitting and receiving point, node, SSB, Resource Block, etc. Herein, the QoS level and/or QoS type may be identified by one or more of the following: 5G QoS Identifier (5QI), Qos Flow Identifier (QFI), etc.
   Energy saving related state and/or mode: used to indicate the current energy saving related state and/or mode of the network, for example, it may be one or more of the following: switch-on, switch-off, activation, deactivation, energy saving state, non-energy saving state, sleep, non-sleep, deep sleep, light sleep, micro sleep, active uplink (active UL), active downlink (active DL), transmission power decrease and/or increase, coverage increase and/or decrease, etc. The state and/or mode may be for one or more of the following: uplink, downlink, uplink or downlink, uplink and downlink.
   Predicted network energy saving related state and/or mode: used to represent a predicted energy saving related state and/or mode at a later time, for example, it may be one or more of the following: switch-on, switch-off, activation, deactivation, network energy saving state, non-network energy saving state, sleep, non-sleep, deep sleep, light sleep, micro sleep, active uplink (active UL), active downlink (active DL), transmission power decrease and/or increase, coverage increase and/or decrease, etc. The state and/or mode may be for one or more of the following: uplink, downlink, uplink or downlink, uplink and downlink.
   Applicable time corresponding to the predicted network energy saving related state and/or mode: used to indicate the applicable time point and/or applicable time period of the predicted energy saving related state and/or mode. This time may be a relative time or an absolute time. If it is a time interval, it may be represented by 2*n bits, for example, the first n bits represent a start time and the last n bits represent an end time. It may also be represented by separate fields, including one or more of the following:
      Start time: used to indicate a start time. The start time may be a relative time or an absolute time.
      End time: used to indicate an end time. The end time may be a relative time or an absolute time.
   Accuracy of the predicted energy saving configuration: it may be an accuracy or a confidence. The accuracy may also be an accuracy corresponding to the model for predicting the energy saving configuration.
   Energy saving configuration: this configuration may be a current energy saving configuration or a predicted energy saving configuration. It may include one or more of the following:
      not transmitting downlink channels (all or any downlink channels)
      not receiving uplink channels (all or any downlink channels)
      not transmitting a predefined downlink channel
      not receiving a predefined uplink channel
      transmitting downlink channels (all or any downlink channels)
      receiving uplink channels (all or any uplink channels)
      transmitting a predefined downlink channel
      receiving a predefined uplink channel
      Synchronization Signal Block (SSB) configuration: it may be a configuration in an energy saving mode or a configuration in a non-energy saving mode. The SSB configuration may be one and/or a set of configuration parameters, which may include one or more of the following: cell identification, SSB frequency, SSB subcarrier spacing, SSB transmission power, SSB period, SSB half subframe index, SSB system frame number offset, initial time of system frame number, SSB position, etc. The SSB position may be an SSB Position in Burst, including one or more of the following: short bitmap, medium bitmap and long bitmap. The SSB configuration may also be a configuration index, where one index corresponds to a set of defined configuration parameters, which may include the above parameters of the SSB configuration, etc. The SSB configuration may also be an energy saving and/or non-energy saving mode that the SSB is in, which may include one or more of the following: switch-on, switch-off, activation, deactivation, network energy saving state, non-network energy saving state, sleep, non-sleep, deep sleep, light sleep, micro sleep, active uplink (active UL), active downlink (active DL), SSB normal state, SSB reduced (SSB-less and/or light SSB) state, SSB-free state, simplified SSB, partial SSB, transmission power decrease and/or increase, coverage increase and/or decrease, etc. Herein, the SSB reduced state may identify the configuration of SSB by an index, or may identify the configuration of SSB by specific parameters.
      Master Information Block (MIB) configuration: it may be a configuration in an energy saving mode or a configuration in a non-energy saving mode. The MIB configuration may be one and/or a set of configuration parameters, which may include one or more of the following: cell identification, MIB frequency, MIB subcarrier spacing, MIB transmission power, MIB period, MIB repetition, MIB position, etc. The MIB configuration may also be a configuration index, where one index corresponds to a set of defined configuration parameters, which may include the above parameters of the MIB configuration, etc. The MIB configuration may also be an energy saving and/or non-energy saving mode that the MIB is in, which may include one or more of the following: switch-on, switch-off, activation, deactivation, network energy saving state, non-network energy saving state, sleep, non-sleep, deep sleep, light sleep, micro sleep, active uplink (active UL), active downlink (active DL), MIB normal state, MIB reduced (MIB-less and/or light MIB) state, MIB-free state, simplified MIB, partial MIB, simplified MIB, partial MIB, transmission power decrease and/or increase, coverage increase and/or decrease, etc. Herein, the MIB reduced state may identify the configuration of MIB by an index, or may identify the configuration of MIB by specific parameters.
      System Information Block (SIB) configuration: it may be a configuration in an energy saving mode or a configuration in a non-energy saving mode. The SIB configuration may be one and/or a set of configuration parameters, which may include one or more of the following: cell identification, SIB frequency, SIB subcarrier spacing, SIB transmission power, SIB period, SIB repetition, SIB position, etc. The SIB configuration may also be a configuration index, where one index corresponds to a set of defined configuration parameters, which may include the above parameters of the SIB configuration, etc. The SIB configuration may also be an energy saving and/or non-energy saving mode that the SIB is in, which may include one or more of the following: switch-on, switch-off, activation, deactivation, network energy saving state, non-network energy saving state, sleep, non-sleep, deep sleep, light sleep, micro sleep, active uplink (active UL), active downlink (active DL), SIB normal state, SIB reduced (SIB-less and/or light SIB) state, SIB-free state, simplified SIB, partial SIB, transmission power decrease and/or increase, coverage increase and/or decrease, etc. Herein, the SIB reduced state may identify the configuration of SIB by an index, or may identify the configuration of SIB by specific parameters.
      Transmission power configuration
      Channel and/or signal configuration
      Scope corresponding to the above configuration: it may include one or more of the following: service, QoS type, QoS level, etc. In an implementation, for example, one or more service types are applicable to the above configuration, and other services are not applicable to the above configuration; alternatively, one or more service types are not applicable to the above configuration, and other services are applicable to the above configuration. In another implementation, for example, one or more QoS types and/or QoS levels are applicable to the above configuration, and other services are not applicable to the above configuration. Alternatively, one or more QoS types and/or QoS levels are not applicable to the above configuration, and other services are applicable to the above configuration. Herein, the QoS level and/or QoS type may be identified by one or more of the following: 5G QoS Identifier (5QI), Qos Flow Identifier (QFI), etc.
      Time mode corresponding to the above configuration: it may include one or more of the following: part of time periods is applicable, part of time periods is inapplicable, applicable time periods, inapplicable time periods, mode index, time mode configuration, active time, inactive time, etc. Herein, one mode index corresponds to one configuration. The configuration may be that, for example, part of time periods is for transmission and/or part of time periods is not for transmission. Herein, the active time may be the time when reception and/or transmission can be performed. Herein, the inactive time may be the time when reception and/or transmission is not performed. The time may be for one configuration of the above configurations or for multiple configurations of the above configurations. In an implementation, for example, it may be that the time not used for reception may be used for transmission. In another implementation, for example, it may be that part of the active time is for transmission, and another part is for reception, etc.
      Frequency mode corresponding to the above configuration: it may include one or more of the following: part of frequencies is applicable, part of frequencies is inapplicable, applicable frequencies, inapplicable frequencies, mode index, active frequencies, inactive frequencies, etc. Herein, one mode index corresponds to one configuration. For example, it may be that part of frequencies is for transmission and/or part of frequencies is not for transmission. Herein, an active frequency can be the frequency at which reception and/or transmission can be performed. Herein, an inactive frequency may be the frequency at which reception and/or transmission is not performed. This mode can be aimed at one configuration or multiple configurations of the above configurations. In an implementation, for example, it may be that frequencies not used for reception may be used for transmission. In another implementation, for example, it may be that part of the active frequencies is for transmission, and another part is for reception, etc.
      Indication of joint configuration: used to indicate whether the energy saving configuration is a joint configuration. In an implementation, for example, the configuration may be a joint configuration for reception and transmission. In an implementation, for example, a joint configuration mode can be predefined. Transmission of this indication enables that while part of the configuration is transmitted, another part of the configuration can be not transmitted, and a node receiving this message can derive another part of the configuration through the predefined joint configuration mode and the part of the configuration, thus achieving an effect of signaling saving. Modes of joint configuration may include but are not limited to:
         Time and/or frequency bands not used for reception can be used for transmission.
         A part of the active time and/or frequency bands is for transmission, and another part is for reception.
         Active time and/or frequency bands are for reception, and inactive time and/or frequency bands are for transmission.
         Inactive time and/or frequency bands are for reception, and active time and/or frequency bands are for transmission.
         Index of joint configuration: used to identify whether the configuration is a joint configuration and/or identify the index corresponding to the joint configuration. In an implementation, for example, the configuration may be a joint configuration for reception and transmission. In an implementation, for example, a variety of joint configuration modes can be predefined and identified by indexes. Transmission of this index enables that while part of the configuration is transmitted, another part of the configuration can be not transmitted, and a node receiving this message can derive another part of the configuration through the predefined joint configuration mode corresponding to the index and the part of the configuration, thus achieving an effect of signaling saving. Modes of joint configuration may include but are not limited to:
         Time and/or frequency bands not used for reception can be used for transmission.
         A part of the active time and/or frequency bands is for transmission, and another part is for reception.
         Active time and/or frequency bands are for reception, and inactive time and/or frequency bands are for transmission.
   Inactive time and/or frequency bands are for reception, and active time and/or frequency bands are for transmission. Condition for triggering energy saving configuration: when a certain condition is met, the above configuration is activated. For example, it may include one or more of the following: receiving a certain signaling, transmitting a certain signaling, being in a certain mode at present, meeting a timer, load situation and/or resource status being less than and/or less than or equal to and/or greater than and/or greater than or equal to a certain threshold, a change of coverage state of oneself and/or a neighboring cell, etc. It should be understood that the signaling, modes, timers, etc. described herein can be one or more of any existing or future signaling, modes, timers, etc. unless otherwise specified, and are not limited herein.
   Activation time applicable to energy saving configuration: it may be an absolute time or a relative time.
   Deactivation time applicable to energy saving configuration: it may be an absolute time or a relative time.
   Energy saving configuration mode: it may include static configuration, semi-static configuration, dynamic configuration, periodic configuration, aperiodic configuration, semi-periodic configuration, etc.
   Capability requirement of a UE that can be received: used to indicate the capabilities that a UE that can be received needs to have, that is, a UE that meets the capability requirement can perform handover. This capability requirement may be: a requirement for standard version, whether energy saving technology is supported, whether it is a traditional UE, etc. In some implementations, for example, the capability requirement of the UE that can be received indicates that a UE whose version is before a certain version will not be received, and when the UE does not meet this requirement, the UE may not be handed over to a corresponding node. This field may also be represented by a single bit. For example, when the bit is 1, it means that a UE supporting energy saving technology can be received and/or a traditional UE can be received; and when the bit is 0, it means that a UE supporting energy saving technology cannot be received and/or a traditional UE cannot be received. Herein, a traditional UE may be a UE that does not support a certain technology (for example, the technology may be an energy saving technology, etc.), or a UE whose version is before a certain standard version.
Event that triggers reporting: used to indicate an event that triggers the reporting, for example, it may be one or more of the following: a change of network energy saving configuration, a change of predicted network energy saving configuration, a change of coverage state of oneself and/or a neighboring cell, etc.
Settings of setting energy saving configuration autonomously: it may include one or more of the following:
   Indication of whether energy saving configuration can be set autonomously: used to indicate whether a node and/or cell can set energy saving configuration autonomously. The node may be a transmitting node, a receiving node or an other node. The cell may be a cell of the transmitting node, a cell of the receiving node, or a cell of an other node.
   Cells and/or nodes that can set energy saving configuration autonomously: it may be identifications and/or an identification list of cells and/or nodes.
   Cells and/or nodes that cannot set energy saving configuration autonomously: it may be identifications and/or an identification list of cells and/or nodes. The node may be a transmitting node, a receiving node or an other node. The cell may be a cell of the transmitting node, a cell of the receiving node, or a cell of an other node.
Information related to wake-up signal configuration: it may indicate the configuration related to wake-up signal. The configuration may include one or more of the following:
   Power Saving (or Energy Saving) radio network temporary identifier: indicating a radio network temporary identifier for scrambling a Cyclic redundancy check of a DCI format used for power saving.
   Power saving offset
   Frequency configuration of wake-up signal: for example, it may include one or more of the following: start frequency, end frequency, frequency hopping information, frequency domain resources that can be transmitted, frequency domain resources that cannot be transmitted, frequency domain resources that can be received, frequency domain resources that cannot be received, etc.
   Time domain configuration and/or time information of wake-up signal: for example, it may include one or more of the following: start time, end time, period, time that can be transmitted, time that cannot be transmitted, time that can be received, time that cannot be received, etc.
   Transmitting position of the wake-up signal: it may include frequency configuration and/or time domain configuration, etc.
   Receiving position of the wake-up signal: it may include frequency configuration and/or time domain configuration, etc.
   Sequence of the wake-up signal
   Detecting sequence of the wake-up signal
   Applicable time for the configuration: indicates that the configuration is valid only within the applicable time.
Information related to a configuration about whether to wake up after receiving a wake-up signal: used to indicate the related configuration about whether to wake up based on the received wake-up signal. This configuration may be a configuration used by the node to judge whether to wake up from an energy saving mode after receiving the wake-up signal. For example, it may include one or more of the following:
   Wake-up condition: when the wake-up condition is met, wake-up operation is performed. It may include one or more of the following:
      Threshold: it may be that a wake-up operation is performed when a received signal quality is greater than and/or greater than or equal to the wake-up threshold, and is not performed when the signal quality is less than and/or less than or equal to the wake-up threshold, or it may be that a wake-up operation is performed when a received signal quality is less than and/or less than or equal to the wake-up threshold, and is not performed when the signal quality is greater than and/or greater than or equal to the wake-up threshold. The threshold may be set based on the signal quality of the wake-up signal received from the node, or it may be set based on the signal quality of the wake-up signal received by oneself.
      Sequence: it may be that a wake-up operation is performed when a received signal sequence meets the condition of this signal sequence. Alternatively, it may be that a wake-up operation is performed when a received signal sequence meets the condition of this signal sequence after being processed. A processing method may be that the received signal sequence is mathematically processed with the signal sequence.
      Information of applicable time of the wake-up condition: indicates that the wake-up condition is valid only within the applicable time.
Information related to a signal quality of a received wake-up signal: used to indicate information related to the signal quality and/or other parameters of the received wake-up signal. For example, the information related to the signal quality and/or other parameters of the received wake-up signal may include one or more of the following:
   Signal quality of the received wake-up signal
   Request for information about a comparison between the signal quality of the received wake-up signal with a limitation value: the limitation value may be a predefined value or a signal quality of a wake-up signal received by a certain node received from the certain node. In some implementations, it may be a signal quality of a wake-up signal transmitted by a UE and received by a certain node received from the certain node. The comparison with the limitation value may be that it is greater than and/or greater than or equal to and/or equal to and/or less than and/or less than or equal to the limitation value.
   Limitation value information: the limitation value may be a predefined value or a signal quality of a wake-up signal received by a certain node received from the certain node. The limit value may be set based on the signal quality of the wake-up signal received from the node or the signal quality of the wake-up signal received by oneself.
   Condition and/or event that triggers reporting: a condition and/or event that is met when the reporting is triggered. For example, the trigger condition and/or event may be that the signal quality of the received wake-up signal is greater than and/or greater than or equal to and/or equal to and/or less than and/or less than or equal to a limitation value.
   Other parameters of the received wake-up signal: for example, it may include time delay, sequence, etc.
Indication of whether to wake up: it may indicate whether to perform a wake-up operation. In some implementations, it may be that a second node informs a first node that the second node will perform a wake-up operation. This field may also include time information when to perform the wake-up operation, and/or time information of an energy saving and/or non-energy saving state.
Indication of whether to request wake-up: it may indicate whether to request a node to perform a wake-up operation. In some implementations, it may be that a second node requests a first node to perform a wake-up operation. This field may also include time information when the wake-up operation is requested to be performed, and/or time information of an energy saving and/or non-energy saving state.
Indication of requesting not to perform a wake-up operation: it may indicate that a node is requested not to perform a wake-up operation. In some implementations, it may be that a second node requests a first node not to perform a wake-up operation. This field may also include time information when the wake-up operation is not to be performed, and/or time information of an energy saving and/or non-energy saving state.
Activation and/or applicable time of a configuration: indicates the applicable time of one or more of the above configurations. It may include one or more of the following:
   Applicable activation time of a configuration: it may be an absolute time or a relative time.
   Applicable deactivation time of a configuration: it may be an absolute time or a relative time.
   Applicable time of a configuration: it may be an absolute time or a relative time.
   Inapplicable time of a configuration: it may be an absolute time or a relative time.

In some implementations, if what indicated by the indication of whether energy saving configuration can be set autonomously is directed to a receiving node and/or a cell of the receiving node, after receiving the indication, if it is indicated that the configuration can be set autonomously, the receiving node can make energy saving configuration on a related cell itself. In an implementation, for example, a gNB-CU may be the transmitting node of the second message and a gNB-DU may be the receiving node of the second message. The gNB-CU indicates that the receiving node can set the energy saving configuration autonomously, then the gNB-DU can set the energy saving configuration autonomously, and then the gNB-DU can transmit the energy saving configuration set autonomously to the gNB-CU, for example, the gNB-DU may transmit the energy saving configuration to the gNB-CU through the second message.

In some implementations, Node A informs Node B of the signal quality of a received wake-up signal by using the second message, and Node B compares the signal quality of its own received wake-up signal with the received signal quality of the wake-up signal received by Node A, and then the node with a higher signal quality of the wake-up signal performs a wake-up operation. For example, when the signal quality of the received wake-up signal of Node A is higher, Node B may request the node to perform a wake-up and/or activation operation by using the second message and/or the third message. In some implementations, for example, the gNB DU may inform the gNB CU of the signal quality of the received wake-up signal by using the second message, and the gNB CU compares the signal quality of wake-up signals received from a plurality of gNB DUs, and the gNB CU transmits a wake-up and/or activation request to the gNB DU where the cell with higher signal quality of wake-up signal is located by using the second message and/or the third message, and the gNB DU performs corresponding wake-up and/or activation operations. In other implementations, for example, it may be that a node providing capacity informs a node providing coverage of the signal quality of the received wake-up signal by using the second message, and the node providing coverage compares the signal quality of wake-up signals received from a plurality of nodes providing capacity, and the node providing coverage transmits a wake-up and/or activation request to the node providing capacity where the cell with higher signal quality of wake-up signal is located by using the second message and/or the third message, and the node providing capacity performs corresponding wake-up and/or activation operations. In still other implementations, for example, it may be that a node informs a neighboring node of the signal quality of the received wake-up signal by using the second message, and the neighboring node compares the signal quality of wake-up signals received from a plurality of nodes, and the neighboring node transmits a wake-up and/or activation request to the node where the cell with higher signal quality of wake-up signal is located by using the second message and/or the third message, and the node performs corresponding wake-up and/or activation operations.

In some implementations, Node A informs Node B of the information related to a configuration about whether to wake up after receiving a wake-up signal by using the second message, and Node B performs a wake-up operation and/or does not perform a wake-up operation according to the information related to the configuration after receiving a wake-up signal. For example, it may be that Node A transmits a wake-up condition to Node B, and after Node B receives a wake-up signal, if information related to the received wake-up signal meets the wake-up condition, Node B performs a wake-up operation. In some implementations, for example, it may be that a gNB CU informs a gNB DU of the information related to a configuration about whether to wake up after receiving a wake-up signal by using the second message, and the gNB DU performs a wake-up operation and/or does not perform a wake-up operation according to the information related to the configuration after receiving a wake-up signal. For example, it may be that the gNB CU transmits a wake-up condition to the gNB DU, and after the gNB DU receives a wake-up signal, if information related to the received wake-up signal meets the wake-up condition, the gNB DU performs a wake-up operation. In other implementations, for example, it may be that a node providing coverage informs a node providing capacity of the information related to a configuration about whether to wake up after receiving a wake-up signal by using the second message, and the node providing capacity performs a wake-up operation and/or does not perform a wake-up operation according to the information related to the configuration after receiving a wake-up signal. For example, it may be that the node providing coverage transmits a wake-up condition to the node providing capacity, and after the node providing capacity receives a wake-up signal, if information related to the received wake-up signal meets the wake-up condition, the node providing capacity performs a wake-up operation. In still other implementations, for example, it may be that a node informs a neighboring node of the information related to a configuration about whether to wake up after receiving a wake-up signal by using the second message, and the neighboring node performs a wake-up operation and/or does not perform a wake-up operation according to the information related to the configuration after receiving a wake-up signal. For example, it may be that the node transmits a wake-up condition to the neighboring node, and after the neighboring node receives a wake-up signal, if information related to the received wake-up signal meets the wake-up condition, the neighboring node performs a wake-up operation.

In some implementations, Node A informs Node B a result that the signal quality of the received wake-up signal is greater than a limitation value, and Node B may request Node A to perform a wake-up operation. For example, it may be that if the signal quality of the wake-up signal received by Node A from the UE is greater than the signal quality of the wake-up signals received by other nodes (it may be any node except Node A), Node B requests Node A to perform a wake-up and/or activation operation by using the second message and/or the third message.

In some implementations, Node A transmits a configuration of a wake-up signal to other nodes, and other nodes receive and/or transmit the wake-up signal according to the configuration of the wake-up signal, and/or other nodes perform or not perform corresponding wake-up operations according to the configuration after receiving the wake-up signal.

In some implementations, Node A transmits a configuration of a wake-up signal to other nodes, and other nodes make reference to the received configuration when configuring a wake-up signal, such as setting different configurations to avoid configuration conflicts.

In some implementations, the wake-up signal may be transmitted by the UE to a node, and the node receives a related wake-up signal from the UE. The UE may be in a Radio Resource Control (RRC) connected state and/or an RRC idle state and/or an RRC inactive state.

In some implementations, the energy saving configuration of the second node and/or other nodes indicates that a UE that does not meet a certain capability requirement can not be received and/or only a UE that meets a certain capability requirement can be received. When the UE does not meet the capability requirement, the first node cannot switch the UE to the above-mentioned second node and/or other nodes.

In some implementations, it may be that the second node and/or other nodes may not receive a UE that does not meet a certain capability requirement and/or may only receive a UE that meets a certain capability requirement. When the UE does not meet the capability requirement, the first node transmits a handover request to the second node and/or other nodes, and the second node and/or other nodes reject the handover request. Alternatively, the first node may be informed that the reasons for rejection are one or more of the following: this type of UE cannot be received, the UE does not meet one or more capability requirements for a receiving UEs, etc. The capability requirement may be a capability requirement for the above-mentioned UE that can be received.

### Example 2

An example of the present disclosure proposes a method for supporting network energy saving, which may include: a second node transmits a third message including a request to activate a network in an energy saving state and/or deactivate a network in a non-energy saving state to a first node, so as to request and/or suggest the first node to update network energy saving configuration, for example, to activate the network in an energy saving state and/or deactivate the network in a non-energy saving state, so as to avoid local overload, excessive local energy consumption, and inability to guarantee UE performance, etc. For example, if the second node is to enter an energy saving state, in order to avoid coverage blank, the first node is required and/or suggested to expand its coverage. Alternatively, it may be that the second node transmits a third message including a request to activate a network in an energy saving state and/or deactivate a network in a non-energy saving state to the first node, so as to inform the first node of the update of network energy saving configuration of the second node. The first node may accept and/or reject the update request of the second node according to its own situation, and the second node may update and/or maintain the network energy saving configuration according to the acceptance and/or rejection of the first node, so as to avoid the situation that the second node updates the network energy saving configuration only according to its own situation thus resulting in coverage blank, local overload and the like, and make the energy saving configuration updating more suitable. In an implementation, for example, a gNB-DU may transmit a request to update the network energy saving configuration of the gNB-DU to a gNB-CU, and the gNB-CU may accept the gNB-DU to update the energy saving configuration and/or reject the gNB-DU to update the network energy saving configuration according to its own situation. In another implementation, for example, a node informs a neighboring node of its own demand to update the network configuration, and the neighboring node accepts and/or rejects to update the network energy saving configuration according to its own situation.

In some implementations, the third message may be or be included in one or more of the following: an XN SETUP REQUEST message or an XN SETUP RESPONSE message of Xn; or an ENB CONFIGURATION UPDATE message or an ENB CONFIGURATION UPDATE ACKNOWLEDGE message or an EN-DC CONFIGURATION UPDATE message or an EN-DC CONFIGURATION UPDATE ACKNOWLEDGE message of X2; or an NG-RAN NODE CONFIGURATION UPDATE message or an NG-RAN NODE CONFIGURATION UPDATE ACKNOWLEDGE message of Xn; or a CELL ACTIVATION REQUEST message or a CELL ACTIVATION RESPONSE message or a CELL ACTIVATION FAILURE message of Xn or X2; or an EN-DC CELL ACTIVATION REQUEST message or an EN-DC CELL ACTIVATION RESPONSE message or an EN-DC CELL ACTIVATION FAILURE message of X2; or a RESET REQUEST message of X2 or Xn; or a MOBILITY CHANGE REQUEST message of X2; or an F1 SETUP REQUEST message or an F1 SETUP RESPONSE message or a GNB-DU CONFIGURATION UPDATE message or a GNB-DU CONFIGURATION UPDATE ACKNOWLEDGE message or a GNB-CU CONFIGURATION UPDATE message or a GNB-CU CONFIGURATION UPDATE ACKNOWLEDGE message or a GNB-DU RESOURCE COORDINATION REQUEST message or a GNB-DU RESOURCE COORDINATION RESPONSE message of F1; or a GNB-CU-UP E1 SETUP REQUEST message or a GNB-CU-UP E1 SETUP RESPONSE message or a GNB-CU-CP E1 SETUP REQUEST message or a GNB-CU-CP E1 SETUP RESPONSE message or a GNB-CU-UP CONFIGURATION UPDATE message or a GNB-CU-UP CONFIGURATION UPDATE ACKNOWLEDGE message or a GNB-CU-CP CONFIGURATION UPDATE message or a gNB-CU-CP CONFIGURATION UPDATE ACKNOWLEDGE message of E1; or a RESOURCE STATUS REQUEST message of X2 or Xn or F1 or E1, or an EN-DC RESOURCE STATUS REQUEST message of X2; or an UPLINK RAN CONFIGURATION TRANSFER message and a DOWNLINK RAN CONFIGURATION TRANSFER message of NG; or a HANDOVER REQUEST ACKNOWLEDGE message, a RETRIEVE UE CONTEXT REQUEST message or a HANDOVER SUCCESS message of X2 or Xn; or an SENB ADDITION REQUEST ACKNOWLEDGE message or an SGNB ADDITION REQUEST ACKNOWLEDGE message of X2; or an S-NODE ADDITION REQUEST ACKNOWLEDGE message of Xn; or an other and/or newly defined RRC and/or Xn and/or X2 and/or F1 and/or E1 and/or NG message.

In some implementations, the third message may include one or more of the following fields and/or related information:
Transmitting node identification: an identification of a node that transmits the third message.
Receiving node identification: an identification of a node that receives the third message.
Activation identification: identifies the activation.
Scope corresponding to an activation request: it may be identifications and/or identification lists of one or more of the following: cell, slice (for example, it may be identified by Single Network Slice Selection Assistance Information (S-NSSAI)), Bandwidth Part (BWP), subframe, slot, symbol, carrier, service, Quality of Service (QoS) level, QoS flow, Protocol Data Unit (PDU) session, data Radio Bearer (DRB), beam, transmitting and receiving point, node, SSB, Resource Block, etc. This request may be a current activation request or a predicted activation request. Herein, the QoS level and/or QoS type may be identified by one or more of the following: 5G QoS Identifier (5QI), Qos Flow Identifier (QFI), etc.
Configuration requested for activation: the configuration may be a current configuration or a predicted configuration. It may include one or more of the following:
   not transmitting downlink channels (all or any downlink channels)
   not receiving uplink channels (all or any downlink channels)
   not transmitting a predefined downlink channel
   not receiving a predefined uplink channel
   transmitting downlink channels (all or any downlink channels)
   receiving uplink channels (all or any uplink channels)
   transmitting a predefined downlink channel
   receiving a predefined uplink channel
   Synchronization Signal Block (SSB) configuration: it may be a configuration in an energy saving mode or a configuration in a non-energy saving mode. The SSB configuration may be one and/or a set of configuration parameters, which may include one or more of the following: cell identification, SSB frequency, SSB subcarrier spacing, SSB transmission power, SSB period, SSB half subframe index, SSB system frame number offset, initial time of system frame number, SSB position, etc. The SSB position may be an SSB Position in Burst, including one or more of the following: short bitmap, medium bitmap and long bitmap. The SSB configuration may also be a configuration index, where one index corresponds to a set of defined configuration parameters, which may include the above parameters of the SSB configuration, etc. The SSB configuration may also be an energy saving and/or non-energy saving mode that the SSB is in, which may include one or more of the following: switch-on, switch-off, activation, deactivation, network energy saving state, non-network energy saving state, sleep, non-sleep, deep sleep, light sleep, micro sleep, active uplink (active UL), active downlink (active DL), SSB normal state, SSB reduced (SSB-less and/or light SSB) state, SSB-free state, simplified SSB, partial SSB, transmission power decrease and/or increase, coverage increase and/or decrease, etc. Herein, the SSB reduced state may identify the configuration of SSB by an index, or may identify the configuration of SSB by specific parameters.
   Master Information Block (MIB) configuration: it may be a configuration in an energy saving mode or a configuration in a non-energy saving mode. The MIB configuration may be one and/or a set of configuration parameters, which may include one or more of the following: cell identification, MIB frequency, MIB subcarrier spacing, MIB transmission power, MIB period, MIB repetition, MIB position, etc. The MIB configuration may also be a configuration index, where one index corresponds to a set of defined configuration parameters, which may include the above parameters of the MIB configuration, etc. The MIB configuration may also be an energy saving and/or non-energy saving mode that the MIB is in, which may include one or more of the following: switch-on, switch-off, activation, deactivation, network energy saving state, non-network energy saving state, sleep, non-sleep, deep sleep, light sleep, micro sleep, active uplink (active UL), active downlink (active DL), MIB normal state, MIB reduced (MIB-less and/or light MIB) state, MIB-free state, simplified MIB, partial MIB, simplified MIB, partial MIB, transmission power decrease and/or increase, coverage increase and/or decrease, etc. Herein, the MIB reduced state may identify the configuration of MIB by an index, or may identify the configuration of MIB by specific parameters.
   System Information Block (SIB) configuration: it may be a configuration in an energy saving mode or a configuration in a non-energy saving mode. The SIB configuration may be one and/or a set of configuration parameters, which may include one or more of the following: cell identification, SIB frequency, SIB subcarrier spacing, SIB transmission power, SIB period, SIB repetition, SIB position, etc. The SIB configuration may also be a configuration index, where one index corresponds to a set of defined configuration parameters, which may include the above parameters of the SIB configuration, etc. The SIB configuration may also be an energy saving and/or non-energy saving mode that the SIB is in, which may include one or more of the following: switch-on, switch-off, activation, deactivation, network energy saving state, non-network energy saving state, sleep, non-sleep, deep sleep, light sleep, micro sleep, active uplink (active UL), active downlink (active DL), SIB normal state, SIB reduced (SIB-less and/or light SIB) state, SIB-free state, simplified SIB, partial SIB, transmission power decrease and/or increase, coverage increase and/or decrease, etc. Herein, the SIB reduced state may identify the configuration of SIB by an index, or may identify the configuration of SIB by specific parameters.
   Transmission power configuration
   Channel and/or signal configuration
   Scope corresponding to the above activation configuration: it may include one or more of the following: service, QoS type, QoS level, etc. In an implementation, for example, one or more service types are applicable to the above configuration, and other services are not applicable to the above configuration; alternatively, one or more service types are not applicable to the above configuration, and other services are applicable to the above configuration. In another implementation, for example, one or more QoS types and/or QoS levels are applicable to the above configuration, and other services are not applicable to the above configuration. Alternatively, one or more QoS types and/or QoS levels are not applicable to the above configuration, and other services are applicable to the above configuration. Herein, the QoS level and/or QoS type may be identified by one or more of the following: 5G QOS Identifier (5QI), Qos Flow Identifier (QFI), etc.
   Time mode corresponding to the above configuration: it may include one or more of the following: part of time periods is applicable, part of time periods is inapplicable, applicable time periods, inapplicable time periods, mode index, time mode configuration, active time, inactive time, etc. Herein, one mode index corresponds to one configuration. For example, it may be that part of time periods is for transmission and/or part of time periods is not for transmission. Herein, the active time may be the time when reception and/or transmission can be performed. Herein, the inactive time may be the time when reception and/or transmission is not performed. This mode can be aimed at one configuration or multiple configurations of the above configurations. In an implementation, for example, it may be that the time not used for reception may be used for transmission. In another implementation, for example, it may be that part of the active time is for transmission, and another part is for reception, etc.
   Frequency mode corresponding to the above configuration: it may include one or more of the following: part of frequencies is applicable, part of frequencies is inapplicable, applicable frequencies, inapplicable frequencies, mode index, active frequencies, inactive frequencies, etc. Herein, one mode index corresponds to one configuration. For example, it may be that part of frequencies is for transmission and/or part of frequencies is not for transmission. Herein, an active frequency can be the frequency at which reception and/or transmission can be performed. Herein, an inactive frequency may be the frequency at which reception and/or transmission is not performed. This mode can be aimed at one configuration or multiple configurations of the above configurations. In an implementation, for example, it may be that frequencies not used for reception may be used for transmission. In another implementation, for example, it may be that part of the active frequencies is for transmission, and another part is for reception, etc.
   Indication of joint configuration: used to indicate whether the energy saving configuration is a joint configuration. In an implementation, for example, the configuration may be a joint configuration for reception and transmission. In an implementation, for example, a joint configuration mode can be predefined. Transmission of this indication enables that while part of the configuration is transmitted, another part of the configuration can be not transmitted, and a node receiving this message can derive another part of the configuration through the predefined joint configuration mode and the part of the configuration, thus achieving an effect of signaling saving. Modes of joint configuration may include but are not limited to:
      Time and/or frequency bands not used for reception can be used for transmission.
      A part of the active time and/or frequency bands is for transmission, and another part is for reception.
      Active time and/or frequency bands are for reception, and inactive time and/or frequency bands are for transmission.
      Inactive time and/or frequency bands are for reception, and active time and/or frequency bands are for transmission.
   Index of joint configuration: used to identify whether the configuration is a joint configuration and/or identify the index corresponding to the joint configuration. In an implementation, for example, the configuration may be a joint configuration for reception and transmission. In an implementation, for example, a variety of joint configuration modes can be predefined and identified by indexes. Transmission of this index enables that while part of the configuration is transmitted, another part of the configuration can be not transmitted, and a node receiving this message can derive another part of the configuration through the predefined joint configuration mode corresponding to the index and the part of the configuration, thus achieving an effect of signaling saving. Modes of joint configuration may include but are not limited to:
      Time and/or frequency bands not used for reception can be used for transmission.
      A part of the active time and/or frequency bands is for transmission, and another part is for reception.
      Active time and/or frequency bands are for reception, and inactive time and/or frequency bands are for transmission.
      Inactive time and/or frequency bands are for reception, and active time and/or frequency bands are for transmission.
   Energy saving configuration mode: it may include static configuration, semi-static configuration, dynamic configuration, periodic configuration, aperiodic configuration, semi-periodic configuration, etc.
Condition for triggering activation: when a certain condition is met, the activation operation is performed, which may include, for example, one or more of the following: receiving a certain signaling, transmitting a certain signaling, being in a certain mode at present, meeting a timer, load situation and/or resource status being less than and/or less than or equal to and/or greater than and/or greater than or equal to a certain threshold, a change of coverage state of oneself and/or a neighboring cell, etc. It should be understood that the signaling, modes, timers, etc. described herein can be one or more of any existing or future signaling, modes, timers, etc. unless otherwise specified, and are not limited herein.
Activation time: indicates the time for activation. It may be an absolute time or a relative time.
Deactivation identification: identifies the deactivation.
Scope corresponding to a deactivation request: it may be identifications and/or identification lists of one or more of the following: cell, slice (for example, it may be identified by Single Network Slice Selection Assistance Information (S-NSSAI)), Bandwidth Part (BWP), subframe, slot, symbol, carrier, service, Quality of Service (QoS) level, QoS flow, Protocol Data Unit (PDU) session, data Radio Bearer (DRB), beam, transmitting and receiving point, node, SSB, Resource Block, etc. This request may be a current activation request or a predicted activation request. Herein, the QoS level and/or QoS type may be identified by one or more of the following: 5G QoS Identifier (5QI), Qos Flow Identifier (QFI), etc.
Configuration requested for deactivation: this configuration may be a current configuration or a predicted configuration. It may include one or more of the following:
   not transmitting downlink channels (all or any downlink channels)
   not receiving uplink channels (all or any downlink channels)
   not transmitting a predefined downlink channel
   not receiving a predefined uplink channel
   transmitting downlink channels (all or any downlink channels)
   receiving uplink channels (all or any uplink channels)
   transmitting a predefined downlink channel
   receiving a predefined uplink channel
   Synchronization Signal Block (SSB) configuration: it may be a configuration in an energy saving mode or a configuration in a non-energy saving mode. The SSB configuration may be one and/or a set of configuration parameters, which may include one or more of the following: cell identification, SSB frequency, SSB subcarrier spacing, SSB transmission power, SSB period, SSB half subframe index, SSB system frame number offset, initial time of system frame number, SSB position, etc. The SSB position may be an SSB Position in Burst, including one or more of the following: short bitmap, medium bitmap and long bitmap. The SSB configuration may also be a configuration index, where one index corresponds to a set of defined configuration parameters, which may include the above parameters of the SSB configuration, etc. The SSB configuration may also be an energy saving and/or non-energy saving mode that the SSB is in, which may include one or more of the following: switch-on, switch-off, activation, deactivation, network energy saving state, non-network energy saving state, sleep, non-sleep, deep sleep, light sleep, micro sleep, active uplink (active UL), active downlink (active DL), SSB normal state, SSB reduced (SSB-less and/or light SSB) state, SSB-free state, simplified SSB, partial SSB, transmission power decrease and/or increase, coverage increase and/or decrease, etc. Herein, the SSB reduced state may identify the configuration of SSB by an index, or may identify the configuration of SSB by specific parameters.
   Master Information Block (MIB) configuration: it may be a configuration in an energy saving mode or a configuration in a non-energy saving mode. The MIB configuration may be one and/or a set of configuration parameters, which may include one or more of the following: cell identification, MIB frequency, MIB subcarrier spacing, MIB transmission power, MIB period, MIB repetition, MIB position, etc. The MIB configuration may also be a configuration index, where one index corresponds to a set of defined configuration parameters, which may include the above parameters of the MIB configuration, etc. The MIB configuration may also be an energy saving and/or non-energy saving mode that the MIB is in, which may include one or more of the following: switch-on, switch-off, activation, deactivation, network energy saving state, non-network energy saving state, sleep, non-sleep, deep sleep, light sleep, micro sleep, active uplink (active UL), active downlink (active DL), MIB normal state, MIB reduced (MIB-less and/or light MIB) state, MIB-free state, simplified MIB, partial MIB, MIB-free state, transmission power decrease and/or increase, coverage increase and/or decrease, etc. Herein, the MIB reduced state may identify the configuration of MIB by an index, or may identify the configuration of MIB by specific parameters.
   System Information Block (SIB) configuration: it may be a configuration in an energy saving mode or a configuration in a non-energy saving mode. The SIB configuration may be one and/or a set of configuration parameters, which may include one or more of the following: cell identification, SIB frequency, SIB subcarrier spacing, SIB transmission power, SIB period, SIB repetition, SIB position, etc. The SIB configuration may also be a configuration index, where one index corresponds to a set of defined configuration parameters, which may include the above parameters of the SIB configuration, etc. The SIB configuration may also be an energy saving and/or non-energy saving mode that the SIB is in, which may include one or more of the following: switch-on, switch-off, activation, deactivation, network energy saving state, non-network energy saving state, sleep, non-sleep, deep sleep, light sleep, micro sleep, active uplink (active UL), active downlink (active DL), SIB normal state, SIB reduced (SIB-less and/or light SIB) state, SIB-free state, simplified SIB, partial SIB, transmission power decrease and/or increase, coverage increase and/or decrease, etc. Herein, the SIB reduced state may identify the configuration of SIB by an index, or may identify the configuration of SIB by specific parameters.
   Transmission power configuration
   Channel and/or signal configuration
   Scope corresponding to the above deactivation configuration: it may include one or more of the following: service, QoS type, QoS level, etc. In an implementation, for example, one or more service types are applicable to the above configuration, and other services are not applicable to the above configuration; alternatively, one or more service types are not applicable to the above configuration, and other services are applicable to the above configuration. In another implementation, for example, one or more QoS types and/or QoS levels are applicable to the above configuration, and other services are not applicable to the above configuration. Alternatively, one or more QoS types and/or QoS levels are not applicable to the above configuration, and other services are applicable to the above configuration. Herein, the QoS level and/or QoS type may be identified by one or more of the following: 5G QoS Identifier (5QI), Qos Flow Identifier (QFI), etc.
   Time mode corresponding to the above configuration: it may include one or more of the following: part of time periods is applicable, part of time periods is inapplicable, applicable time periods, inapplicable time periods, mode index, time mode configuration, active time, inactive time, etc. Herein, one mode index corresponds to one configuration. For example, it may be that part of time periods is for transmission and/ or part of time periods is not for transmission. Herein, the active time may be the time when reception and/or transmission can be performed. Herein, the inactive time may be the time when reception and/or transmission is not performed. This mode can be aimed at one configuration or multiple configurations of the above configurations. In an implementation, for example, it may be that the time not used for reception may be used for transmission. In another implementation, for example, it may be that part of the active time is for transmission, and another part is for reception, etc.
   Frequency mode corresponding to the above configuration: it may include one or more of the following: part of frequencies is applicable, part of frequencies is inapplicable, applicable frequencies, inapplicable frequencies, mode index, active frequencies, inactive frequencies, etc. Herein, one mode index corresponds to one configuration. For example, it may be that part of frequencies is for transmission and/or part of frequencies is not for transmission. Herein, one mode index corresponds to one configuration. For example, it may be that part of frequencies is for transmission and/or part of frequencies is not for transmission. Herein, an active frequency can be the frequency at which reception and/or transmission can be performed. Herein, an inactive frequency may be the frequency at which reception and/or transmission is not performed. This mode can be aimed at one configuration or multiple configurations of the above configurations. In an implementation, for example, it may be that frequencies not used for reception may be used for transmission. In another implementation, for example, it may be that part of the active frequencies is for transmission, and another part is for reception, etc.
   Indication of joint configuration: used to indicate whether the energy saving configuration is a joint configuration. In an implementation, for example, the configuration may be a joint configuration for reception and transmission. In an implementation, for example, a joint configuration mode can be predefined. Transmission of this indication enables that while part of the configuration is transmitted, another part of the configuration can be not transmitted, and a node receiving this message can derive another part of the configuration through the predefined joint configuration mode and the part of the configuration, thus achieving an effect of signaling saving. Modes of joint configuration may include but are not limited to:
      Time and/or frequency bands not used for reception can be used for transmission.
      A part of the active time and/or frequency bands is for transmission, and another part is for reception.
      Active time and/or frequency bands are for reception, and inactive time and/or frequency bands are for transmission.
      Inactive time and/or frequency bands are for reception, and active time and/or frequency bands are for transmission.
   Index of joint configuration: used to identify whether the configuration is a joint configuration and/or identify the index corresponding to the joint configuration. In an implementation, for example, the configuration may be a joint configuration for reception and transmission. In an implementation, for example, a variety of joint configuration modes can be predefined and identified by indexes. Transmission of this index enables that while part of the configuration is transmitted, another part of the configuration can be not transmitted, and a node receiving this message can derive another part of the configuration through the predefined joint configuration mode corresponding to the index and the part of the configuration, thus achieving an effect of signaling saving. Modes of joint configuration may include but are not limited to:
      Time and/or frequency bands not used for reception can be used for transmission.
      A part of the active time and/or frequency bands is for transmission, and another part is for reception.
      Active time and/or frequency bands are for reception, and inactive time and/or frequency bands are for transmission.
      Inactive time and/or frequency bands are for reception, and active time and/or frequency bands are for transmission.
   Energy saving configuration mode: it may include static configuration, semi-static configuration, dynamic configuration, periodic configuration, aperiodic configuration, semi-periodic configuration, etc.
Condition for triggering deactivation: when a certain condition is met, a deactivation operation is performed, for example, it may include one or more of the following: receiving a certain signaling, transmitting a certain signaling, being in a certain mode at present, meeting a timer, load situation and/or resource status being less than and/or less than or equal to and/or greater than and/or greater than or equal to a certain threshold, a change of coverage state of oneself and/or a neighboring cell, etc. It should be understood that the signaling, modes, timers, etc. described herein can be one or more of any existing or future signaling, modes, timers, etc. unless otherwise specified, and are not limited herein.
Deactivation time: indicates the time for deactivation. It may be an absolute time or a relative time.
Suggested and/or requested energy saving related state and/or mode: it is used to represent a suggested and/or requested energy saving related state and/or mode of a network, or a predicted energy saving related state and/or mode, or an energy saving configuration, or one or more of the following: switch-on, switch-off, activation, deactivation, energy saving state, non-energy saving state, sleep, non-sleep, deep sleep, light sleep, micro sleep, active uplink (active UL), active downlink (active DL), suggested and/or requested SSB configuration, suggested and/or requested MIB configuration, suggested and/or requested SIB configuration, transmission power decrease and/or increase, coverage increase and/or decrease, etc. The state and/or mode may be for one or more of the following: uplink, downlink, uplink or downlink, uplink and downlink. The Synchronization Signal Block (SSB) configuration may be a configuration in an energy saving mode or a configuration in a non-energy saving mode. The SSB configuration may be one and/or a set of configuration parameters, which may include one or more of the following: cell identification, SSB frequency, SSB subcarrier spacing, SSB transmission power, SSB period, SSB half subframe index, SSB system frame number offset, initial time of system frame number, SSB position, etc. The SSB position may be an SSB Position in Burst, including one or more of the following: short bitmap, medium bitmap and long bitmap. The SSB configuration may also be a configuration index, where one index corresponds to a set of defined configuration parameters, which may include the above parameters of the SSB configuration, etc. The SSB configuration may also be an energy saving and/or non-energy saving mode that the SSB is in, which may include one or more of the following: switch-on, switch-off, activation, deactivation, network energy saving state, non-network energy saving state, sleep, non-sleep, deep sleep, light sleep, micro sleep, active uplink (active UL), active downlink (active DL), SSB normal state, SSB reduced (SSB-less and/or light SSB) state, SSB-free state, simplified SSB, partial SSB, transmission power decrease and/or increase, coverage increase and/or decrease, etc.

Herein, the SSB reduced state may identify the configuration of SSB by an index, or may identify the configuration of SSB by specific parameters. The Master Information Block (MIB) configuration may be a configuration in an energy saving mode or a configuration in a non-energy saving mode. The MIB configuration may be one and/or a set of configuration parameters, which may include one or more of the following: cell identification, MIB frequency, MIB subcarrier spacing, MIB transmission power, MIB period, MIB repetition, MIB position, etc. The MIB configuration may also be a configuration index, where one index corresponds to a set of defined configuration parameters, which may include the above parameters of the MIB configuration, etc. The MIB configuration may also be an energy saving and/or non-energy saving mode that the MIB is in, which may include one or more of the following: switch-on, switch-off, activation, deactivation, network energy saving state, non-network energy saving state, sleep, non-sleep, deep sleep, light sleep, micro sleep, active uplink (active UL), active downlink (active DL), MIB normal state, MIB reduced (MIB-less and/or light MIB) state, MIB-free state, simplified MIB, partial MIB, MIB-free state, transmission power decrease and/or increase, coverage increase and/or decrease, etc. Herein, the MIB reduced state may identify the configuration of MIB by an index, or may identify the configuration of MIB by specific parameters. The System Information Block (SIB) configuration may be a configuration in an energy saving mode or a configuration in a non-energy saving mode. The SIB configuration may be one and/or a set of configuration parameters, which may include one or more of the following: cell identification, SIB frequency, SIB subcarrier spacing, SIB transmission power, SIB period, SIB repetition, SIB position, etc. The SIB configuration may also be a configuration index, where one index corresponds to a set of defined configuration parameters, which may include the above parameters of the SIB configuration, etc. The SIB configuration may also be an energy saving and/or non-energy saving mode that the SIB is in, which may include one or more of the following: switch-on, switch-off, activation, deactivation, network energy saving state, non-network energy saving state, sleep, non-sleep, deep sleep, light sleep, micro sleep, active uplink (active UL), active downlink (active DL), SIB normal state, SIB reduced (SIB-less and/or light SIB) state, SIB-free state, simplified SIB, partial SIB, transmission power decrease and/or increase, coverage increase and/or decrease, etc. Herein, the SIB reduced state may identify the configuration of SIB by an index, or may identify the configuration of SIB by specific parameters.
Configuration change identification: identifies this configuration change. This configuration may be a transmission power configuration, a channel and/or signal configuration, or any other configuration mentioned in the present disclosure, for example, a configuration of a wake-up signal, an energy saving configuration, a setting of setting energy saving configuration autonomously, and the like.
Suggested and/or requested configuration: this configuration may be a transmission power configuration, a channel and/or signal configuration, or any other configuration mentioned in the present disclosure, for example, a configuration of a wake-up signal, an energy saving configuration, a setting of setting energy saving configuration autonomously, and the like.
Time corresponding to a configuration: it may be expressed by one or more of the following: timestamp, time point, time interval, timer, time period, time length, etc. Herein, the time length may be a length of time from a certain time point, which may be the current time. The time may be a relative time or an absolute time. This configuration may be a transmission power configuration, a channel and/or signal configuration, or any other configuration mentioned in the present disclosure, for example, a configuration of a wake-up signal, an energy saving configuration, a setting of setting energy saving configuration autonomously, and the like. Herein, the time may include one or more of the following: activation time, deactivation time, applicable time, inapplicable time, offset, start time, end time, active time, inactive time, long period, short period, retransmission time, Hybrid Automatic Repeat reQuest round-trip time, etc.
Suggested and/or requested energy saving configuration mode: it may include static configuration, semi-static configuration, dynamic configuration, periodic configuration, aperiodic configuration, semi-periodic configuration, etc.
Triggering condition corresponding to application of a configuration: when a certain condition is met, an operation of applying the configuration is performed. It may include, for example, one or more of the following: receiving a certain signaling, transmitting a certain signaling, being in a certain mode at present, meeting a timer, load situation and/or resource status being less than and/or less than or equal to and/or greater than and/or greater than or equal to a certain threshold, a change of coverage state of oneself and/or a neighboring cell, etc. It should be understood that the signaling, modes, timers, etc. described herein can be one or more of any existing or future signaling, modes, timers, etc. unless otherwise specified, and are not limited herein. This configuration may be a transmission power configuration, a channel and/or signal configuration, or any other configuration mentioned in the present disclosure, for example, a configuration of a wake-up signal, an energy saving configuration, a setting of setting energy saving configuration autonomously, and the like.
Coverage state change identification: identify this coverage state change.
Suggested and/or requested coverage state: it may include increasing coverage, decreasing coverage, etc., and may also be expressed by indexes, where one index corresponds to a group of related coverage configurations. It may be a suggestion for the current case or a suggestion for the prediction.
Scope corresponding to suggested and/or requested coverage state: it may be identifications and/or identification lists of one or more of the following: cell, beam, transmitting and receiving point, node, SSB, SSB, slice (for example, it may be identified by Single Network Slice Selection Assistance Information (S-NSSAI)), etc. It may be a suggestion for the current case or a suggestion for the prediction. Herein, the QoS level and/or QoS type may be identified by one or more of the following: 5G QoS Identifier (5QI), Qos Flow Identifier (QFI), etc.
Time of change of a coverage state: it may be expressed by one or more of the following: timestamp, time point, time interval, timer, time period, time length, etc.

Herein, the time length may be a length of time from a certain time point, which may be the current time. The time may be a relative time or an absolute time. Herein, the time and/or time mode may include one or more of the following: activation time, deactivation time, applicable time, inapplicable time, start time, end time, etc.
Triggering condition for coverage change: when a certain condition is met, an operation of changing coverage state is performed. It may include, for example, one or more of the following: receiving a certain signaling, transmitting a certain signaling, being in a certain mode at present, meeting a timer, load situation and/or resource status being less than and/or less than or equal to and/or greater than and/or greater than or equal to a certain threshold, receiving information of coverage change of a neighboring cell, decreasing coverage of a neighboring cell, a change of coverage state of oneself and/or a neighboring cell, etc. It should be understood that the signaling, modes, timers, etc. described herein can be one or more of any existing or future signaling, modes, timers, etc. unless otherwise specified, and are not limited herein.
Source of activation and/or deactivation and/or a request: used to indicate an issuing node and/or a source node of the activation and/or deactivation and/or request. The source may be represented by a node and/or a node identification. For example, if the activation is from a user, the source is the user and/or the user identification. If the activation is from a user, the source may be a user in a Radio Resource Control (RRC) connected state, or a user in an RRC inactive state or a user in an RRC idle state.
Cause for activation and/or deactivation and/or a request: used to indicate reasons for the activation and/or deactivation and/or request, which may include one or more of the following: a change of load of oneself and/or a neighboring cell (increasing and/or decreasing), a change of coverage state of oneself and/or a neighboring cell (increasing and/or decreasing), reception of a request from UE, reception of a request from a neighboring cell and/or a neighboring node, and triggering by an event, etc.
Interface instance indication: used to indicate a destination interface of this message, which may be UU and/or Xn and/or X2 and/or F1 and/or E1 and/or NG.

In some implementations, the first node may transmit a fourth message including a response to the request to activate a network in an energy saving state and/or deactivate a network in a non-energy saving state to the second node according to the received third message including the request to activate a network in an energy saving state and/or deactivate a network in a non-energy saving state, so as to inform the second node of the configuration that can be activated, etc. If the request received by the first node including activating the network in an energy saving state and/or deactivating the network in a non-energy saving state is to request the first node to update the network energy saving configuration, then the first node accepts and/or rejects the request according to its own situation, and transmits a fourth message including a response to the request to activate a network in an energy saving state and/or deactivate a network in a non-energy saving state to the second node. If the request is accepted and/or partially accepted, the first node updates all and/or part of the network energy saving configuration according to the accepted part of request; and if the request is rejected and/or partially rejected, the first node maintains all and/or part of the network energy saving configuration. Alternatively, if the request received by the first node including activating the network in an energy saving state and/or deactivating the network in a non-energy saving state is to request the second node to update the network energy saving configuration, then the first node accepts and/or rejects the request according to its own situation, and transmits a fourth message including a response to the request to activate a network in an energy saving state and/or deactivate a network in a non-energy saving state to the second node, so as to avoid the situation that the second node updates the network energy saving configuration only according to its own situation thus resulting in coverage blank, local overload and the like, and make the energy saving configuration updating more suitable. If the fourth message includes accepting and/or partially accepting the request, the second node updates all and/or part of the network energy saving configuration according to the accepted part of request; if the fourth message includes the rejection and/or partial rejection of the request, the second node maintains all and/or part of the network energy saving configuration.

In some implementations, the fourth message may be or be included in one or more of the following: an XN SETUP REQUEST message or an XN SETUP RESPONSE message of Xn; or an ENB CONFIGURATION UPDATE message or an ENB CONFIGURATION UPDATE ACKNOWLEDGE message or an EN-DC CONFIGURATION UPDATE message or an EN-DC CONFIGURATION UPDATE ACKNOWLEDGE message of X2; or an NG-RAN NODE CONFIGURATION UPDATE message or an NG-RAN NODE CONFIGURATION UPDATE ACKNOWLEDGE message of Xn; or a CELL ACTIVATION REQUEST message or a CELL ACTIVATION RESPONSE message or a CELL ACTIVATION FAILURE message of Xn or X2; or an EN-DC CELL ACTIVATION REQUEST message or an EN-DC CELL ACTIVATION RESPONSE message or an EN-DC CELL ACTIVATION FAILURE message of X2; or a RESET REQUEST message of X2 or Xn; or a MOBILITY CHANGE REQUEST message of X2; or an F1 SETUP REQUEST message or an F1 SETUP RESPONSE message or a GNB-DU CONFIGURATION UPDATE message or a GNB-DU CONFIGURATION UPDATE ACKNOWLEDGE message or a GNB-CU CONFIGURATION UPDATE message or a GNB-CU CONFIGURATION UPDATE ACKNOWLEDGE message or a GNB-DU RESOURCE COORDINATION REQUEST message or a GNB-DU RESOURCE COORDINATION RESPONSE message of F1; or a GNB-CU-UP E1 SETUP REQUEST message or a GNB-CU-UP E1 SETUP RESPONSE message or a GNB-CU-CP E1 SETUP REQUEST message or a GNB-CU-CP E1 SETUP RESPONSE message or a GNB-CU-UP CONFIGURATION UPDATE message or a GNB-CU-UP CONFIGURATION UPDATE ACKNOWLEDGE message or a GNB-CU-CP CONFIGURATION UPDATE message or a gNB-CU-CP CONFIGURATION UPDATE ACKNOWLEDGE message of E1; or a RESOURCE STATUS REQUEST message of X2 or Xn or F1 or E1, or an EN-DC RESOURCE STATUS REQUEST message of X2; or a RESOURCE STATUS RESPONSE message or a RESOURCE STATUS FAILURE message or a RESOURCE STATUS UPDATE message of X2 or Xn or F1 or E1; or an RESOURCE STATUS RESPONSE message and/or an EN-DC RESOURCE STATUS FAILURE message and/or an EN-DC RESOURCE STATUS UPDATE message of X2; or an UPLINK RAN CONFIGURATION TRANSFER message and a DOWNLINK RAN CONFIGURATION TRANSFER message of NG; a HANDOVER REQUEST message or a RETRIEVE UE CONTEXT RESPONSE message or a RETRIEVE UE CONTEXT FAILURE message of X2 or Xn; or a SENB ADDITION REQUEST message or a SGNB ADDITION REQUEST message of X2; or an S-NODE ADDITION REQUEST message of Xn; or a BEARER CONTEXT SETUP REQUEST message of E1; or an other and/or newly defined RRC and/or Xn and/or X2 and/or F1 and/or E1 and/or NG message.

In some implementations, the fourth message may include one or more of the following fields and/or related information:
Transmitting node identification: an identification of a node that transmits the fourth message.
Receiving node identification: an identification of a node that receives the fourth message.
Activation identification: identifies the activation.
Corresponding scope that can be activated: it may be identifications and/or identification lists of one or more of the following: cell, slice (for example, it may be identified by Single Network Slice Selection Assistance Information (S-NSSAI)), Bandwidth Part (BWP), subframe, slot, symbol, carrier, service, Quality of Service (QoS) level, QoS flow, Protocol Data Unit (PDU) session, data Radio Bearer (DRB), beam, transmitting and receiving point, node, SSB, Resource Block, etc. This field may be for the current activation request or for the predicted activation request. Herein, the QoS level and/or QoS type may be identified by one or more of the following: 5G QoS Identifier (5QI), Qos Flow Identifier (QFI), etc.
Activatable configuration: this configuration may be a current configuration or a predicted configuration. It may include one or more of the following:
   not transmitting downlink channels (all or any downlink channels)
   not receiving uplink channels (all or any downlink channels)
   not transmitting a predefined downlink channel
   not receiving a predefined uplink channel
   transmitting downlink channels (all or any downlink channels)
   receiving uplink channels (all or any uplink channels)
   transmitting a predefined downlink channel
   receiving a predefined uplink channel
   Synchronization Signal Block (SSB) configuration: it may be a configuration in an energy saving mode or a configuration in a non-energy saving mode. The SSB configuration may be one and/or a set of configuration parameters, which may include one or more of the following: cell identification, SSB frequency, SSB subcarrier spacing, SSB transmission power, SSB period, SSB half subframe index, SSB system frame number offset, initial time of system frame number, SSB position, etc. The SSB position may be an SSB Position in Burst, including one or more of the following: short bitmap, medium bitmap and long bitmap. The SSB configuration may also be a configuration index, where one index corresponds to a set of defined configuration parameters, which may include the above parameters of the SSB configuration, etc. The SSB configuration may also be an energy saving and/or non-energy saving mode that the SSB is in, which may include one or more of the following: switch-on, switch-off, activation, deactivation, network energy saving state, non-network energy saving state, sleep, non-sleep, deep sleep, light sleep, micro sleep, active uplink (active UL), active downlink (active DL), SSB normal state, SSB reduced (SSB-less and/or light SSB) state, SSB-free state, simplified SSB, partial SSB, transmission power decrease and/or increase, coverage increase and/or decrease, etc. Herein, the SSB reduced state may identify the configuration of SSB by an index, or may identify the configuration of SSB by specific parameters.
   Master Information Block (MIB) configuration: it may be a configuration in an energy saving mode or a configuration in a non-energy saving mode. The MIB configuration may be one and/or a set of configuration parameters, which may include one or more of the following: cell identification, MIB frequency, MIB subcarrier spacing, MIB transmission power, MIB period, MIB repetition, MIB position, etc. The MIB configuration may also be a configuration index, where one index corresponds to a set of defined configuration parameters, which may include the above parameters of the MIB configuration, etc. The MIB configuration may also be an energy saving and/or non-energy saving mode that the MIB is in, which may include one or more of the following: switch-on, switch-off, activation, deactivation, network energy saving state, non-network energy saving state, sleep, non-sleep, deep sleep, light sleep, micro sleep, active uplink (active UL), active downlink (active DL), MIB normal state, MIB reduced (MIB-less and/or light MIB) state, MIB-free state, simplified MIB, partial MIB, MIB-free state, transmission power decrease and/or increase, coverage increase and/or decrease, etc. Herein, the MIB reduced state may identify the configuration of MIB by an index, or may identify the configuration of MIB by specific parameters.
   System Information Block (SIB) configuration: it may be a configuration in an energy saving mode or a configuration in a non-energy saving mode. The SIB configuration may be one and/or a set of configuration parameters, which may include one or more of the following: cell identification, SIB frequency, SIB subcarrier spacing, SIB transmission power, SIB period, SIB repetition, SIB position, etc. The SIB configuration may also be a configuration index, where one index corresponds to a set of defined configuration parameters, which may include the above parameters of the SIB configuration, etc. The SIB configuration may also be an energy saving and/or non-energy saving mode that the SIB is in, which may include one or more of the following: switch-on, switch-off, activation, deactivation, network energy saving state, non-network energy saving state, sleep, non-sleep, deep sleep, light sleep, micro sleep, active uplink (active UL), active downlink (active DL), SIB normal state, SIB reduced (SIB-less and/or light SIB) state, SIB-free state, simplified SIB, partial SIB, transmission power decrease and/or increase, coverage increase and/or decrease, etc. Herein, the SIB reduced state may identify the configuration of SIB by an index, or may identify the configuration of SIB by specific parameters.
   Scope corresponding to the above configuration that can be activated: it may include one or more of the following: service, QoS type, QoS level, etc. In an implementation, for example, one or more service types are applicable to the above configuration, and other services are not applicable to the above configuration; alternatively, one or more service types are not applicable to the above configuration, and other services are applicable to the above configuration. In another implementation, for example, one or more QoS types and/or QoS levels are applicable to the above configuration, and other services are not applicable to the above configuration. Alternatively, one or more QoS types and/or QoS levels are not applicable to the above configuration, and other services are applicable to the above configuration. Herein, the QoS level and/or QoS type may be identified by one or more of the following: 5G QoS Identifier (5QI), Qos Flow Identifier (QFI), etc.
   Time mode corresponding to the above configuration: it may include one or more of the following: part of time periods is applicable, part of time periods is inapplicable, applicable time periods, inapplicable time periods, mode index, time mode configuration, active time, inactive time, etc. Herein, one mode index corresponds to one configuration. For example, it may be that part of time periods is for transmission and/or part of time periods is not for transmission. Herein, the active time may be the time when reception and/or transmission can be performed. Herein, the inactive time may be the time when reception and/or transmission is not performed. This mode can be aimed at one configuration or multiple configurations of the above configurations. In an implementation, for example, it may be that the time not used for reception may be used for transmission. In another implementation, for example, it may be that part of the active time is for transmission, and another part is for reception, etc.
   Frequency mode corresponding to the above configuration: it may include one or more of the following: part of frequencies is applicable, part of frequencies is inapplicable, applicable frequencies, inapplicable frequencies, mode index, active frequencies, inactive frequencies, etc. Herein, one mode index corresponds to one configuration. For example, it may be that part of frequencies is for transmission and/or part of frequencies is not for transmission. Herein, an active frequency can be the frequency at which reception and/or transmission can be performed. Herein, an inactive frequency may be the frequency at which reception and/or transmission is not performed. This mode can be aimed at one configuration or multiple configurations of the above configurations. In an implementation, for example, it may be that frequencies not used for reception may be used for transmission. In another implementation, for example, it may be that part of the active frequencies is for transmission, and another part is for reception, etc.
   Indication of joint configuration: used to indicate whether the energy saving configuration is a joint configuration. In an implementation, for example, the configuration may be a joint configuration for reception and transmission. In an implementation, for example, a joint configuration mode can be predefined. Transmission of this indication enables that while part of the configuration is transmitted, another part of the configuration can be not transmitted, and a node receiving this message can derive another part of the configuration through the predefined joint configuration mode and the part of the configuration, thus achieving an effect of signaling saving. Modes of joint configuration may include but are not limited to:
      Time and/or frequency bands not used for reception can be used for transmission.
      A part of the active time and/or frequency bands is for transmission, and another part is for reception.
      Active time and/or frequency bands are for reception, and inactive time and/or frequency bands are for transmission.
      Inactive time and/or frequency bands are for reception, and active time and/or frequency bands are for transmission.
   Index of joint configuration: used to identify whether the configuration is a joint configuration and/or identify the index corresponding to the joint configuration. In an implementation, for example, the configuration may be a joint configuration for reception and transmission. In an implementation, for example, a variety of joint configuration modes can be predefined and identified by indexes. Transmission of this index enables that while part of the configuration is transmitted, another part of the configuration can be not transmitted, and a node receiving this message can derive another part of the configuration through the predefined joint configuration mode corresponding to the index and the part of the configuration, thus achieving an effect of signaling saving. Modes of joint configuration may include but are not limited to:
      Time and/or frequency bands not used for reception can be used for transmission.
      A part of the active time and/or frequency bands is for transmission, and another part is for reception.
      Active time and/or frequency bands are for reception, and inactive time and/or frequency bands are for transmission.
      Inactive time and/or frequency bands are for reception, and active time and/or frequency bands are for transmission.
   Energy saving configuration mode: it may include static configuration, semi-static configuration, dynamic configuration, periodic configuration, aperiodic configuration, semi-periodic configuration, etc.
Activatable time: indicates the time when activation can be performed. It may be an absolute time or a relative time.
Entered energy saving related state and/or mode: used to indicate an energy saving related state and/or mode that a network has entered, or an energy saving related state and/or mode that can be entered in the future. It may be one or more of the following: switch-on, switch-off, activation, deactivation, energy saving state, non-energy saving state, sleep, non-sleep, deep sleep, light sleep, micro sleep, active uplink (active UL), active downlink (active DL), SSB configuration, MIB configuration, SIB configuration, transmission power decrease and/or increase, coverage increase and/or decrease, etc. The state and/or mode may be for one or more of the following: uplink, downlink, uplink or downlink, uplink and downlink. The Synchronization Signal Block (SSB) configuration may be a configuration in an energy saving mode or a configuration in a non-energy saving mode. The SSB configuration may be one and/or a set of configuration parameters, which may include one or more of the following: cell identification, SSB frequency, SSB subcarrier spacing, SSB transmission power, SSB period, SSB half subframe index, SSB system frame number offset, initial time of system frame number, SSB position, etc. The SSB position may be an SSB Position in Burst, including one or more of the following: short bitmap, medium bitmap and long bitmap. The SSB configuration may also be a configuration index, where one index corresponds to a set of defined configuration parameters, which may include the above parameters of the SSB configuration, etc. The SSB configuration may also be an energy saving and/or non-energy saving mode that the SSB is in, which may include one or more of the following: switch-on, switch-off, activation, deactivation, network energy saving state, non-network energy saving state, sleep, non-sleep, deep sleep, light sleep, micro sleep, active uplink (active UL), active downlink (active DL), SSB normal state, SSB reduced (SSB-less and/or light SSB) state, SSB-free state, simplified SSB, partial SSB, transmission power decrease and/or increase, coverage increase and/or decrease, etc. Herein, the SSB reduced state may identify the configuration of SSB by an index, or may identify the configuration of SSB by specific parameters. The Master Information Block (MIB) configuration may be a configuration in an energy saving mode or a configuration in a non-energy saving mode. The MIB configuration may be one and/or a set of configuration parameters, which may include one or more of the following: cell identification, MIB frequency, MIB subcarrier spacing, MIB transmission power, MIB period, MIB repetition, MIB position, etc. The MIB configuration may also be a configuration index, where one index corresponds to a set of defined configuration parameters, which may include the above parameters of the MIB configuration, etc. The MIB configuration may also be an energy saving and/or non-energy saving mode that the MIB is in, which may include one or more of the following: switch-on, switch-off, activation, deactivation, network energy saving state, non-network energy saving state, sleep, non-sleep, deep sleep, light sleep, micro sleep, active uplink (active UL), active downlink (active DL), MIB normal state, MIB reduced (MIB-less and/or light MIB) state, MIB-free state, simplified MIB, partial MIB, MIB-free state, transmission power decrease and/or increase, coverage increase and/or decrease, etc. Herein, the MIB reduced state may identify the configuration of MIB by an index, or may identify the configuration of MIB by specific parameters. The System Information Block (SIB) configuration may be a configuration in an energy saving mode or a configuration in a non-energy saving mode. The SIB configuration may be one and/or a set of configuration parameters, which may include one or more of the following: cell identification, SIB frequency, SIB subcarrier spacing, SIB transmission power, SIB period, SIB repetition, SIB position, etc. The SIB configuration may also be a configuration index, where one index corresponds to a set of defined configuration parameters, which may include the above parameters of the SIB configuration, etc. The SIB configuration may also be an energy saving and/or non-energy saving mode that the SIB is in, which may include one or more of the following: switch-on, switch-off, activation, deactivation, network energy saving state, non-network energy saving state, sleep, non-sleep, deep sleep, light sleep, micro sleep, active uplink (active UL), active downlink (active DL), SIB normal state, SIB reduced (SIB-less and/or light SIB) state, SIB-free state, simplified SIB, partial SIB, transmission power decrease and/or increase, coverage increase and/or decrease, etc. Herein, the SIB reduced state may identify the configuration of SIB by an index, or may identify the configuration of SIB by specific parameters.
Time corresponding to an entered energy saving related state and/or mode: it may be an absolute time or a relative time.
Corresponding scope that is activated: it may be identifications and/or identification lists of one or more of the following: cell, slice (for example, it may be identified by Single Network Slice Selection Assistance Information (S-NSSAI)), Bandwidth Part (BWP), subframe, slot, symbol, carrier, service, Quality of Service (QOS) level, QoS flow, Protocol Data Unit (PDU) session, data Radio Bearer (DRB), beam, transmitting and receiving point, node, SSB, Resource Block, etc. This field may be for the current activation request or for the predicted activation request. Herein, the QoS level and/or QoS type may be identified by one or more of the following: 5G QoS Identifier (5QI), Qos Flow Identifier (QFI), etc.
Activated configuration: it may include one or more of the following:
   not transmitting downlink channels (all or any downlink channels)
   not receiving uplink channels (all or any downlink channels)
   not transmitting a predefined downlink channel
   not receiving a predefined uplink channel
   transmitting downlink channels (all or any downlink channels)
   receiving uplink channels (all or any uplink channels)
   transmitting a predefined downlink channel
   receiving a predefined uplink channel
   Synchronization Signal Block (SSB) configuration: it may be a configuration in an energy saving mode or a configuration in a non-energy saving mode. The SSB configuration may be one and/or a set of configuration parameters, which may include one or more of the following: cell identification, SSB frequency, SSB subcarrier spacing, SSB transmission power, SSB period, SSB half subframe index, SSB system frame number offset, initial time of system frame number, SSB position, etc. The SSB position may be an SSB Position in Burst, including one or more of the following: short bitmap, medium bitmap and long bitmap. The SSB configuration may also be a configuration index, where one index corresponds to a set of defined configuration parameters, which may include the above parameters of the SSB configuration, etc. The SSB configuration may also be an energy saving and/or non-energy saving mode that the SSB is in, which may include one or more of the following: switch-on, switch-off, activation, deactivation, network energy saving state, non-network energy saving state, sleep, non-sleep, deep sleep, light sleep, micro sleep, active uplink (active UL), active downlink (active DL), SSB normal state, SSB reduced (SSB-less and/or light SSB) state, SSB-free state, simplified SSB, partial SSB, transmission power decrease and/or increase, coverage increase and/or decrease, etc. Herein, the SSB reduced state may identify the configuration of SSB by an index, or may identify the configuration of SSB by specific parameters.
   Master Information Block (MIB) configuration: it may be a configuration in an energy saving mode or a configuration in a non-energy saving mode. The MIB configuration may be one and/or a set of configuration parameters, which may include one or more of the following: cell identification, MIB frequency, MIB subcarrier spacing, MIB transmission power, MIB period, MIB repetition, MIB position, etc. The MIB configuration may also be a configuration index, where one index corresponds to a set of defined configuration parameters, which may include the above parameters of the MIB configuration, etc. The MIB configuration may also be an energy saving and/or non-energy saving mode that the MIB is in, which may include one or more of the following: switch-on, switch-off, activation, deactivation, network energy saving state, non-network energy saving state, sleep, non-sleep, deep sleep, light sleep, micro sleep, active uplink (active UL), active downlink (active DL), MIB normal state, MIB reduced (MIB-less and/or light MIB) state, MIB-free state, simplified MIB, partial MIB, MIB-free state, transmission power decrease and/or increase, coverage increase and/or decrease, etc. Herein, the MIB reduced state may identify the configuration of MIB by an index, or may identify the configuration of MIB by specific parameters.
   System Information Block (SIB) configuration: it may be a configuration in an energy saving mode or a configuration in a non-energy saving mode. The SIB configuration may be one and/or a set of configuration parameters, which may include one or more of the following: cell identification, SIB frequency, SIB subcarrier spacing, SIB transmission power, SIB period, SIB repetition, SIB position, etc. The SIB configuration may also be a configuration index, where one index corresponds to a set of defined configuration parameters, which may include the above parameters of the SIB configuration, etc. The SIB configuration may also be an energy saving and/or non-energy saving mode that the SIB is in, which may include one or more of the following: switch-on, switch-off, activation, deactivation, network energy saving state, non-network energy saving state, sleep, non-sleep, deep sleep, light sleep, micro sleep, active uplink (active UL), active downlink (active DL), SIB normal state, SIB reduced (SIB-less and/or light SIB) state, SIB-free state, simplified SIB, partial SIB, transmission power decrease and/or increase, coverage increase and/or decrease, etc. Herein, the SIB reduced state may identify the configuration of SIB by an index, or may identify the configuration of SIB by specific parameters.
   Scope corresponding to the above activated configuration: it may include one or more of the following: service, QoS type, QoS level, etc. In an implementation, for example, one or more service types are applicable to the above configuration, and other services are not applicable to the above configuration; alternatively, one or more service types are not applicable to the above configuration, and other services are applicable to the above configuration. In another implementation, for example, one or more QoS types and/or QoS levels are applicable to the above configuration, and other services are not applicable to the above configuration. Alternatively, one or more QoS types and/or QoS levels are not applicable to the above configuration, and other services are applicable to the above configuration. Herein, the QoS level and/or QoS type may be identified by one or more of the following: 5G QoS Identifier (5QI), Qos Flow Identifier (QFI), etc.
   Time mode corresponding to the above configuration: it may include one or more of the following: part of time periods is applicable, part of time periods is inapplicable, applicable time periods, inapplicable time periods, mode index, time mode configuration, active time, inactive time, etc. Herein, one mode index corresponds to one configuration. For example, it may be that part of time periods is for transmission and/or part of time periods is not for transmission. Herein, the active time may be the time when reception and/or transmission can be performed. Herein, the inactive time may be the time when reception and/or transmission is not performed. This mode can be aimed at one configuration or multiple configurations of the above configurations. In an implementation, for example, it may be that the time not used for reception may be used for transmission. In another implementation, for example, it may be that part of the active time is for transmission, and another part is for reception, etc.
   Frequency mode corresponding to the above configuration: it may include one or more of the following: part of frequencies is applicable, part of frequencies is inapplicable, applicable frequencies, inapplicable frequencies, mode index, active frequencies, inactive frequencies, etc. Herein, one mode index corresponds to one configuration. For example, it may be that part of frequencies is for transmission and/or part of frequencies is not for transmission. Herein, an active frequency can be the frequency at which reception and/or transmission can be performed. Herein, an inactive frequency may be the frequency at which reception and/or transmission is not performed. This mode can be aimed at one configuration or multiple configurations of the above configurations. In an implementation, for example, it may be that frequencies not used for reception may be used for transmission. In another implementation, for example, it may be that part of the active frequencies is for transmission, and another part is for reception, etc.
   Indication of joint configuration: used to indicate whether the energy saving configuration is a joint configuration. In an implementation, for example, the configuration may be a joint configuration for reception and transmission. In an implementation, for example, a joint configuration mode can be predefined. Transmission of this indication enables that while part of the configuration is transmitted, another part of the configuration can be not transmitted, and a node receiving this message can derive another part of the configuration through the predefined joint configuration mode and the part of the configuration, thus achieving an effect of signaling saving. Modes of joint configuration may include but are not limited to:
      Time and/or frequency bands not used for reception can be used for transmission.
      A part of the active time and/or frequency bands is for transmission, and another part is for reception.
      Active time and/or frequency bands are for reception, and inactive time and/or frequency bands are for transmission.
      Inactive time and/or frequency bands are for reception, and active time and/or frequency bands are for transmission.
   Index of joint configuration: used to identify whether the configuration is a joint configuration and/or identify the index corresponding to the joint configuration. In an implementation, for example, the configuration may be a joint configuration for reception and transmission. In an implementation, for example, a variety of joint configuration modes can be predefined and identified by indexes. Transmission of this index enables that while part of the configuration is transmitted, another part of the configuration can be not transmitted, and a node receiving this message can derive another part of the configuration through the predefined joint configuration mode corresponding to the index and the part of the configuration, thus achieving an effect of signaling saving. Modes of joint configuration may include but are not limited to:
      Time and/or frequency bands not used for reception can be used for transmission.
      A part of the active time and/or frequency bands is for transmission, and another part is for reception.
      Active time and/or frequency bands are for reception, and inactive time and/or frequency bands are for transmission.
      Inactive time and/or frequency bands are for reception, and active time and/or frequency bands are for transmission.
Activated time: indicates the time when the activation is performed. It may be an absolute time or a relative time.
Energy saving configuration mode information:
   Activated energy saving configuration mode: it may include static configuration, semi-static configuration, dynamic configuration, periodic configuration, aperiodic configuration, semi-periodic configuration, etc.
   Deactivated energy saving configuration mode: it may include static configuration, semi-static configuration, dynamic configuration, periodic configuration, aperiodic configuration, semi-periodic configuration, etc.
   Energy saving configuration mode that can be activated: it may include static configuration, semi-static configuration, dynamic configuration, periodic configuration, aperiodic configuration, semi-periodic configuration, etc.
   Energy saving configuration mode that cannot be activated: it may include static configuration, semi-static configuration, dynamic configuration, periodic configuration, aperiodic configuration, semi-periodic configuration, etc.
   Energy saving configuration mode that can be deactivated: it may include static configuration, semi-static configuration, dynamic configuration, periodic configuration, aperiodic configuration, semi-periodic configuration, etc.
   Energy saving configuration mode that cannot be deactivated: it may include static configuration, semi-static configuration, dynamic configuration, periodic configuration, aperiodic configuration, semi-periodic configuration, etc.
   Energy saving configuration mode that can be applied: it may include static configuration, semi-static configuration, dynamic configuration, periodic configuration, aperiodic configuration, semi-periodic configuration, etc.
   Energy saving configuration mode that cannot be applied: it may include static configuration, semi-static configuration, dynamic configuration, periodic configuration, aperiodic configuration, semi-periodic configuration, etc.
Corresponding scope that cannot be activated: it may be identifications and/or identification lists of one or more of the following: cell, slice (for example, it may be identified by Single Network Slice Selection Assistance Information (S-NSSAI)), Bandwidth Part (BWP), subframe, slot, symbol, carrier, service, Quality of Service (QoS) level, QoS flow, Protocol Data Unit (PDU) session, data Radio Bearer (DRB), beam, transmitting and receiving point, node, SSB, Resource Block, etc. This field may be for the current activation request or for the predicted activation request. Herein, the QoS level and/or QoS type may be identified by one or more of the following: 5G QoS Identifier (5QI), Qos Flow Identifier (QFI), etc.
Configuration that cannot be activated: this configuration may be a current configuration or a predicted configuration. It may include one or more of the following:
   not transmitting downlink channels (all or any downlink channels)
   not receiving uplink channels (all or any downlink channels)
   not transmitting a predefined downlink channel
   not receiving a predefined uplink channel
   transmitting downlink channels (all or any downlink channels)
   receiving uplink channels (all or any uplink channels)
   transmitting a predefined downlink channel
   receiving a predefined uplink channel
   Synchronization Signal Block (SSB) configuration: it may be a configuration in an energy saving mode or a configuration in a non-energy saving mode. The SSB configuration may be one and/or a set of configuration parameters, which may include one or more of the following: cell identification, SSB frequency, SSB subcarrier spacing, SSB transmission power, SSB period, SSB half subframe index, SSB system frame number offset, initial time of system frame number, SSB position, etc. The SSB position may be an SSB Position in Burst, including one or more of the following: short bitmap, medium bitmap and long bitmap. The SSB configuration may also be a configuration index, where one index corresponds to a set of defined configuration parameters, which may include the above parameters of the SSB configuration, etc. The SSB configuration may also be an energy saving and/or non-energy saving mode that the SSB is in, which may include one or more of the following: switch-on, switch-off, activation, deactivation, network energy saving state, non-network energy saving state, sleep, non-sleep, deep sleep, light sleep, micro sleep, active uplink (active UL), active downlink (active DL), SSB normal state, SSB reduced (SSB-less and/or light SSB) state, SSB-free state, simplified SSB, partial SSB, transmission power decrease and/or increase, coverage increase and/or decrease, etc. Herein, the SSB reduced state may identify the configuration of SSB by an index, or may identify the configuration of SSB by specific parameters.
   Master Information Block (MIB) configuration: it may be a configuration in an energy saving mode or a configuration in a non-energy saving mode. The MIB configuration may be one and/or a set of configuration parameters, which may include one or more of the following: cell identification, MIB frequency, MIB subcarrier spacing, MIB transmission power, MIB period, MIB repetition, MIB position, etc. The MIB configuration may also be a configuration index, where one index corresponds to a set of defined configuration parameters, which may include the above parameters of the MIB configuration, etc. The MIB configuration may also be an energy saving and/or non-energy saving mode that the MIB is in, which may include one or more of the following: switch-on, switch-off, activation, deactivation, network energy saving state, non-network energy saving state, sleep, non-sleep, deep sleep, light sleep, micro sleep, active uplink (active UL), active downlink (active DL), MIB normal state, MIB reduced (MIB-less and/or light MIB) state, MIB-free state, simplified MIB, partial MIB, MIB-free state, transmission power decrease and/or increase, coverage increase and/or decrease, etc. Herein, the MIB reduced state may identify the configuration of MIB by an index, or may identify the configuration of MIB by specific parameters.
   System Information Block (SIB) configuration: it may be a configuration in an energy saving mode or a configuration in a non-energy saving mode. The SIB configuration may be one and/or a set of configuration parameters, which may include one or more of the following: cell identification, SIB frequency, SIB subcarrier spacing, SIB transmission power, SIB period, SIB repetition, SIB position, etc. The SIB configuration may also be a configuration index, where one index corresponds to a set of defined configuration parameters, which may include the above parameters of the SIB configuration, etc. The SIB configuration may also be an energy saving and/or non-energy saving mode that the SIB is in, which may include one or more of the following: switch-on, switch-off, activation, deactivation, network energy saving state, non-network energy saving state, sleep, non-sleep, deep sleep, light sleep, micro sleep, active uplink (active UL), active downlink (active DL), SIB normal state, SIB reduced (SIB-less and/or light SIB) state, SIB-free state, simplified SIB, partial SIB, transmission power decrease and/or increase, coverage increase and/or decrease, etc. Herein, the SIB reduced state may identify the configuration of SIB by an index, or may identify the configuration of SIB by specific parameters.
   Scope corresponding to the above configuration that cannot be activated: it may include one or more of the following: service, QoS type, QoS level, etc. In an implementation, for example, one or more service types are applicable to the above configuration, and other services are not applicable to the above configuration; alternatively, one or more service types are not applicable to the above configuration, and other services are applicable to the above configuration. In another implementation, for example, one or more QoS types and/or QoS levels are applicable to the above configuration, and other services are not applicable to the above configuration. Alternatively, one or more QoS types and/or QoS levels are not applicable to the above configuration, and other services are applicable to the above configuration. Herein, the QOS level and/or QoS type may be identified by one or more of the following: 5G QoS Identifier (5QI), Qos Flow Identifier (QFI), etc.
   Time mode corresponding to the above configuration: it may include one or more of the following: part of time periods is applicable, part of time periods is inapplicable, applicable time periods, inapplicable time periods, mode index, time mode configuration, active time, inactive time, etc. Herein, one mode index corresponds to one configuration. For example, it may be that part of time periods is for transmission and/ or part of time periods is not for transmission. Herein, the active time may be the time when reception and/or transmission can be performed. Herein, the inactive time may be the time when reception and/or transmission is not performed. This mode can be aimed at one configuration or multiple configurations of the above configurations. In an implementation, for example, it may be that the time not used for reception may be used for transmission. In another implementation, for example, it may be that part of the active time is for transmission, and another part is for reception, etc.
   Frequency mode corresponding to the above configuration: it may include one or more of the following: part of frequencies is applicable, part of frequencies is inapplicable, applicable frequencies, inapplicable frequencies, mode index, active frequencies, inactive frequencies, etc. Herein, one mode index corresponds to one configuration. For example, it may be that part of frequencies is for transmission and/or part of frequencies is not for transmission. Herein, an active frequency can be the frequency at which reception and/or transmission can be performed. Herein, an inactive frequency may be the frequency at which reception and/or transmission is not performed. This mode can be aimed at one configuration or multiple configurations of the above configurations. In an implementation, for example, it may be that frequencies not used for reception may be used for transmission. In another implementation, for example, it may be that part of the active frequencies is for transmission, and another part is for reception, etc.
   Indication of joint configuration: used to indicate whether the energy saving configuration is a joint configuration. In an implementation, for example, the configuration may be a joint configuration for reception and transmission. In an implementation, for example, a joint configuration mode can be predefined. Transmission of this indication enables that while part of the configuration is transmitted, another part of the configuration can be not transmitted, and a node receiving this message can derive another part of the configuration through the predefined joint configuration mode and the part of the configuration, thus achieving an effect of signaling saving. Modes of joint configuration may include but are not limited to:
      Time and/or frequency bands not used for reception can be used for transmission.
      A part of the active time and/or frequency bands is for transmission, and another part is for reception.
      Active time and/or frequency bands are for reception, and inactive time and/or frequency bands are for transmission.
      Inactive time and/or frequency bands are for reception, and active time and/or frequency bands are for transmission.
   Index of joint configuration: used to identify whether the configuration is a joint configuration and/or identify the index corresponding to the joint configuration. In an implementation, for example, the configuration may be a joint configuration for reception and transmission. In an implementation, for example, a variety of joint configuration modes can be predefined and identified by indexes. Transmission of this index enables that while part of the configuration is transmitted, another part of the configuration can be not transmitted, and a node receiving this message can derive another part of the configuration through the predefined joint configuration mode corresponding to the index and the part of the configuration, thus achieving an effect of signaling saving. Modes of joint configuration may include but are not limited to:
      Time and/or frequency bands not used for reception can be used for transmission.
      A part of the active time and/or frequency bands is for transmission, and another part is for reception.
      Active time and/or frequency bands are for reception, and inactive time and/or frequency bands are for transmission.
      Inactive time and/or frequency bands are for reception, and active time and/or frequency bands are for transmission.
Deactivation identification: identifies the deactivation.
Corresponding scope that can be deactivated: it may be identifications and/or identification lists of one or more of the following: cell, slice (for example, it may be identified by Single Network Slice Selection Assistance Information (S-NSSAI)), Bandwidth Part (BWP), subframe, slot, symbol, carrier, service, Quality of Service (QoS) level, QoS flow, Protocol Data Unit (PDU) session, data Radio Bearer (DRB), beam, transmitting and receiving point, node, SSB, Resource Block, etc. This field may be for the current activation request or for the predicted activation request. Herein, the QoS level and/or QoS type may be identified by one or more of the following: 5G QoS Identifier (5QI), Qos Flow Identifier (QFI), etc.
Configuration that can be deactivated: this configuration may be a current configuration or a predicted configuration. It may include one or more of the following:
   not transmitting downlink channels (all or any downlink channels)
   not receiving uplink channels (all or any downlink channels)
   not transmitting a predefined downlink channel
   not receiving a predefined uplink channel
   transmitting downlink channels (all or any downlink channels)
   receiving uplink channels (all or any uplink channels)
   transmitting a predefined downlink channel
   receiving a predefined uplink channel
   Synchronization Signal Block (SSB) configuration: it may be a configuration in an energy saving mode or a configuration in a non-energy saving mode. The SSB configuration may be one and/or a set of configuration parameters, which may include one or more of the following: cell identification, SSB frequency, SSB subcarrier spacing, SSB transmission power, SSB period, SSB half subframe index, SSB system frame number offset, initial time of system frame number, SSB position, etc. The SSB position may be an SSB Position in Burst, including one or more of the following: short bitmap, medium bitmap and long bitmap. The SSB configuration may also be a configuration index, where one index corresponds to a set of defined configuration parameters, which may include the above parameters of the SSB configuration, etc. The SSB configuration may also be an energy saving and/or non-energy saving mode that the SSB is in, which may include one or more of the following: switch-on, switch-off, activation, deactivation, network energy saving state, non-network energy saving state, sleep, non-sleep, deep sleep, light sleep, micro sleep, active uplink (active UL), active downlink (active DL), SSB normal state, SSB reduced (SSB-less and/or light SSB) state, SSB-free state, simplified SSB, partial SSB, transmission power decrease and/or increase, coverage increase and/or decrease, etc. Herein, the SSB reduced state may identify the configuration of SSB by an index, or may identify the configuration of SSB by specific parameters.
   Master Information Block (MIB) configuration: it may be a configuration in an energy saving mode or a configuration in a non-energy saving mode. The MIB configuration may be one and/or a set of configuration parameters, which may include one or more of the following: cell identification, MIB frequency, MIB subcarrier spacing, MIB transmission power, MIB period, MIB repetition, MIB position, etc. The MIB configuration may also be a configuration index, where one index corresponds to a set of defined configuration parameters, which may include the above parameters of the MIB configuration, etc. The MIB configuration may also be an energy saving and/or non-energy saving mode that the MIB is in, which may include one or more of the following: switch-on, switch-off, activation, deactivation, network energy saving state, non-network energy saving state, sleep, non-sleep, deep sleep, light sleep, micro sleep, active uplink (active UL), active downlink (active DL), MIB normal state, MIB reduced (MIB-less and/or light MIB) state, MIB-free state, simplified MIB, partial MIB, MIB-free state, transmission power decrease and/or increase, coverage increase and/or decrease, etc. Herein, the MIB reduced state may identify the configuration of MIB by an index, or may identify the configuration of MIB by specific parameters.
   System Information Block (SIB) configuration: it may be a configuration in an energy saving mode or a configuration in a non-energy saving mode. The SIB configuration may be one and/or a set of configuration parameters, which may include one or more of the following: cell identification, SIB frequency, SIB subcarrier spacing, SIB transmission power, SIB period, SIB repetition, SIB position, etc. The SIB configuration may also be a configuration index, where one index corresponds to a set of defined configuration parameters, which may include the above parameters of the SIB configuration, etc. The SIB configuration may also be an energy saving and/or non-energy saving mode that the SIB is in, which may include one or more of the following: switch-on, switch-off, activation, deactivation, network energy saving state, non-network energy saving state, sleep, non-sleep, deep sleep, light sleep, micro sleep, active uplink (active UL), active downlink (active DL), SIB normal state, SIB reduced (SIB-less and/or light SIB) state, SIB-free state, simplified SIB, partial SIB, transmission power decrease and/or increase, coverage increase and/or decrease, etc. Herein, the SIB reduced state may identify the configuration of SIB by an index, or may identify the configuration of SIB by specific parameters.
   Scope corresponding to the above configuration that can be deactivated: it may include one or more of the following: service, QoS type, QoS level, etc. In an implementation, for example, one or more service types are applicable to the above configuration, and other services are not applicable to the above configuration; alternatively, one or more service types are not applicable to the above configuration, and other services are applicable to the above configuration. In another implementation, for example, one or more QoS types and/or QoS levels are applicable to the above configuration, and other services are not applicable to the above configuration. Alternatively, one or more QoS types and/or QoS levels are not applicable to the above configuration, and other services are applicable to the above configuration. Herein, the QoS level and/or QoS type may be identified by one or more of the following: 5G QoS Identifier (5QI), Qos Flow Identifier (QFI), etc.
   Time mode corresponding to the above configuration: it may include one or more of the following: part of time periods is applicable, part of time periods is inapplicable, applicable time periods, inapplicable time periods, mode index, time mode configuration, active time, inactive time, etc. Herein, one mode index corresponds to one configuration. For example, it may be that part of time periods is for transmission and/ or part of time periods is not for transmission. Herein, the active time may be the time when reception and/or transmission can be performed. Herein, the inactive time may be the time when reception and/or transmission is not performed. This mode can be aimed at one configuration or multiple configurations of the above configurations. In an implementation, for example, it may be that the time not used for reception may be used for transmission. In another implementation, for example, it may be that part of the active time is for transmission, and another part is for reception, etc.
   Frequency mode corresponding to the above configuration: it may include one or more of the following: part of frequencies is applicable, part of frequencies is inapplicable, applicable frequencies, inapplicable frequencies, mode index, active frequencies, inactive frequencies, etc. Herein, one mode index corresponds to one configuration. For example, it may be that part of frequencies is for transmission and/or part of frequencies is not for transmission. Herein, an active frequency can be the frequency at which reception and/or transmission can be performed. Herein, an inactive frequency may be the frequency at which reception and/or transmission is not performed. This mode can be aimed at one configuration or multiple configurations of the above configurations. In an implementation, for example, it may be that frequencies not used for reception may be used for transmission. In another implementation, for example, it may be that part of the active frequencies is for transmission, and another part is for reception, etc.
   Indication of joint configuration: used to indicate whether the energy saving configuration is a joint configuration. In an implementation, for example, the configuration may be a joint configuration for reception and transmission. In an implementation, for example, a joint configuration mode can be predefined. Transmission of this indication enables that while part of the configuration is transmitted, another part of the configuration can be not transmitted, and a node receiving this message can derive another part of the configuration through the predefined joint configuration mode and the part of the configuration, thus achieving an effect of signaling saving. Modes of joint configuration may include but are not limited to:
      Time and/or frequency bands not used for reception can be used for transmission.
      A part of the active time and/or frequency bands is for transmission, and another part is for reception.
      Active time and/or frequency bands are for reception, and inactive time and/or frequency bands are for transmission.
      Inactive time and/or frequency bands are for reception, and active time and/or frequency bands are for transmission.
   Index of joint configuration: used to identify whether the configuration is a joint configuration and/or identify the index corresponding to the joint configuration. In an implementation, for example, the configuration may be a joint configuration for reception and transmission. In an implementation, for example, a variety of joint configuration modes can be predefined and identified by indexes. Transmission of this index enables that while part of the configuration is transmitted, another part of the configuration can be not transmitted, and a node receiving this message can derive another part of the configuration through the predefined joint configuration mode corresponding to the index and the part of the configuration, thus achieving an effect of signaling saving. Modes of joint configuration may include but are not limited to:
      Time and/or frequency bands not used for reception can be used for transmission.
      A part of the active time and/or frequency bands is for transmission, and another part is for reception.
      Active time and/or frequency bands are for reception, and inactive time and/or frequency bands are for transmission.
      Inactive time and/or frequency bands are for reception, and active time and/or frequency bands are for transmission.
Time that can be deactivated: indicates the time when deactivation can be performed. It may be an absolute time or a relative time.
Corresponding scope that is deactivated: it may be identifications and/or identification lists of one or more of the following: cell, slice (for example, it may be identified by Single Network Slice Selection Assistance Information (S-NSSAI)), Bandwidth Part (BWP), subframe, slot, symbol, carrier, service, Quality of Service (QoS) level, QoS flow, Protocol Data Unit (PDU) session, data Radio Bearer (DRB), beam, transmitting and receiving point, node, SSB, Resource Block, etc. This field may be for the current activation request or for the predicted activation request. Herein, the QoS level and/or QoS type may be identified by one or more of the following: 5G QOS Identifier (5QI), Qos Flow Identifier (QFI), etc.
Deactivated configuration: it may include one or more of the following:
   not transmitting downlink channels (all or any downlink channels)
   not receiving uplink channels (all or any downlink channels)
   not transmitting a predefined downlink channel
   not receiving a predefined uplink channel
   transmitting downlink channels (all or any downlink channels)
   receiving uplink channels (all or any uplink channels)
   transmitting a predefined downlink channel
   receiving a predefined uplink channel
   Synchronization Signal Block (SSB) configuration: it may be a configuration in an energy saving mode or a configuration in a non-energy saving mode. The SSB configuration may be one and/or a set of configuration parameters, which may include one or more of the following: cell identification, SSB frequency, SSB subcarrier spacing, SSB transmission power, SSB period, SSB half subframe index, SSB system frame number offset, initial time of system frame number, SSB position, etc. The SSB position may be an SSB Position in Burst, including one or more of the following: short bitmap, medium bitmap and long bitmap. The SSB configuration may also be a configuration index, where one index corresponds to a set of defined configuration parameters, which may include the above parameters of the SSB configuration, etc. The SSB configuration may also be an energy saving and/or non-energy saving mode that the SSB is in, which may include one or more of the following: switch-on, switch-off, activation, deactivation, network energy saving state, non-network energy saving state, sleep, non-sleep, deep sleep, light sleep, micro sleep, active uplink (active UL), active downlink (active DL), SSB normal state, SSB reduced (SSB-less and/or light SSB) state, SSB-free state, simplified SSB, partial SSB, transmission power decrease and/or increase, coverage increase and/or decrease, etc. Herein, the SSB reduced state may identify the configuration of SSB by an index, or may identify the configuration of SSB by specific parameters.
   Master Information Block (MIB) configuration: it may be a configuration in an energy saving mode or a configuration in a non-energy saving mode. The MIB configuration may be one and/or a set of configuration parameters, which may include one or more of the following: cell identification, MIB frequency, MIB subcarrier spacing, MIB transmission power, MIB period, MIB repetition, MIB position, etc. The MIB configuration may also be a configuration index, where one index corresponds to a set of defined configuration parameters, which may include the above parameters of the MIB configuration, etc. The MIB configuration may also be an energy saving and/or non-energy saving mode that the MIB is in, which may include one or more of the following: switch-on, switch-off, activation, deactivation, network energy saving state, non-network energy saving state, sleep, non-sleep, deep sleep, light sleep, micro sleep, active uplink (active UL), active downlink (active DL), MIB normal state, MIB reduced (MIB-less and/or light MIB) state, MIB-free state, simplified MIB, partial MIB, MIB-free state, transmission power decrease and/or increase, coverage increase and/or decrease, etc. Herein, the MIB reduced state may identify the configuration of MIB by an index, or may identify the configuration of MIB by specific parameters.
   System Information Block (SIB) configuration: it may be a configuration in an energy saving mode or a configuration in a non-energy saving mode. The SIB configuration may be one and/or a set of configuration parameters, which may include one or more of the following: cell identification, SIB frequency, SIB subcarrier spacing, SIB transmission power, SIB period, SIB repetition, SIB position, etc. The SIB configuration may also be a configuration index, where one index corresponds to a set of defined configuration parameters, which may include the above parameters of the SIB configuration, etc. The SIB configuration may also be an energy saving and/or non-energy saving mode that the SIB is in, which may include one or more of the following: switch-on, switch-off, activation, deactivation, network energy saving state, non-network energy saving state, sleep, non-sleep, deep sleep, light sleep, micro sleep, active uplink (active UL), active downlink (active DL), SIB normal state, SIB reduced (SIB-less and/or light SIB) state, SIB-free state, simplified SIB, partial SIB, transmission power decrease and/or increase, coverage increase and/or decrease, etc. Herein, the SIB reduced state may identify the configuration of SIB by an index, or may identify the configuration of SIB by specific parameters.
   Scope corresponding to the above deactivated configuration: it may include one or more of the following: service, QoS type, QoS level, etc. In an implementation, for example, one or more service types are applicable to the above configuration, and other services are not applicable to the above configuration; alternatively, one or more service types are not applicable to the above configuration, and other services are applicable to the above configuration. In another implementation, for example, one or more QoS types and/or QoS levels are applicable to the above configuration, and other services are not applicable to the above configuration. Alternatively, one or more QoS types and/or QoS levels are not applicable to the above configuration, and other services are applicable to the above configuration. Herein, the QoS level and/or QoS type may be identified by one or more of the following: 5G QoS Identifier (5QI), Qos Flow Identifier (QFI), etc.
   Time mode corresponding to the above configuration: it may include one or more of the following: part of time periods is applicable, part of time periods is inapplicable, applicable time periods, inapplicable time periods, mode index, time mode configuration, active time, inactive time, etc. Herein, one mode index corresponds to one configuration. For example, it may be that part of time periods is for transmission and/or part of time periods is not for transmission. Herein, the active time may be the time when reception and/or transmission can be performed. Herein, the inactive time may be the time when reception and/or transmission is not performed. This mode can be aimed at one configuration or multiple configurations of the above configurations. In an implementation, for example, it may be that the time not used for reception may be used for transmission. In another implementation, for example, it may be that part of the active time is for transmission, and another part is for reception, etc.
   Frequency mode corresponding to the above configuration: it may include one or more of the following: part of frequencies is applicable, part of frequencies is inapplicable, applicable frequencies, inapplicable frequencies, mode index, active frequencies, inactive frequencies, etc. Herein, one mode index corresponds to one configuration. For example, it may be that part of frequencies is for transmission and/or part of frequencies is not for transmission. Herein, an active frequency can be the frequency at which reception and/or transmission can be performed. Herein, an inactive frequency may be the frequency at which reception and/or transmission is not performed. This mode can be aimed at one configuration or multiple configurations of the above configurations. In an implementation, for example, it may be that frequencies not used for reception may be used for transmission. In another implementation, for example, it may be that part of the active frequencies is for transmission, and another part is for reception, etc.
   Indication of joint configuration: used to indicate whether the energy saving configuration is a joint configuration. In an implementation, for example, the configuration may be a joint configuration for reception and transmission. In an implementation, for example, a joint configuration mode can be predefined. Transmission of this indication enables that while part of the configuration is transmitted, another part of the configuration can be not transmitted, and a node receiving this message can derive another part of the configuration through the predefined joint configuration mode and the part of the configuration, thus achieving an effect of signaling saving. Modes of joint configuration may include but are not limited to:
      Time and/or frequency bands not used for reception can be used for transmission.
      A part of the active time and/or frequency bands is for transmission, and another part is for reception.
      Active time and/or frequency bands are for reception, and inactive time and/or frequency bands are for transmission.
      Inactive time and/or frequency bands are for reception, and active time and/or frequency bands are for transmission.
   Index of joint configuration: used to identify whether the configuration is a joint configuration and/or identify the index corresponding to the joint configuration. In an implementation, for example, the configuration may be a joint configuration for reception and transmission. In an implementation, for example, a variety of joint configuration modes can be predefined and identified by indexes. Transmission of this index enables that while part of the configuration is transmitted, another part of the configuration can be not transmitted, and a node receiving this message can derive another part of the configuration through the predefined joint configuration mode corresponding to the index and the part of the configuration, thus achieving an effect of signaling saving. Modes of joint configuration may include but are not limited to:
      Time and/or frequency bands not used for reception can be used for transmission.
      A part of the active time and/or frequency bands is for transmission, and another part is for reception.
      Active time and/or frequency bands are for reception, and inactive time and/or frequency bands are for transmission.
      Inactive time and/or frequency bands are for reception, and active time and/or frequency bands are for transmission.
Deactivated time: indicates the time when deactivation has been performed. It may be an absolute time or a relative time.
Corresponding scope that cannot be deactivated: it may be identifications and/or identification lists of one or more of the following: cell, slice (for example, it may be identified by Single Network Slice Selection Assistance Information (S-NSSAI)), Bandwidth Part (BWP), subframe, slot, symbol, carrier, service, Quality of Service (QoS) level, QoS flow, Protocol Data Unit (PDU) session, data Radio Bearer (DRB), beam, transmitting and receiving point, node, SSB, Resource Block, etc. This field may be for the current activation request or for the predicted activation request. Herein, the QoS level and/or QoS type may be identified by one or more of the following: 5G QoS Identifier (5QI), Qos Flow Identifier (QFI), etc.
Configuration that cannot be deactivated: this configuration may be a current configuration or a predicted configuration. It may include one or more of the following:
   not transmitting downlink channels (all or any downlink channels)
   not receiving uplink channels (all or any downlink channels)
   not transmitting a predefined downlink channel
   not receiving a predefined uplink channel
   transmitting downlink channels (all or any downlink channels)
   receiving uplink channels (all or any uplink channels)
   transmitting a predefined downlink channel
   receiving a predefined uplink channel
   Synchronization Signal Block (SSB) configuration: it may be a configuration in an energy saving mode or a configuration in a non-energy saving mode. The SSB configuration may be one and/or a set of configuration parameters, which may include one or more of the following: cell identification, SSB frequency, SSB subcarrier spacing, SSB transmission power, SSB period, SSB half subframe index, SSB system frame number offset, initial time of system frame number, SSB position, etc. The SSB position may be an SSB Position in Burst, including one or more of the following: short bitmap, medium bitmap and long bitmap. The SSB configuration may also be a configuration index, where one index corresponds to a set of defined configuration parameters, which may include the above parameters of the SSB configuration, etc. The SSB configuration may also be an energy saving and/or non-energy saving mode that the SSB is in, which may include one or more of the following: switch-on, switch-off, activation, deactivation, network energy saving state, non-network energy saving state, sleep, non-sleep, deep sleep, light sleep, micro sleep, active uplink (active UL), active downlink (active DL), SSB normal state, SSB reduced (SSB-less and/or light SSB) state, SSB-free state, simplified SSB, partial SSB, transmission power decrease and/or increase, coverage increase and/or decrease, etc. Herein, the SSB reduced state may identify the configuration of SSB by an index, or may identify the configuration of SSB by specific parameters.
   Master Information Block (MIB) configuration: it may be a configuration in an energy saving mode or a configuration in a non-energy saving mode. The MIB configuration may be one and/or a set of configuration parameters, which may include one or more of the following: cell identification, MIB frequency, MIB subcarrier spacing, MIB transmission power, MIB period, MIB repetition, MIB position, etc. The MIB configuration may also be a configuration index, where one index corresponds to a set of defined configuration parameters, which may include the above parameters of the MIB configuration, etc. The MIB configuration may also be an energy saving and/or non-energy saving mode that the MIB is in, which may include one or more of the following: switch-on, switch-off, activation, deactivation, network energy saving state, non-network energy saving state, sleep, non-sleep, deep sleep, light sleep, micro sleep, active uplink (active UL), active downlink (active DL), MIB normal state, MIB reduced (MIB-less and/or light MIB) state, MIB-free state, simplified MIB, partial MIB, MIB-free state, transmission power decrease and/or increase, coverage increase and/or decrease, etc. Herein, the MIB reduced state may identify the configuration of MIB by an index, or may identify the configuration of MIB by specific parameters.
   System Information Block (SIB) configuration: it may be a configuration in an energy saving mode or a configuration in a non-energy saving mode. The SIB configuration may be one and/or a set of configuration parameters, which may include one or more of the following: cell identification, SIB frequency, SIB subcarrier spacing, SIB transmission power, SIB period, SIB repetition, SIB position, etc. The SIB configuration may also be a configuration index, where one index corresponds to a set of defined configuration parameters, which may include the above parameters of the SIB configuration, etc. The SIB configuration may also be an energy saving and/or non-energy saving mode that the SIB is in, which may include one or more of the following: switch-on, switch-off, activation, deactivation, network energy saving state, non-network energy saving state, sleep, non-sleep, deep sleep, light sleep, micro sleep, active uplink (active UL), active downlink (active DL), SIB normal state, SIB reduced (SIB-less and/or light SIB) state, SIB-free state, simplified SIB, partial SIB, transmission power decrease and/or increase, coverage increase and/or decrease, etc. Herein, the SIB reduced state may identify the configuration of SIB by an index, or may identify the configuration of SIB by specific parameters.
   Scope corresponding to the above configuration that cannot be activated: it may include one or more of the following: service, QoS type, QoS level, etc. In an implementation, for example, one or more service types are applicable to the above configuration, and other services are not applicable to the above configuration; alternatively, one or more service types are not applicable to the above configuration, and other services are applicable to the above configuration. In another implementation, for example, one or more QoS types and/or QoS levels are applicable to the above configuration, and other services are not applicable to the above configuration. Alternatively, one or more QoS types and/or QoS levels are not applicable to the above configuration, and other services are applicable to the above configuration. Herein, the QoS level and/or QoS type may be identified by one or more of the following: 5G QoS Identifier (5QI), Qos Flow Identifier (QFI), etc.
   Time mode corresponding to the above configuration: it may include one or more of the following: part of time periods is applicable, part of time periods is inapplicable, applicable time periods, inapplicable time periods, mode index, time mode configuration, active time, inactive time, etc. Herein, one mode index corresponds to one configuration. For example, it may be that part of time periods is for transmission and/or part of time periods is not for transmission. Herein, the active time may be the time when reception and/or transmission can be performed. Herein, the inactive time may be the time when reception and/or transmission is not performed. This mode can be aimed at one configuration or multiple configurations of the above configurations. In an implementation, for example, it may be that the time not used for reception may be used for transmission. In another implementation, for example, it may be that part of the active time is for transmission, and another part is for reception, etc.
   Frequency mode corresponding to the above configuration: it may include one or more of the following: part of frequencies is applicable, part of frequencies is inapplicable, applicable frequencies, inapplicable frequencies, mode index, active frequencies, inactive frequencies, etc. Herein, one mode index corresponds to one configuration. For example, it may be that part of frequencies is for transmission and/or part of frequencies is not for transmission. Herein, an active frequency can be the frequency at which reception and/or transmission can be performed. Herein, an inactive frequency may be the frequency at which reception and/or transmission is not performed. This mode can be aimed at one configuration or multiple configurations of the above configurations. In an implementation, for example, it may be that frequencies not used for reception may be used for transmission. In another implementation, for example, it may be that part of the active frequencies is for transmission, and another part is for reception, etc.
   Indication of joint configuration: used to indicate whether the energy saving configuration is a joint configuration. In an implementation, for example, the configuration may be a joint configuration for reception and transmission. In an implementation, for example, a joint configuration mode can be predefined. Transmission of this indication enables that while part of the configuration is transmitted, another part of the configuration can be not transmitted, and a node receiving this message can derive another part of the configuration through the predefined joint configuration mode and the part of the configuration, thus achieving an effect of signaling saving. Modes of joint configuration may include but are not limited to:
      Time and/or frequency bands not used for reception can be used for transmission.
      A part of the active time and/or frequency bands is for transmission, and another part is for reception.
      Active time and/or frequency bands are for reception, and inactive time and/or frequency bands are for transmission.
      Inactive time and/or frequency bands are for reception, and active time and/or frequency bands are for transmission.
   Index of joint configuration: used to identify whether the configuration is a joint configuration and/or identify the index corresponding to the joint configuration. In an implementation, for example, the configuration may be a joint configuration for reception and transmission. In an implementation, for example, a variety of joint configuration modes can be predefined and identified by indexes. Transmission of this index enables that while part of the configuration is transmitted, another part of the configuration can be not transmitted, and a node receiving this message can derive another part of the configuration through the predefined joint configuration mode corresponding to the index and the part of the configuration, thus achieving an effect of signaling saving. Modes of joint configuration may include but are not limited to:
      Time and/or frequency bands not used for reception can be used for transmission.
      A part of the active time and/or frequency bands is for transmission, and another part is for reception.
      Active time and/or frequency bands are for reception, and inactive time and/or frequency bands are for transmission.
      Inactive time and/or frequency bands are for reception, and active time and/or frequency bands are for transmission.
Configuration change identification: identifies this configuration change. This configuration may be a transmission power configuration, a channel and/or signal configuration, or any other configuration mentioned in the present disclosure, for example, a configuration of a wake-up signal, an energy saving configuration, a setting of setting energy saving configuration autonomously, and the like.
Configuration that can be applied: this configuration may be a transmission power configuration, a channel and/or signal configuration, or any other configuration mentioned in the present disclosure, for example, a configuration of a wake-up signal, an energy saving configuration, a setting of setting energy saving configuration autonomously, and the like.
Application time corresponding to configuration that can be applied: it may be expressed by one or more of the following: timestamp, time point, time interval, timer, time period, time length, etc. Herein, the time length may be a length of time from a certain time point, which may be the current time. The time may be a relative time or an absolute time. This configuration may be a transmission power configuration, a channel and/or signal configuration, or any other configuration mentioned in the present disclosure, for example, a configuration of a wake-up signal, an energy saving configuration, a setting of setting energy saving configuration autonomously, and the like. Herein, the time may include one or more of the following: activation time, deactivation time, applicable time, inapplicable time, offset, start time, end time, active time, inactive time, long period, short period, retransmission time, Hybrid Automatic Repeat reQuest round-trip time, etc.
Trigger condition for triggering configuration application: when a certain condition is met, an operation of applying the configuration is performed, which may include, for example, one or more of the following: receiving a certain signaling, transmitting a certain signaling, being in a certain mode at present, meeting a timer, load situation and/or resource status being less than and/or less than or equal to and/or greater than and/or greater than or equal to a certain threshold, a change of coverage state of oneself and/or a neighboring cell, etc. It should be understood that the signaling, modes, timers, etc. described herein can be one or more of any existing or future signaling, modes, timers, etc. unless otherwise specified, and are not limited herein. This configuration may be a transmission power configuration, a channel and/or signal configuration, or any other configuration mentioned in the present disclosure, for example, a configuration of a wake-up signal, an energy saving configuration, a setting of setting energy saving configuration autonomously, and the like.
Configuration that cannot be applied: this configuration may be a transmission power configuration, a channel and/or signal configuration, or any other configuration mentioned in the present disclosure, for example, a configuration of a wake-up signal, an energy saving configuration, a setting of setting energy saving configuration autonomously, and the like.
Applied configuration: this configuration may be a transmission power configuration, a channel and/or signal configuration, or any other configuration mentioned in the present disclosure, for example, a configuration of a wake-up signal, an energy saving configuration, a setting of setting energy saving configuration autonomously, and the like.
Coverage state change identification: identify this coverage state change.
Coverage state that can be changed: it may include increasing coverage, decreasing coverage, etc., and may also be expressed by indexes, where one index corresponds to a group of related coverage configurations.
Scope corresponding to a coverage state that can be changed: it may be identifications and/or identification lists of one or more of the following: cell, slice (for example, it may be identified by Single Network Slice Selection Assistance Information (S-NSSAI)), Bandwidth Part (BWP), subframe, slot, symbol, carrier, service, Quality of Service (QOS) level, QoS flow, Protocol Data Unit (PDU) session, data Radio Bearer (DRB), beam, transmitting and receiving point, node, SSB, Resource Block, etc. Herein, the QoS level and/or QoS type may be identified by one or more of the following: 5G QoS Identifier (5QI), Qos Flow Identifier (QFI), etc.
Time of change of a coverage state: it may be expressed by one or more of the following: timestamp, time point, time interval, timer, time period, time length, etc. Herein, the time length may be a length of time from a certain time point, which may be the current time. The time may be a relative time or an absolute time. Herein, the time and/or time mode may include one or more of the following: activation time, deactivation time, applicable time, inapplicable time, start time, end time, etc.
Changed coverage state: it may include increasing coverage, decreasing coverage, etc., and may also be expressed by indexes, where one index corresponds to a group of related coverage configurations.
Scope corresponding to a changed coverage state: it may be identifications and/or identification lists of one or more of the following: cell, slice (for example, it may be identified by Single Network Slice Selection Assistance Information (S-NSSAI)), Bandwidth Part (BWP), subframe, slot, symbol, carrier, service, Quality of Service (QoS) level, QoS flow, Protocol Data Unit (PDU) session, data Radio Bearer (DRB), beam, transmitting and receiving point, node, SSB, Resource Block, etc. Herein, the QoS level and/or QoS type may be identified by one or more of the following: 5G QoS Identifier (5QI), Qos Flow Identifier (QFI), etc.
Condition for triggering the coverage change: for example, it may include one or more of the following: receiving a certain signaling, transmitting a certain signaling, being in a certain mode at present, meeting a timer, load situation and/or resource status being less than and/or less than or equal to and/or greater than and/or greater than or equal to a certain threshold, receiving information of coverage change of a neighboring cell, decreasing coverage of a neighboring cell, a change of coverage state of oneself and/or a neighboring cell, etc. It should be understood that the signaling, modes, timers, etc. described herein can be one or more of any existing or future signaling, modes, timers, etc. unless otherwise specified, and are not limited herein.
Coverage state that cannot be changed: it may include increasing coverage, decreasing coverage, etc., and may also be expressed by indexes, where one index corresponds to a group of related coverage configurations.
Scope corresponding to a coverage state that cannot be changed: it may be identifications and/or identification lists of one or more of the following: cell, slice (for example, it may be identified by Single Network Slice Selection Assistance Information (S-NSSAI)), Bandwidth Part (BWP), subframe, slot, symbol, carrier, service, Quality of Service (QOS) level, QoS flow, Protocol Data Unit (PDU) session, data Radio Bearer (DRB), beam, transmitting and receiving point, node, SSB, Resource Block, etc. Herein, the QoS level and/or QoS type may be identified by one or more of the following: 5G QoS Identifier (5QI), Qos Flow Identifier (QFI), etc.
Interface instance indication: used to indicate a destination interface of this message, which may be UU and/or Xn and/or X2 and/or F1 and/or E1 and/or NG.
Cause: it may indicate the reasons why activation cannot be performed, the reasons why deactivation cannot be performed, the reasons why change cannot be performed and the reasons why application cannot be performed. It may include one or more of the following: a change of load of oneself and/or a neighboring cell (increasing and/or decreasing), a change of coverage state of oneself and/or a neighboring cell (increasing and/or decreasing), reception of a request from UE, reception of a request from a neighboring cell and/or a neighboring node, and triggering by an event, etc.

### Example 3

An example of the present disclosure proposes a method for supporting network energy saving, which may include: a first node transmits a sixth message including a request for network performance to a second node to trigger the second node to measure and/or collect the requested network performance, so that the first node can obtain the network performance of the second node and/or other nodes, and can provide reference information for the first node to make network energy saving and/or other self-optimization decisions, so as to realize global energy saving, for example, to avoid the increase of energy consumption in multiple cells due to the energy saving in one cell. Specifically, when the energy consumption of a cell decreases but the energy consumption of a neighboring cell increases after an energy saving action, it is necessary to globally consider whether the energy saving action is appropriate. For example, when the total energy consumption of the cell and the neighboring cell decreases, the energy saving action is appropriate, and for example, when the total energy consumption of the cell and the neighboring cell increases, the energy saving action is not appropriate.

In some implementations, the sixth message may be or be included in one or more of the following: an XN SETUP REQUEST message or an XN SETUP RESPONSE message of Xn; or an ENB CONFIGURATION UPDATE message or an ENB CONFIGURATION UPDATE ACKNOWLEDGE message or an EN-DC CONFIGURATION UPDATE message or an EN-DC CONFIGURATION UPDATE ACKNOWLEDGE message of X2; or an NG-RAN NODE CONFIGURATION UPDATE message or an NG-RAN NODE CONFIGURATION UPDATE ACKNOWLEDGE message of Xn; or a CELL ACTIVATION REQUEST message or a CELL ACTIVATION RESPONSE message or a CELL ACTIVATION FAILURE message of Xn or X2; or an EN-DC CELL ACTIVATION REQUEST message or an EN-DC CELL ACTIVATION RESPONSE message or an EN-DC CELL ACTIVATION FAILURE message of X2; or a RESET REQUEST message of X2 or Xn; or a MOBILITY CHANGE REQUEST message of X2; or an F1 SETUP REQUEST message or an F1 SETUP RESPONSE message or a GNB-DU CONFIGURATION UPDATE message or a GNB-DU CONFIGURATION UPDATE ACKNOWLEDGE message or a GNB-CU CONFIGURATION UPDATE message or a GNB-CU CONFIGURATION UPDATE ACKNOWLEDGE message or a GNB-DU RESOURCE COORDINATION REQUEST message or a GNB-DU RESOURCE COORDINATION RESPONSE message of F1; or a GNB-CU-UP E1 SETUP REQUEST message or a GNB-CU-UP E1 SETUP RESPONSE message or a GNB-CU-CP E1 SETUP REQUEST message or a GNB-CU-CP E1 SETUP RESPONSE message or a GNB-CU-UP CONFIGURATION UPDATE message or a GNB-CU-UP CONFIGURATION UPDATE ACKNOWLEDGE message or a GNB-CU-CP CONFIGURATION UPDATE message or a gNB-CU-CP CONFIGURATION UPDATE ACKNOWLEDGE message of E1; or a RESOURCE STATUS REQUEST message of X2 or Xn or F1 or E1, or an EN-DC RESOURCE STATUS REQUEST message of X2; or an UPLINK RAN CONFIGURATION TRANSFER message and a DOWNLINK RAN CONFIGURATION TRANSFER message of NG; or a HANDOVER REQUEST ACKNOWLEDGE message, a RETRIEVE UE CONTEXT REQUEST message or a HANDOVER SUCCESS message of X2 or Xn; or an SENB ADDITION REQUEST ACKNOWLEDGE message or an SGNB ADDITION REQUEST ACKNOWLEDGE message of X2; or an S-NODE ADDITION REQUEST ACKNOWLEDGE message of Xn; or an other and/or newly defined RRC and/or Xn and/or X2 and/or F1 and/or E1 and/or NG message.

In some implementations, the sixth message may include one or more of the following fields and/or related information:
Transmitting node identification: an identification of a node that transmits the sixth message.
Receiving node identification: an identification of a node that receives the sixth message.
Identification of network performance request: used to identify that the request is a request for reporting network performance, and/or to identify whether it is required to report network performance. It may be represented by a single bit. For example, when the bit is 1, it indicates that network performance is requested to be reported and/or required to be reported; and when the bit is 0, it indicates that network performance is not requested to be reported and/or not required to be reported; alternatively, when the bit is 0, it indicates that network performance is requested to be reported and/or required to be reported; and when the bit is 1, it indicates that network performance is not requested to be reported and/or not required to be reported. The request for network performance may be for current network performance or predicted network performance.
Scope corresponding to the request: it may be identifications and/or identification lists of one or more of the following: cell, slice (for example, it may be identified by Single Network Slice Selection Assistance Information (S-NSSAI)), Bandwidth Part (BWP), subframe, slot, symbol, carrier, service, Quality of Service (QOS) level, QoS flow, Protocol Data Unit (PDU) session, data Radio Bearer (DRB), beam, transmitting and receiving point, node, SSB, Resource Block, etc. Herein, the QoS level and/or QoS type may be identified by one or more of the following: 5G QoS Identifier (5QI), Qos Flow Identifier (QFI), etc.
Reporting mode: used to indicate the reporting mode (of the network performance), for example, it may include On-demand, single reporting, periodic reporting, event triggering, etc.
Reporting registration request: used to indicate the start, end, addition, decrease, etc. of the reporting (of network performance).
Reporting interval: used to indicate a reporting interval of periodic reporting (of network performance).
Trigger event: used to indicate an event that triggers the reporting (of network performance), for example, it may be a change of predicted network energy saving configuration, a change of coverage state of oneself and/or a neighboring cell, a change of network performance, a change of predicted network performance, a change of network energy saving performance, a change of predicted network energy saving performance, etc. When the trigger event is met, reporting will be performed.
Reporting request information for predicted network performance:
   Reporting mode of requested predicted network performance: used to indicate the reporting mode of requested predicted network performance, for example, it may include On-demand, single reporting, periodic reporting, event triggering, etc.
   Reporting registration request for requested predicted network performance: used to indicate the start, end, addition, decrease, etc. of the reporting of the requested predicted network performance.
   Reporting interval of the requested predicted network performance: used to indicate a reporting interval of the requested periodic reporting of the predicted network performance.
   Trigger event of the reporting of the requested predicted network performance: used to indicate an event that triggers the reporting of predicted network performance, for example, it may be a change of predicted network energy saving configuration, a change of coverage state of oneself and/or a neighboring cell, a change of network performance, a change of predicted network performance, a change of network energy saving performance, a change of predicted network energy saving performance, etc. When the trigger event is met, reporting will be performed.
   Applicable time of the predicted network performance requested to be reported: used to indicate the applicable time point and/or applicable time period of the predicted network performance requested to be reported. This time may be a relative time or an absolute time. If it is a time interval, it may be represented by 2*n bits, for example, the first n bits represent a start time and the last n bits represent an end time. It may also be represented by separate fields, including one or more of the following:
      Start time: used to indicate a start time. The start time may be a relative time or an absolute time.
      End time: used to indicate an end time. The end time may be a relative time or an absolute time.
   Accuracy of the predicted network performance requested to be reported: it may be an accuracy or a confidence. The accuracy may also be an accuracy corresponding to a model for predicting network performance.
Requested reporting content: used to indicate the content requested for reporting. This content may be a current content or a predicted content. The content may be targeted for one or more of the following: uplink, downlink, uplink or downlink, uplink and downlink. The content may include one or more of the following:
   Network performance: it may include one or more of the following:
      Decrease proportion of energy consumption
      Increase proportion of energy consumption
      Decrease amount of energy consumption
      Increase amount of energy consumption
      Jitter of energy consumption
      Jitter of energy consumption increase
      Jitter of energy consumption decrease
      Decrease proportion of energy efficiency
      Increase proportion of energy efficiency
      Decrease amount of energy efficiency
      Increase amount of energy efficiency
      Jitter of energy efficiency
      Jitter of energy efficiency increase
      Jitter of energy efficiency decrease

In some implementations, the second node may transmit a seventh message including a response to the request for network performance of the second node and/or other nodes to the first node according to the received sixth message including a request for network performance, so as to indicate whether the requested measurement and/or collection can be successfully triggered, for example, all and/or part of the measurement objects can be successfully initiated, and/or all and/or part of the measurement objects cannot be initiated. The first node may know whether the requested measurement and/or collection can be received.

In some implementations, the seventh message may be or be included in one or more of the following: an XN SETUP REQUEST message or an XN SETUP RESPONSE message of Xn; or an ENB CONFIGURATION UPDATE message or an ENB CONFIGURATION UPDATE ACKNOWLEDGE message or an EN-DC CONFIGURATION UPDATE message or an EN-DC CONFIGURATION UPDATE ACKNOWLEDGE message of X2; or an NG-RAN NODE CONFIGURATION UPDATE message or an NG-RAN NODE CONFIGURATION UPDATE ACKNOWLEDGE message of Xn; or a CELL ACTIVATION REQUEST message or a CELL ACTIVATION RESPONSE message or a CELL ACTIVATION FAILURE message of Xn or X2; or an EN-DC CELL ACTIVATION REQUEST message or an EN-DC CELL ACTIVATION RESPONSE message or an EN-DC CELL ACTIVATION FAILURE message of X2; or a RESET REQUEST message of X2 or Xn; or a MOBILITY CHANGE REQUEST message of X2; or an F1 SETUP REQUEST message or an F1 SETUP RESPONSE message or a GNB-DU CONFIGURATION UPDATE message or a GNB-DU CONFIGURATION UPDATE ACKNOWLEDGE message or a GNB-CU CONFIGURATION UPDATE message or a GNB-CU CONFIGURATION UPDATE ACKNOWLEDGE message or a GNB-DU RESOURCE COORDINATION REQUEST message or a GNB-DU RESOURCE COORDINATION RESPONSE message of F1; or a GNB-CU-UP E1 SETUP REQUEST message or a GNB-CU-UP E1 SETUP RESPONSE message or a GNB-CU-CP E1 SETUP REQUEST message or a GNB-CU-CP E1 SETUP RESPONSE message or a GNB-CU-UP CONFIGURATION UPDATE message or a GNB-CU-UP CONFIGURATION UPDATE ACKNOWLEDGE message or a GNB-CU-CP CONFIGURATION UPDATE message or a gNB-CU-CP CONFIGURATION UPDATE ACKNOWLEDGE message of E1; or a RESOURCE STATUS RESPONSE message or a RESOURCE STATUS FAILURE message or a RESOURCE STATUS UPDATE message of X2 or Xn or F1 or E1; or an RESOURCE STATUS RESPONSE message and/or an EN-DC RESOURCE STATUS FAILURE message and/or an EN-DC RESOURCE STATUS UPDATE message of X2; or an UPLINK RAN CONFIGURATION TRANSFER message and a DOWNLINK RAN CONFIGURATION TRANSFER message of NG; or an other and/or newly defined RRC and/or Xn and/or X2 and/or F1 and/or E1 and/or NG message.

In some implementations, the seventh message may include one or more of the following fields and/or related information:
Transmitting node identification: an identification of a node that transmits the seventh message.
Receiving node identification: an identification of a node that receives the seventh message.
Scope corresponding to content that can be reported: the scope corresponding to network energy saving performance that can be reported, which may be identifications and/or identification lists of one or more of the following: cell, slice (for example, it may be identified by Single Network Slice Selection Assistance Information (S-NSSAI)), Bandwidth Part (BWP), subframe, slot, symbol, carrier, service, Quality of Service (QOS) level, QoS flow, Protocol Data Unit (PDU) session, data Radio Bearer (DRB), beam, transmitting and receiving point, node, SSB, Resource Block, etc. Herein, the QoS level and/or QoS type may be identified by one or more of the following: 5G QOS Identifier (5QI), Qos Flow Identifier (QFI), etc.
Content that can be reported: indicates the content that can be reported. This content may be a current content or a predicted content. The content may be targeted for one or more of the following: uplink, downlink, uplink or downlink, uplink and downlink. It may include one or more of the following:
Applicable scope: the scope corresponding to the network energy saving performance, which may be identifications and/or identification lists of one or more of the following: cell, slice (for example, it may be identified by Single Network Slice Selection Assistance Information (S-NSSAI)), Bandwidth Part (BWP), subframe, slot, symbol, carrier, service, Quality of Service (QOS) level, QoS flow, Protocol Data Unit (PDU) session, data Radio Bearer (DRB), beam, transmitting and receiving point, node, SSB, Resource Block, etc. Herein, the QoS level and/or QoS type may be identified by one or more of the following: 5G QoS Identifier (5QI), Qos Flow Identifier (QFI), etc.
   Network performance: it may include one or more of the following:
      Decrease proportion of energy consumption
      Increase proportion of energy consumption
      Decrease amount of energy consumption
      Increase amount of energy consumption
      Jitter of energy consumption
      Jitter of energy consumption increase
      Jitter of energy consumption decrease
      Decrease proportion of energy efficiency
      Increase proportion of energy efficiency
      Decrease amount of energy efficiency
      Increase amount of energy efficiency
      Jitter of energy efficiency
      Jitter of energy efficiency increase
      Jitter of energy efficiency decrease
   Applicable time of predicted network performance: used to indicate the applicable time point and/or applicable time period of predicted network performance. This time may be a relative time or an absolute time. If it is a time interval, it may be represented by 2*n bits, for example, the first n bits represent a start time and the last n bits represent an end time. It may also be represented by separate fields, including one or more of the following:
      Start time: used to indicate a start time. The start time may be a relative time or an absolute time.
      End time: used to indicate an end time. The end time may be a relative time or an absolute time.
   Accuracy of predicted network performance: it may be an accuracy or a confidence. The accuracy may also be an accuracy corresponding to a model for predicting the network performance.
Scope corresponding to content that cannot be reported: the scope corresponding to network energy saving performance that cannot be reported, which may be identifications and/or identification lists of one or more of the following: cell, slice (for example, it may be identified by Single Network Slice Selection Assistance Information (S-NSSAI)), Bandwidth Part (BWP), subframe, slot, symbol, carrier, service, Quality of Service (QOS) level, QoS flow, Protocol Data Unit (PDU) session, data Radio Bearer (DRB), beam, transmitting and receiving point, node, SSB, Resource Block, etc. Herein, the QoS level and/or QoS type may be identified by one or more of the following: 5G QoS Identifier (5QI), Qos Flow Identifier (QFI), etc.
Content that cannot be reported: indicates the content that cannot be reported. This content may be a current content or a predicted content. The content may be targeted for one or more of the following: uplink, downlink, uplink or downlink, uplink and downlink. It may include one or more of the following:
   Applicable scope: the scope corresponding to the network energy saving performance, which may be identifications and/or identification lists of one or more of the following: cell, slice (for example, it may be identified by Single Network Slice Selection Assistance Information (S-NSSAI)), Bandwidth Part (BWP), subframe, slot, symbol, carrier, service, Quality of Service (QOS) level, QoS flow, Protocol Data Unit (PDU) session, data Radio Bearer (DRB), beam, transmitting and receiving point, node, SSB, Resource Block, etc. Herein, the QoS level and/or QoS type may be identified by one or more of the following: 5G QoS Identifier (5QI), Qos Flow Identifier (QFI), etc.
   Network performance: it may include one or more of the following:
      Decrease proportion of energy consumption
      Increase proportion of energy consumption
      Decrease amount of energy consumption
      Increase amount of energy consumption
      Jitter of energy consumption
      Jitter of energy consumption increase
      Jitter of energy consumption decrease
      Decrease proportion of energy efficiency
      Increase proportion of energy efficiency
      Decrease amount of energy efficiency
      Increase amount of energy efficiency
      Jitter of energy efficiency
      Jitter of energy efficiency increase
      Jitter of energy efficiency decrease
   Applicable time of predicted network performance: used to indicate the applicable time point and/or applicable time period of predicted network performance. This time may be a relative time or an absolute time. If it is a time interval, it may be represented by 2*n bits, for example, the first n bits represent a start time and the last n bits represent an end time. It may also be represented by separate fields, including one or more of the following:
      Start time: used to indicate a start time. The start time may be a relative time or an absolute time.
      End time: used to indicate an end time. The end time may be a relative time or an absolute time.
   Accuracy of predicted network performance: it may be an accuracy or a confidence. The accuracy may also be an accuracy corresponding to a model for predicting the network performance.
Cause: used to indicate the reason why the request failed, for example, there is no requested content, the requested content cannot be collected and/or measured, there is no network performance prediction ability, there is no prediction ability, and there is no artificial intelligence and/or machine learning ability.

In some implementations, the second node may transmit an eighth message including network performance of the second node and/or other nodes to the first node according to its own situation and/or according to the received sixth message including a request for the network performance, so that the first node can obtain the network performance of the second node and/or other nodes, and the first node can make network energy saving configuration updating and/or self-optimization decision and the like according to the received network performance, and/or judge whether the decision made is correct. For example, when the cell and/or node makes a decision to enter an energy saving mode and has entered the energy saving mode, and the received network performance of a neighboring cell decreases, then it indicates that the energy saving decision is not appropriate. In some implementations, for example, when the cell and/or node needs to make an energy saving decision and/or load balancing and/or mobility management decision, and the received network performance of a neighboring cell decreases, then the cell and/or node should not enter the energy saving mode and/or should not transfer the load to the neighboring cell whose network performance decreases and/or should not switch users to the neighboring cell whose network performance decreases.

In some implementations, the eighth message may be or be included in one or more of the following: an XN SETUP REQUEST message or an XN SETUP RESPONSE message of Xn; or an ENB CONFIGURATION UPDATE message or an ENB CONFIGURATION UPDATE ACKNOWLEDGE message or an EN-DC CONFIGURATION UPDATE message or an EN-DC CONFIGURATION UPDATE ACKNOWLEDGE message of X2; or an NG-RAN NODE CONFIGURATION UPDATE message or an NG-RAN NODE CONFIGURATION UPDATE ACKNOWLEDGE message of Xn; or a CELL ACTIVATION REQUEST message or a CELL ACTIVATION RESPONSE message or a CELL ACTIVATION FAILURE message of Xn or X2; or an EN-DC CELL ACTIVATION REQUEST message or an EN-DC CELL ACTIVATION RESPONSE message or an EN-DC CELL ACTIVATION FAILURE message of X2; or a RESET REQUEST message of X2 or Xn; or a MOBILITY CHANGE REQUEST message of X2; or an F1 SETUP REQUEST message or an F1 SETUP RESPONSE message or a GNB-DU CONFIGURATION UPDATE message or a GNB-DU CONFIGURATION UPDATE ACKNOWLEDGE message or a GNB-CU CONFIGURATION UPDATE message or a GNB-CU CONFIGURATION UPDATE ACKNOWLEDGE message or a GNB-DU RESOURCE COORDINATION REQUEST message or a GNB-DU RESOURCE COORDINATION RESPONSE message of F1; or a GNB-CU-UP E1 SETUP REQUEST message or a GNB-CU-UP E1 SETUP RESPONSE message or a GNB-CU-CP E1 SETUP REQUEST message or a GNB-CU-CP E1 SETUP RESPONSE message or a GNB-CU-UP CONFIGURATION UPDATE message or a GNB-CU-UP CONFIGURATION UPDATE ACKNOWLEDGE message or a GNB-CU-CP CONFIGURATION UPDATE message or a gNB-CU-CP CONFIGURATION UPDATE ACKNOWLEDGE message of E1; or a RESOURCE STATUS RESPONSE message or a RESOURCE STATUS FAILURE message or a RESOURCE STATUS UPDATE message of X2 or Xn or F1 or E1; or an RESOURCE STATUS RESPONSE message and/or an EN-DC RESOURCE STATUS FAILURE message and/or an EN-DC RESOURCE STATUS UPDATE message of X2; or an UPLINK RAN CONFIGURATION TRANSFER message and a DOWNLINK RAN CONFIGURATION TRANSFER message of NG; or an other and/or newly defined RRC and/or Xn and/or X2 and/or F1 and/or E1 and/or NG message.

In some implementations, the eighth message may include one or more of the following fields and/or related information:
Transmitting node identification: an identification of a node that transmits the eighth message.
Receiving node identification: an identification of a node that receives the eighth message.
Reporting content: indicates the reported content. This content may be a current content or a predicted content. The content may be targeted for one or more of the following: uplink, downlink, uplink or downlink, uplink and downlink. It may include one or more of the following:
   Applicable scope: the scope corresponding to the network energy saving performance, which may be identifications and/or identification lists of one or more of the following: cell, slice (for example, it may be identified by Single Network Slice Selection Assistance Information (S-NSSAI)), Bandwidth Part (BWP), subframe, slot, symbol, carrier, service, Quality of Service (QOS) level, QoS flow, Protocol Data Unit (PDU) session, data Radio Bearer (DRB), beam, transmitting and receiving point, node, SSB, Resource Block, etc. Herein, the QoS level and/or QoS type may be identified by one or more of the following: 5G QoS Identifier (5QI), Qos Flow Identifier (QFI), etc.
   Network performance: it may include one or more of the following:
      Decrease proportion of energy consumption
      Increase proportion of energy consumption
      Decrease amount of energy consumption
      Increase amount of energy consumption
      Jitter of energy consumption
      Jitter of energy consumption increase
      Jitter of energy consumption decrease
      Decrease proportion of energy efficiency
      Increase proportion of energy efficiency
      Decrease amount of energy efficiency
      Increase amount of energy efficiency
      Jitter of energy efficiency
      Jitter of energy efficiency increase
      Jitter of energy efficiency decrease
   Applicable time of predicted network performance: used to indicate the applicable time point and/or applicable time period of predicted network performance. This time may be a relative time or an absolute time. If it is a time interval, it may be represented by 2*n bits, for example, the first n bits represent a start time and the last n bits represent an end time. It may also be represented by separate fields, including one or more of the following:
      Start time: used to indicate a start time. The start time may be a relative time or an absolute time.
      End time: used to indicate an end time. The end time may be a relative time or an absolute time.
   Accuracy of predicted network performance: it may be an accuracy or a confidence. The accuracy may also be an accuracy corresponding to a model for predicting the network performance.
Event that triggers reporting: used to indicate an event that triggers the reporting, for example, it may be a change of predicted network energy saving configuration, a change of coverage state of oneself and/or a neighboring cell, a change of network performance, a change of predicted network performance, a change of network energy saving performance, a change of predicted network energy saving performance, etc.

The methods performed by the first node and/or the second node in the wireless communication system according to embodiments of the present disclosure may be used for network self-optimization decision. The network self-optimization decision mentioned in the present disclosure may include at least one of network energy saving, load balancing, coverage optimization, mobility optimization and/or management, network configuration determination and/or network configuration updating, etc.

In addition, in the present disclosure, the mode and the state may refer to each other.

In addition, in the present disclosure, activating a network in an energy saving state may mean converting the network in an energy saving state into a non-energy saving state. Deactivating a network in a non-energy saving state may mean converting the network in a non-energy saving state into an energy saving state. Furthermore, in some implementations, activating a network in an energy saving state may mean activating any network node (or its configuration associated with the network) involved in or included in the network in an energy saving state so as to enable the network to convert from an energy saving state to a non-energy saving state. Deactivating a network in a non-energy saving state may mean deactivating any network node (or its configuration associated with the network) involved in or included in the network in a non-energy saving state so as to enable the network to convert from a non-energy saving state to an energy saving state.

In addition, as can be seen from the above description, the description of that a network (or network node) is in an energy saving state in the present disclosure may mean that part or all of the functions of the network (or network node) are turned off or deactivated or restricted in use, so as to enable a purpose of energy saving.

In addition, in the present disclosure, the activation time and/or deactivation time may be expressed by one or more of the following: timestamp, time point, time interval, timer, time period, time length, etc. Herein, the time length may be a length of time from a certain time point, which may be the current time. The time may be a relative time or an absolute time.

In addition, in the present disclosure, the trigger condition and the trigger event may refer to each other.

In addition, in the present disclosure, time and/or time mode may be represented by one or more of the following: timestamp, time point, time interval, timer, time period, time length, period of time, time spacing, etc. Herein, the time and/or time mode may include one or more of the following: activation time, deactivation time, applicable time, inapplicable time, offset, start time, end time, active time, inactive time, long period, short period, retransmission time, Hybrid Automatic Repeat reQuest round-trip time, etc. Herein, the time length may be a length of time from a certain time point, which may be the current time. The time may be a relative time or an absolute time.

In addition, in the present disclosure, the deep sleep state may mean that there is no downlink transmission and no uplink reception, but the sleeping time is long; the light sleep state may mean that there is no downlink transmission and no uplink reception, but the sleeping time is slightly long; and the micro sleep state may mean that there is no downlink transmission and no uplink reception, but the sleep time is short. An uplink activated state may mean that there is uplink reception only; and a downlink activated state may mean that there is downlink transmission only.

Furthermore, in the present disclosure, the mode and/or state may include one or more of the following: switch-on, switch-off, activation, deactivation, energy saving state, non-energy saving state, sleep, non-sleep, deep sleep, light sleep, micro sleep, active uplink (active UL), active downlink (active DL), normal state, reduced (less and/or light) state, no-certain-signal state, simplified state, partial transmission state, partial state, transmission power decrease and/or increase, coverage increase and/or decrease, etc.

In addition, in the present disclosure, the mode and/or state may include one or more specific parameters of the following: relative power, power, transition time, transition energy, etc.

In addition, in the present disclosure, services may include one or more of the following: Ultra Reliable Low Latency Communication (URLLC), Enhanced Mobile Broadband (eMBB), massive Machine Type of Communication (mMTC), etc. A service may also refer to a service with one and/or more QoS requirements.

In addition, in the present disclosure, the non-energy saving state and/or mode may be a normal state and/or mode.

In addition, in the present disclosure, states and modes may refer to each other.

In addition, in the present disclosure, a field may represent a current instance or a predicted instance.

In addition, in the present disclosure, a field may also be a maximum value, a minimum value, an average value, and the like.

In addition, in the present disclosure, the network performance may also be network self-optimization performance, for example, it may include one or more of the following: network energy saving performance, load balancing performance, coverage optimization performance, mobility optimization and/or management performance, network configuration determination and/or network configuration updating performance, etc.

Furthermore, in the present disclosure, the network performance may include one or more of the following: decrease proportion of energy consumption, increase proportion of energy consumption, decrease amount of energy consumption, increase amount of energy consumption, jitter of energy consumption, jitter of energy consumption increase, jitter of energy consumption decrease, Decrease proportion of energy efficiency, Increase proportion of energy efficiency, decrease amount of energy efficiency, increase amount of energy efficiency, Jitter of energy efficiency, Jitter of energy efficiency increase, Jitter of energy efficiency decrease, throughput, packet loss rate, link failure rate, latency, reliability, energy consumption, energy efficiency, ratio of data volume to energy consumption, ratio of throughput to energy consumption, Quality of Experience parameters, etc., and ratio of the change of the above parameters, as well as the extreme value and/or average value of the above parameters. Herein, the energy efficiency may be the ratio of data volume to energy consumption and/or the ratio of throughput to energy consumption. Herein, the ratio of the change is, for example, one or more of the following: ratio of increase, ratio of decrease, etc. Herein, the extreme value, for example, may be one or more of the following: maximum value, minimum value, etc. Herein, the Quality of Experience (QoE) parameters may include one or more of the following: Round-trip time, Jitter duration, corruption duration, average throughput, Initial playout delay, device information, Rendered viewports, codec information, Buffer level, presentation switch events, Play List, Media presentation description (MPD) information, Interactivity Summary, Interactivity Event List, etc.

In addition, in the present disclosure, Suggested may also be Preferred.

In addition, in the present disclosure, the channel and/or signal configuration may include configurations of one or more of the following: system message, paging, Physical Random Access Channel (PRACH), Physical Downlink Control Channel (PDCCH), Physical Uplink Shared Channel (PUSCH), Physical Downlink Shared Channel (PDSCH), data transmission channel, control signaling transmission channel, reference signal transmission channel, broadcast channel, multicast channel, Semi-Persistent Scheduling (SPS) PDCCH, Physical Uplink Control Channel (PUCCH), Scheduling Request information (SR), PUCCH carrying SR, PUCCH/PUSCH carrying Channel State Information (CSI) report, PUCCH carrying Hybrid Automatic Repeat reQuest (HARQ) Acknowledge for SPS, configured grant (CG)PUSCH, reference signal, broadcast signal, Sounding Reference Signal (SRS), positioning reference signal (positioning RS, PRS), Media Access Control Control Element (MAC CE), CSI reference signal, Bandwidth Part (BWP) configuration, carrier Component, transmission configuration indication configuration, path loss reference signal, tracking reference signal, SSB, SIB, MIB, etc. Configuration may include one or more of the following: cell identification, period, frequency, subcarrier spacing, center frequency point, transmission power, repetition, position, semi-subframe index, system frame number offset, initial time of system frame number, state and/or mode, time domain and frequency domain resource configuration, etc.

In addition, in the present disclosure, a node may refer to a node and/or a cell that the node manages and/or belongs to.

In addition, in the present disclosure, configuration may refer to a specific configuration parameter, and it may also be a way for changing a parameter, such as improving, increasing, reducing, decreasing, etc.

In addition, in the present disclosure, a request may also be a demand, and/or Required.

In addition, in the present disclosure, acceptance may also be consent and/or confirmation.

In addition, in the present disclosure, the content exchanged between the nodes may also be an average value, and/or maximum value, and/or minimum value, and/or maximum range, and/or minimum range, and/or average range, and/or evaluation value, and/or evaluation level (for example, it may include high, medium, low, etc.) of the content.

In addition, in the present disclosure, a node may also refer to one or more cells controlled by the node.

In addition, in the present disclosure, a wake-up operation may be to wake up a network in an energy saving state, or to activate a network in an energy saving state and/or deactivate a network in a non-energy saving state.

In addition, in the present disclosure, SSB and/or simplified SSB may include one or more of the following: only Primary Synchronisation Signal (PSS), only Secondary Synchronisation Signal (SSS), no Physical Broadcast Channel (PBCH), partial PBCH, PSS and/or no PBCH, SSS and/or no PBCH, PSS and/or SSS, PSS and/or SSS without PBCH, PSS and/or partial PBCH, SSS and/or partial PBCH, PSS and/or SSS and/or partial PBCH, etc.

In addition, in the present disclosure, configurations may also be represented by an Index and/or a number, where one index and/or number may represent one and/or more and/or a group and/or a plurality group of configurations. The configuration may include the configuration of one and/or more signals and/or channels, where the specific parameters may include the parameters corresponding to the above configuration.

In addition, in the present disclosure, the scope may also be represented by one or more of the following: start identification, end identification, etc.

In addition, in the present disclosure, the energy saving configuration may be the above-mentioned network energy saving related state and/or mode, energy saving configuration, wake-up signal related configuration and/or related parameters, and related parameters. Herein, the related parameters, for example, may include trigger conditions, activation time, deactivation time, configuration mode, capability requirements of the UE, etc. In addition, in the present disclosure, the frequency may include one or more of the following: frequency, subcarrier spacing, center frequency, frequency band, start frequency, end frequency, etc.

In addition, in the present disclosure, the SSB configuration may be a configuration in which SSB is transmitted or a configuration in which SSB is not transmitted.

Further, in the present disclosure, the MIB configuration may be a configuration in which MIB is transmitted or a configuration in which MIB is not transmitted.

Further, in the present disclosure, the SIB configuration may be a configuration in which SIB is transmitted or a configuration in which SIB is not transmitted.

In addition, in the present disclosure, the configuration of the wake-up signal may include one or more of the following: information related to wake-up signal configuration, information related to a configuration about whether to wake up after receiving a wake-up signal, information related to a signal quality of a received wake-up signal, indication of whether to wake up, indication of whether to request wake-up, indication of requesting not to perform a wake-up operation, and the like.

Exemplary embodiments of the present disclosure are further described below with reference to the accompanying drawings.

The text and drawings are provided as examples only to help understand the present disclosure. They should not be construed as limiting the scope of the present disclosure in any way. Although certain embodiments and examples have been provided, based on the disclosure herein, it is apparent to those skilled in the art that changes can be made to the illustrated embodiments and examples without departing from the scope of the present disclosure.

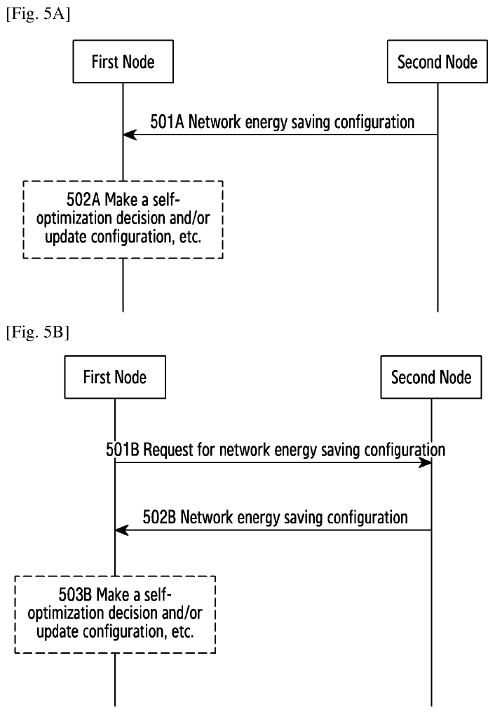

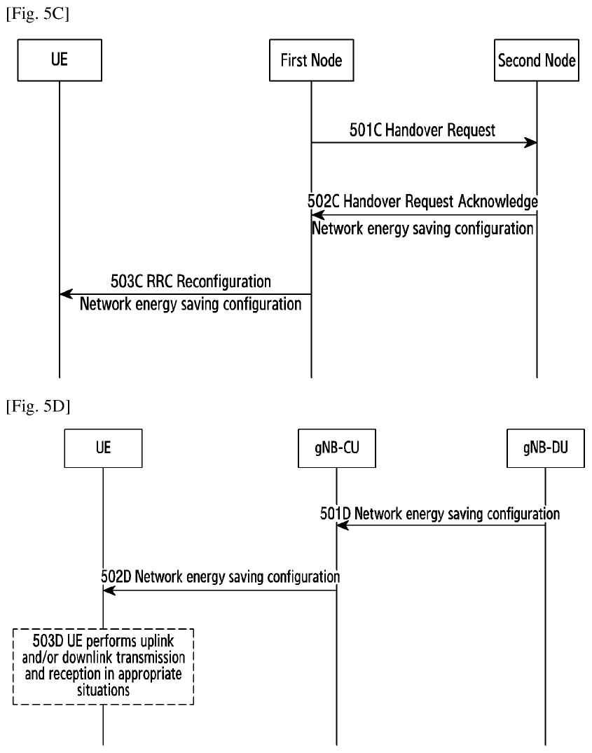

FIG. 5A shows a schematic diagram of an aspect of a method for supporting network energy saving according to embodiments of the present disclosure. Specifically, FIG. 5A shows a process of exchanging network energy saving configuration between two nodes, so that the first node can update the network energy saving configuration and/or make a self-optimization decision according to the received network energy saving configuration, etc. In some implementations, for example, the first node may be a UE, and the second node may be a gNB or gNB-CU or gNB-DU or gNB CU-CP or gNB CU-UP or en-gNB or eNB or ng-eNB. In other implementations, for example, the first node may be a gNB or gNB-CU or gNB-DU or gNB CU-CP or gNB CU-UP or en-gNB or eNB or ng-eNB, and the second node may be a gNB or gNB-CU or gNB-DU or gNB CU-CP or gNB CU-UP or en-gNB or eNB or ng-eNB. In still other implementations, for example, the first node may be an AMF or SMF or MME, and the second node may be a gNB or gNB-CU or gNB CU-CP or en-gNB or eNB or ng-eNB. In yet other embodiments, for example, the first node may be a gNB or gNB-CU or gNB CU-CP or en-gNB or eNB or ng-eNB, and the second node may be an AMF or SMF or MME.

Step 501A: the second node transmits the network energy saving configuration to the first node. The network energy saving configuration may be the aforementioned second message.

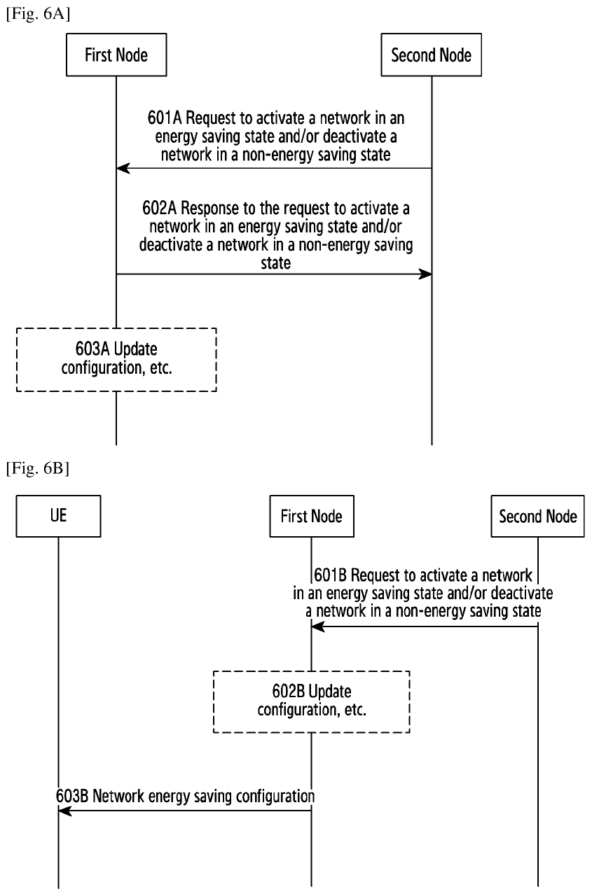

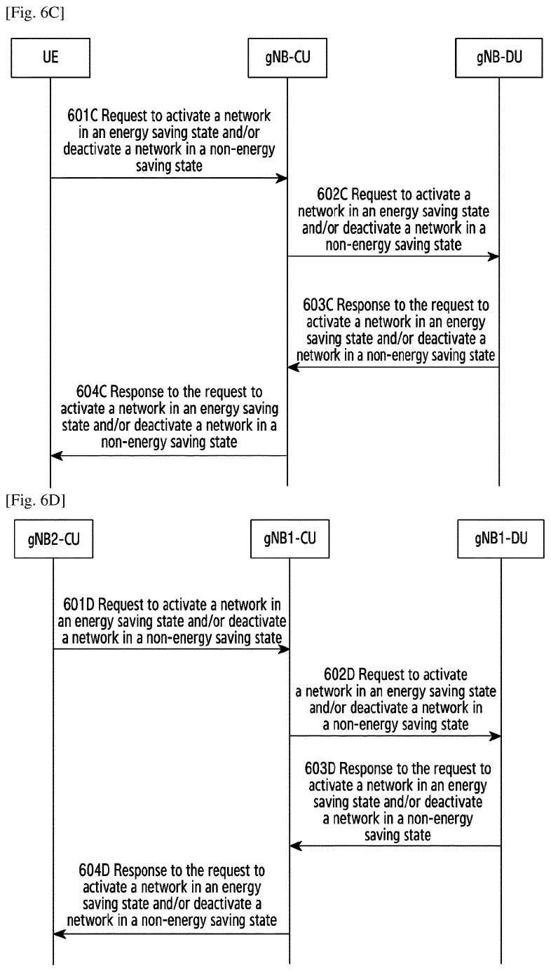

Step 502A: the first node can update the network energy saving configuration and/or make a self-optimization decision according to the received network energy saving configuration, etc. For example, when receiving the network energy saving configuration of a neighboring cell, the first node may adjust the transmission power to achieve the purpose of energy saving while ensuring performance. In some implementations, for example, when receiving that the network energy saving configuration of the neighboring cell is been entered a network energy saving state, the first node may reduce its transmission power due to reduced interference, so as to achieve the purpose of energy saving. In other implementations, for example, after receiving the network energy saving configuration of the neighboring cell, the first node may select a node and/or cell that can support the UE performance as the target node and/or the target cell according to the network energy saving related state and/or mode of the neighboring cell; alternatively, if the neighboring cell has entered the energy saving state, the first node will not enter the energy saving state; alternatively, when performing load balancing, a neighboring cells that can support UE performance in the current state may be selected as the target node and/or target cell for Load Offloading and/or Traffic Offloading. In still other implementations, for example, the first node receives that the second node will take energy saving actions and/or enter an energy saving state at a certain time in the future (for example, the activation time of the network energy saving configuration), then the first node can take this information into account when making a self-optimization decision, for example, the first node will not take energy saving actions and/or not enter an energy saving state at this time to ensure the performance of the UE; alternatively, the first node does not regard the second node and/or a cell of the second node as the target node and/or the target cell for load offloading and/or traffic offloading when making a load balancing decision, so as to avoid offloading ping-pong and/or handover ping-pong, or it may be that the first node does not select the second node and/or the cell of the second node as the target node and/or the target cell for handover when making a mobility decision for UE (e.g. handover); alternatively, the first node may calculate the transmission power and/or prepare the adjustment of the transmission power in advance according to the energy saving actions and/or entrance of an energy saving state of the second node at a certain time in the future. In still other implementations, the first node receives the network energy saving configuration of the second node and/or that the second node will take energy saving actions and/or enter an energy saving state at a certain time in the future (for example, the activation time of the network energy saving configuration), then the first node transmits a request to activate a network in an energy saving state and/or deactivate a network in a non-energy saving state to the second node according to its own situation and/or a request received from other nodes. For example, it may refer to the methods in FIGS. 6A to 6D.

FIG. 5B shows a schematic diagram of an aspect of a method for supporting network energy saving according to embodiments of the present disclosure. Specifically, FIG. 5B shows a process of exchanging network energy saving configuration between two nodes, so that the first node can update the network energy saving configuration and/or make a self-optimization decision according to the received network energy saving configuration, etc. In some implementations, for example, the first node may be a UE, and the second node may be a gNB or gNB-CU or gNB-DU or gNB CU-CP or gNB CU-UP or en-gNB or eNB or ng-eNB. In other implementations, for example, the first node may be a gNB or gNB-CU or gNB-DU or gNB CU-CP or gNB CU-UP or en-gNB or eNB or ng-eNB, and the second node may be a gNB or gNB-CU or gNB-DU or gNB CU-CP or gNB CU-UP or en-gNB or eNB or ng-eNB. In still other implementations, for example, the first node may be an AMF or SMF or MME, and the second node may be a gNB or gNB-CU or gNB CU-CP or en-gNB or eNB or ng-eNB. In yet other embodiments, for example, the first node may be a gNB or gNB-CU or gNB CU-CP or en-gNB or eNB or ng-eNB, and the second node may be an AMF or SMF or MME.

Step 501B: the first node transmits a request for network energy saving configuration to the second node. The request for network energy saving configuration may be the aforementioned first message.

Step 502B: the second node transmits the network energy saving configuration to the first node. The network energy saving configuration may be the aforementioned second message.

Step 503B: the first node can update the network energy saving configuration and/or make a self-optimization decision according to the received network energy saving configuration, etc. For example, when receiving the network energy saving configuration of a neighboring cell, the first node may adjust the transmission power to achieve the purpose of energy saving while ensuring performance. In some implementations, for example, when receiving that the network energy saving configuration of the neighboring cell is been entered a network energy saving state, the first node may reduce its transmission power due to reduced interference, so as to achieve the purpose of energy saving. In other implementations, for example, after receiving the network energy saving configuration of the neighboring cell, the first node may select a node and/or cell that can support the UE performance as the target node and/or the target cell according to the network energy saving related state and/or mode of the neighboring cell; alternatively, if the neighboring cell has entered the energy saving state, the first node will not enter the energy saving state; alternatively, when performing load balancing, a neighboring cells that can support UE performance in the current state may be selected as the target node and/or target cell for Load Offloading and/or Traffic Offloading. In still other implementations, for example, the first node receives that the second node will take energy saving actions and/or enter an energy saving state at a certain time in the future (for example, the activation time of the network energy saving configuration), then the first node can take this information into account when making a self-optimization decision, for example, the first node will not take energy saving actions and/or not enter an energy saving state at this time to ensure the performance of the UE; alternatively, the first node does not regard the second node and/or a cell of the second node as the target node and/or the target cell for load offloading and/or traffic offloading when making a load balancing decision, so as to avoid offloading ping-pong and/or handover ping-pong, or it may be that the first node does not select the second node and/or the cell of the second node as the target node and/or the target cell for handover when making a mobility decision for UE (e.g. handover); alternatively, the first node may calculate the transmission power and/or prepare the adjustment of the transmission power in advance according to the energy saving actions and/or entrance of an energy saving state of the second node at a certain time in the future. In still other implementations, the first node receives the network energy saving configuration of the second node and/or that the second node will take energy saving actions and/or enter an energy saving state at a certain time in the future (for example, the activation time of the network energy saving configuration), then the first node transmits a request to activate a network in an energy saving state and/or deactivate a network in a non-energy saving state to the second node according to its own situation and/or a request received from other nodes. For example, it may refer to the methods in FIGS. 6A to 6D.

FIG. 5C shows a schematic diagram of an aspect of a method for supporting network energy saving according to embodiments of the present disclosure. Specifically, FIG. 5C shows a process of exchanging network energy saving configuration between nodes in the handover process of the UE, so that the UE can obtain the network energy saving configuration of the target node and perform uplink and/or downlink transmission and reception at an appropriate time according to the configuration. In some implementations, for example, the first node may be a gNB or gNB-CU or gNB-DU or gNB CU-CP or gNB CU-UP or en-gNB or eNB or ng-eNB, and the second node may be a gNB or gNB-CU or gNB-DU or gNB CU-CP or gNB CU-UP or en-gNB or eNB or ng-eNB.

Step 501C: the first node transmits a Handover Request for the UE to the second node.

Step 502C: the second node transmits the network energy saving configuration of the second node to the first node. The network energy saving configuration may be the aforementioned second message. The message may be a Handover Request Acknowledge message or may be transmitted through a Handover Request Acknowledge message.

Step 503C: the first node transmits the network energy saving configuration of the second node to the UE. The network energy saving configuration may be the aforementioned second message. The message may be an RRC Reconfiguration message or may be transmitted through an RRC Reconfiguration message. After obtaining the network energy saving configuration of the target node, the UE performs uplink and/or downlink transmission and reception at an appropriate time according to the configuration.

FIG. 5D shows a schematic diagram of an aspect of a method for supporting network energy saving according to embodiments of the present disclosure. Specifically, FIG. 5D shows a process of exchanging network energy saving configuration between gNB-DU and gNB-CU, and between gNB-CU and UE, so that the UE can obtain the network energy saving configuration of the node and perform uplink and/or downlink transmission and reception at an appropriate time according to the configuration.

Step 501D: gNB-DU transmits the network energy saving configuration to gNB-CU. The network energy saving configuration may be the aforementioned second message.

Step 502D: gNB-CU transmits the network energy saving configuration to UE. The network energy saving configuration may be the aforementioned second message.

Step 503D: the UE can obtain the network energy saving configuration of the node, and perform uplink and/or downlink transmission and reception at an appropriate time according to the configuration. After obtaining the network energy saving configuration of the target node, the UE performs uplink and/or downlink transmission and reception at an appropriate time according to the configuration.

FIG. 6A shows a schematic diagram of an aspect of a method for supporting network energy saving according to embodiments of the present disclosure. Specifically, FIG. 6A shows a process of exchanging a request to activate a network in an energy saving state and/or deactivate a network in a non-energy saving state between nodes, so as to request and/or suggest the first node to update network energy saving configuration, for example, to activate the network in an energy saving state and/or deactivate the network in a non-energy saving state, so as to avoid local overload, excessive local energy consumption, and inability to guarantee UE performance, etc. In some implementations, for example, the first node may be a gNB or gNB-CU or gNB-DU or gNB CU-CP or gNB CU-UP or en-gNB or eNB or ng-eNB, and the second node may be a UE. In other implementations, for example, the first node may be a gNB or gNB-CU or gNB-DU or gNB CU-CP or gNB CU-UP or en-gNB or eNB or ng-eNB, and the second node may be a gNB or gNB-CU or gNB-DU or gNB CU-CP or gNB CU-UP or en-gNB or eNB or ng-eNB. In still other implementations, for example, the first node may be an AMF or SMF or MME, and the second node may be a gNB or gNB-CU or gNB CU-CP or en-gNB or eNB or ng-eNB. In yet other embodiments, for example, the first node may be a gNB or gNB-CU or gNB CU-CP or en-gNB or eNB or ng-eNB, and the second node may be an AMF or SMF or MME.

Step 601A: the second node transmits a request to activate a network in an energy saving state and/or deactivate a network in a non-energy saving state to the first node. The request to activate the network in the energy saving state and/or deactivate the network in the non-energy saving state may be the aforementioned third message.

Step 602A: the first node transmits a response to the request to activate the network in energy saving state and/or deactivate the network in non-energy saving state to the second node according to the received message including the request to activate the network in energy saving state and/or deactivate the network in non-energy saving state, so as to inform the second node of the configuration that can be activated. The response to the request to activate a network in an energy saving state and/or deactivate a network in a non-energy saving state may be the aforementioned fourth message.

Step 603A: the first node updates the energy saving configuration according to the received message including the request to activate a network in an energy saving state and/or deactivate a network in a non-energy saving state.

In some implementations, step 603A may be performed before, after or at the same time with step 602A.

FIG. 6B shows a schematic diagram of an aspect of a method for supporting network energy saving according to embodiments of the present disclosure. Specifically, FIG. 6B shows a process of exchanging a request to activate a network in an energy saving state and/or deactivate a network in a non-energy saving state between nodes, so as to request and/or suggest the first node to update network energy saving configuration, for example, to activate the network in an energy saving state and/or deactivate the network in a non-energy saving state, so as to avoid local overload, excessive local energy consumption, and inability to guarantee UE performance, etc. In some implementations, for example, the first node may be a gNB or gNB-CU or gNB-DU or gNB CU-CP or gNB CU-UP or en-gNB or eNB or ng-eNB, and the second node may be a UE. In other implementations, for example, the first node may be a gNB or gNB-CU or gNB-DU or gNB CU-CP or gNB CU-UP or en-gNB or eNB or ng-eNB, and the second node may be a gNB or gNB-CU or gNB-DU or gNB CU-CP or gNB CU-UP or en-gNB or eNB or ng-eNB. In still other implementations, for example, the first node may be an AMF or SMF or MME, and the second node may be a gNB or gNB-CU or gNB CU-CP or en-gNB or eNB or ng-eNB. In yet other embodiments, for example, the first node may be a gNB or gNB-CU or gNB CU-CP or en-gNB or eNB or ng-eNB, and the second node may be an AMF or SMF or MME.

Step 601B: the second node transmits a request to activate the network in the energy saving state and/or deactivate the network in the non-energy saving state to the first node. The request to activate the network in the energy saving state and/or deactivate the network in the non-energy saving state may be the aforementioned third message.

Step 602B: the first node updates the energy saving configuration according to the received message including the request to activate a network in an energy saving state and/or deactivate a network in a non-energy saving state.

Step 603B: the first node transmits the updated and/or planned and/or predicted network energy saving configuration to the UE and/or other nodes. The network energy saving configuration may be the aforementioned second message. After obtaining the network energy saving configuration of the target node, the UE performs uplink and/or downlink transmission and reception at an appropriate time according to the configuration. Other nodes can update the network energy saving configuration and/or make a self-optimization decision according to the received network energy saving configuration, etc. For example, when receiving the network energy saving configuration of a neighboring cell, the first node may adjust the transmission power to achieve the purpose of energy saving while ensuring performance. In some implementations, for example, when receiving that the network energy saving configuration of the neighboring cell is been entered a network energy saving state, the first node may reduce its transmission power due to reduced interference, so as to achieve the purpose of energy saving. In other implementations, for example, after receiving the network energy saving configuration of the neighboring cell, the first node may select a node and/or cell that can support the UE performance as the target node and/or the target cell according to the network energy saving related state and/or mode of the neighboring cell; alternatively, if the neighboring cell has entered the energy saving state, the first node will not enter the energy saving state; alternatively, when performing load balancing, a neighboring cells that can support UE performance in the current state may be selected as the target node and/or target cell for Load Offloading and/or Traffic Offloading. In still other implementations, for example, the first node receives that the second node will take energy saving actions and/or enter an energy saving state at a certain time in the future (for example, the activation time of the network energy saving configuration), then the first node can take this information into account when making a self-optimization decision, for example, the first node will not take energy saving actions and/or not enter an energy saving state at this time to ensure the performance of the UE; alternatively, the first node does not regard the second node and/or a cell of the second node as the target node and/or the target cell for load offloading and/or traffic offloading when making a load balancing decision, so as to avoid offloading ping-pong and/or handover ping-pong, or it may be that the first node does not select the second node and/or the cell of the second node as the target node and/or the target cell for handover when making a mobility decision for UE (e.g. handover); alternatively, the first node may calculate the transmission power and/or prepare the adjustment of the transmission power in advance according to the energy saving actions and/or entrance of an energy saving state of the second node at a certain time in the future. In still other implementations, the first node receives the network energy saving configuration of the second node and/or that the second node will take energy saving actions and/or enter an energy saving state at a certain time in the future (for example, the activation time of the network energy saving configuration), then the first node transmits a request to activate a network in an energy saving state and/or deactivate a network in a non-energy saving state to the second node according to its own situation and/or a request received from other nodes. For example, it may refer to the methods in FIGS. 6A to 6D.

In some implementations, step 603B may be performed before, after or at the same time with step 602B.

FIG. 6C shows a schematic diagram of an aspect of a method for supporting network energy saving according to embodiments of the present disclosure. Specifically, FIG. 6C shows a process of exchanging a request to activate a network in an energy saving state and/or deactivate a network in a non-energy saving state between UE and gNB-CU and between gNB-CU and gNB-DU, so as to require and/or suggest the first node to update the network energy saving configuration, for example, to activate the network in an energy saving state and/or deactivate the network in a non-energy saving state, etc., so as to avoid that the performance of UE cannot be guaranteed, etc.

Step 601C: UE transmits a request to activate a network in an energy saving state and/or deactivate a network in a non-energy saving state to gNB-CU. The request to activate the network in the energy saving state and/or deactivate the network in the non-energy saving state may be the aforementioned third message.

Step 602C: gNB-CU transmits the request to activate the network in an energy saving state and/or deactivate the network in a non-energy saving state to gNB-DU. The request to activate the network in the energy saving state and/or deactivate the network in the non-energy saving state may be the aforementioned third message.

Step 603C: gNB-DU transmits a response to the request to activate the network in an energy saving state and/or deactivate the network in a non-energy saving state to gNB-CU according to the received request to activate the network in an energy saving state and/or deactivate the network in a non-energy saving state, so as to inform gNB-CU of the configuration that can be activated. The response to the request to activate a network in an energy saving state and/or deactivate a network in a non-energy saving state may be the aforementioned fourth message.

Step 604C: gNB-CU transmits the received response to the request to activate a network in an energy saving state and/or deactivate a network in a non-energy saving state to the UE, to inform the UE of the configuration that can be activated. The response to the request to activate a network in an energy saving state and/or deactivate a network in a non-energy saving state may be the aforementioned fourth message. After obtaining the network energy saving configuration of the target node, the UE performs uplink and/or downlink transmission and reception at an appropriate time according to the configuration.

If the response of gNB-DU to the request to activate the network in an energy saving state and/or deactivate the network in a non-energy saving state received by gNB-CU in step 603C cannot meet the request to activate the network in an energy saving state and/or deactivate the network in a non-energy saving state in step 601C, gNB-CU can perform handover for the UE.

FIG. 6D shows a schematic diagram of an aspect of a method for supporting network energy saving according to embodiments of the present disclosure. Specifically, FIG. 6D shows a process of exchanging a request to activate a network in an energy saving state and/or deactivate a network in a non-energy saving state between gNB2-CU and gNB1-CU and between gNB1-CU and gNB1-DU, so as to require and/or suggest the first node to update the network energy saving configuration, for example, to activate the network in an energy saving state and/or deactivate the network in a non-energy saving state, etc., so as to avoid that the UE performance cannot be guaranteed, etc.

Step 601D: gNB2 (or gNB2-CU) transmits a request to activate a network in an energy saving state and/or deactivate a network in a non-energy saving state to gNB1-CU. The request to activate the network in the energy saving state and/or deactivate the network in the non-energy saving state may be the aforementioned third message.

Step 602D: gNB1-CU transmits a request to activate the network in an energy saving state and/or deactivate the network in a non-energy saving state to gNB1-DU. The request to activate the network in the energy saving state and/or deactivate the network in the non-energy saving state may be the aforementioned third message.

Step 603D: gNB1-DU transmits a response to the request to activate the network in energy saving state and/or deactivate the network in non-energy saving state to gNB1-CU according to the received request to activate the network in an energy saving state and/or deactivate the network in a non-energy saving state, so as to inform gNB1-CU of the configuration that can be activated. The response to the request to activate a network in an energy saving state and/or deactivate a network in a non-energy saving state may be the aforementioned fourth message.

Step 604D: gNB1-CU transmits the received response to the request to activate a network in an energy saving state and/or deactivate a network in a non-energy saving state to gNB2 (or gNB2-CU) to inform gNB2 (or gNB2-CU) of the configuration that can be activated. The response to the request to activate a network in an energy saving state and/or deactivate a network in a non-energy saving state may be the aforementioned fourth message. gNB2 can obtain the network energy saving configuration according to the received response to the request to activate a network in an energy saving state and/or deactivate a network in a non-energy saving state, and make network energy saving configuration updating and/or self-optimization decision, etc. For example, when receiving a response to the request to activate a network in an energy saving state and/or deactivate a network in a non-energy saving state from a neighboring cell thus obtaining the network energy saving configuration, the first node can adjust the transmission power to achieve a purpose of energy saving while ensuring performance. In some implementations, for example, when the network energy saving configuration of a neighboring cell is being in a network energy saving state, because of the reduction of interference, the first node may reduce its transmission power, so as to achieve a purpose of energy saving. In other implementations, for example, after obtaining the network energy saving configuration of a neighboring cell, the first node can select nodes and/or cells that can support UE performance as target nodes and/or target cells according to the network energy saving related state and/or mode of the neighboring cell; alternatively, if the neighboring cell has entered the energy saving state, the first node will not enter the energy saving state; alternatively, when performing load balancing, a neighboring cells that can support UE performance in the current state may be selected as the target node and/or target cell for Load Offloading and/or Traffic Offloading. In still other implementations, for example, the first node receives that the second node will take energy saving actions and/or enter an energy saving state at a certain time in the future (for example, the activation time of the network energy saving configuration), then the first node can take this information into account when making a self-optimization decision, for example, the first node will not take energy saving actions and/or not enter an energy saving state at this time to ensure the performance of the UE; alternatively, the first node does not regard the second node and/or a cell of the second node as the target node and/or the target cell for load offloading and/or traffic offloading when making a load balancing decision, so as to avoid offloading ping-pong and/or handover ping-pong, or it may be that the first node does not select the second node and/or the cell of the second node as the target node and/or the target cell for handover when making a mobility decision for UE (e.g. handover); alternatively, the first node may calculate the transmission power and/or prepare the adjustment of the transmission power in advance according to the energy saving actions and/or entrance of an energy saving state of the second node at a certain time in the future. In still other implementations, the first node receives a response of the second node to the request to activate the network in an energy saving state and/or deactivate the network in a non-energy saving state, so as to obtain the network energy saving configuration and/or take energy saving actions and/or enter the energy saving state at a certain time in the future (for example, the activation time of the network energy saving configuration), then the first node transmits a request to activate the network in an energy saving state and/or deactivate the network in a non-energy saving state to the second node according to its own situation and/or the request of other nodes. For example, it may refer to the methods in FIGS. 6A to 6D.

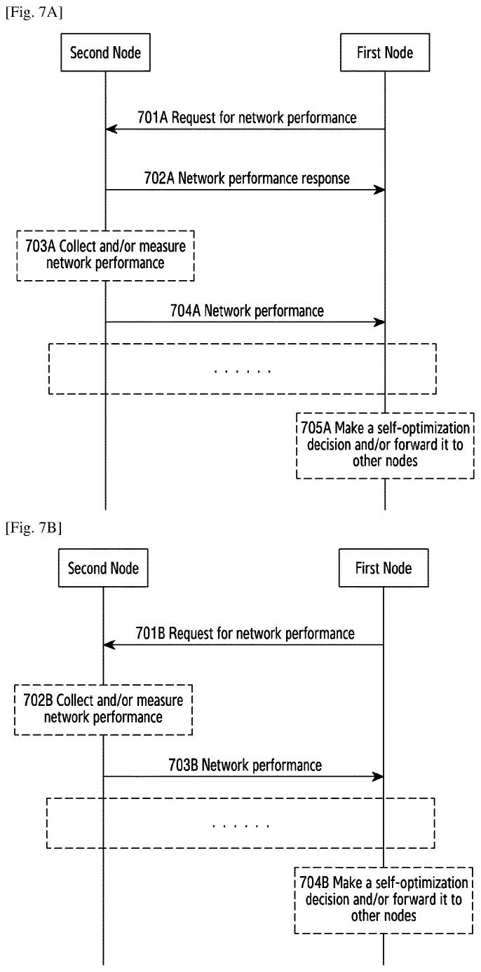

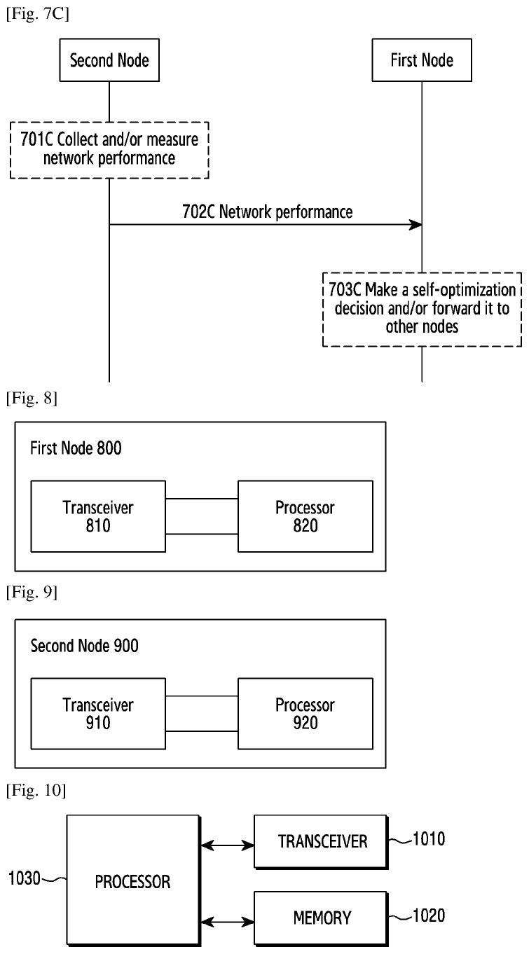

FIG. 7A shows a schematic diagram of an aspect of a method for supporting network energy saving according to embodiments of the present disclosure. Specifically, FIG. 7A shows a process of exchanging network performance between nodes, so that the first node can obtain the network performance of other nodes and provide reference information for self-optimization decision, etc. In some implementations, for example, the first node may be a UE, and the second node may be a gNB or gNB-CU or gNB-DU or gNB CU-CP or gNB CU-UP or en-gNB or eNB or ng-eNB. In other implementations, for example, the first node may be a gNB or gNB-CU or gNB-DU or gNB CU-CP or gNB CU-UP or en-gNB or eNB or ng-eNB, and the second node may be a gNB or gNB-CU or gNB-DU or gNB CU-CP or gNB CU-UP or en-gNB or eNB or ng-eNB. In still other implementations, for example, the first node may be an AMF or SMF or MME, and the second node may be a gNB or gNB-CU or gNB CU-CP or en-gNB or eNB or ng-eNB. In yet other embodiments, for example, the first node may be a gNB or gNB-CU or gNB CU-CP or en-gNB or eNB or ng-eNB, and the second node may be an AMF or SMF or MME.

Step 701A: the first node transmits a request for network performance to the second node to request the second node to feed back the network performance to the first node. The network performance request may be the aforementioned sixth message.

Step 702A: the second node transmits a network performance response to the first node to feed back whether the second node can trigger the requested network performance measurement and/or collection. The network performance response may be the aforementioned seventh message.

Step 703A: the second node collects and/or measures network performance.

Step 704A: the second node transmits the network performance to the first node. The network performance may be the aforementioned eighth message.

Step 705A: the first node sets the network self-optimization decision based on the obtained network performance information and/or forwards it to other nodes, etc., so that the first node can obtain the network performance of the second node and/or other nodes, and the first node can make network energy saving configuration updating and/or self-optimization decision and the like according to the received network performance, and/or judge whether the decision made is correct. For example, when the cell and/or node makes a decision to enter an energy saving mode and has entered the energy saving mode, and the received network performance of a neighboring cell decreases, then it indicates that the energy saving decision is not appropriate. In some implementations, for example, when the cell and/or node needs to make an energy saving decision and/or load balancing and/or mobility management decision, and the received network performance of a neighboring cell decreases, then the cell and/or node should not enter the energy saving mode and/or should not transfer the load to the neighboring cell whose network performance decreases and/or should not switch users to the neighboring cell whose network performance decreases.

If the request in step 701A requires the second node to report periodically, and/or the response in step 702A indicates that periodic reporting can be performed, then step 703A, step 704A and/or step 705A are performed periodically.

FIG. 7B shows a schematic diagram of an aspect of a method for supporting network energy saving according to embodiments of the present disclosure. Specifically, FIG. 7B shows a process of exchanging network performance between nodes, so that the first node can obtain the network performance of other nodes and provide reference information for self-optimization decision, etc. In some implementations, for example, the first node may be a UE, and the second node may be a gNB or gNB-CU or gNB-DU or gNB CU-CP or gNB CU-UP or en-gNB or eNB or ng-eNB. In other implementations, for example, the first node may be a gNB or gNB-CU or gNB-DU or gNB CU-CP or gNB CU-UP or en-gNB or eNB or ng-eNB, and the second node may be a gNB or gNB-CU or gNB-DU or gNB CU-CP or gNB CU-UP or en-gNB or eNB or ng-eNB. In still other implementations, for example, the first node may be an AMF or SMF or MME, and the second node may be a gNB or gNB-CU or gNB CU-CP or en-gNB or eNB or ng-eNB. In yet other embodiments, for example, the first node may be a gNB or gNB-CU or gNB CU-CP or en-gNB or eNB or ng-eNB, and the second node may be an AMF or SMF or MME.

Step 701B: the first node transmits a request for network performance to the second node to request the second node to feed back the network performance to the first node. The request for network performance may be the aforementioned sixth message.

Step 702B: the second node collects and/or measures network performance.

Step 703B: the second node transmits the network performance to the first node. The network performance may be the aforementioned eighth message.

Step 704B: the first node sets the network self-optimization decision based on the obtained network performance information and/or forwards it to other nodes, etc., so that the first node can obtain the network performance of the second node and/or other nodes, and the first node can make network energy saving configuration updating and/or self-optimization decision and the like according to the received network performance, and/or judge whether the decision made is correct. For example, when the cell and/or node makes a decision to enter an energy saving mode and has entered the energy saving mode, and the received network performance of a neighboring cell decreases, then it indicates that the energy saving decision is not appropriate. In some implementations, for example, when the cell and/or node needs to make an energy saving decision and/or load balancing and/or mobility management decision, and the received network performance of a neighboring cell decreases, then the cell and/or node should not enter the energy saving mode and/or should not transfer the load to the neighboring cell whose network performance decreases and/or should not switch users to the neighboring cell whose network performance decreases.

If the request in step 701B requires the second node to report periodically, steps 702B and 703B are performed periodically.

FIG. 7C shows a schematic diagram of an aspect of a method for supporting network energy saving according to embodiments of the present disclosure. Specifically, FIG. 7C shows a process of exchanging network performance between nodes, so that the first node can obtain the network performance of other nodes and provide reference information for self-optimization decision, etc. In some implementations, for example, the first node may be a UE, and the second node may be a gNB or gNB-CU or gNB-DU or gNB CU-CP or gNB CU-UP or en-gNB or eNB or ng-eNB. In other implementations, for example, the first node may be a gNB or gNB-CU or gNB-DU or gNB CU-CP or gNB CU-UP or en-gNB or eNB or ng-eNB, and the second node may be a gNB or gNB-CU or gNB-DU or gNB CU-CP or gNB CU-UP or en-gNB or eNB or ng-eNB. In still other implementations, for example, the first node may be an AMF or SMF or MME, and the second node may be a gNB or gNB-CU or gNB CU-CP or en-gNB or eNB or ng-eNB. In yet other embodiments, for example, the first node may be a gNB or gNB-CU or gNB CU-CP or en-gNB or eNB or ng-eNB, and the second node may be an AMF or SMF or MME.

Step 701C: the second node collects and/or measures the network performance.

Step 702C: the second node transmits the network performance to the first node. The network performance may be the aforementioned eighth message.

Step 703C: the first node sets the network self-optimization decision based on the obtained network performance information and/or forwards it to other nodes, etc., so that the first node can obtain the network performance of the second node and/or other nodes, and the first node can make network energy saving configuration updating and/or self-optimization decision and the like according to the received network performance, and/or judge whether the decision made is correct. For example, when the cell and/or node makes a decision to enter an energy saving mode and has entered the energy saving mode, and the received network performance of a neighboring cell decreases, then it indicates that the energy saving decision is not appropriate. In some implementations, for example, when the cell and/or node needs to make an energy saving decision and/or load balancing and/or mobility management decision, and the received network performance of a neighboring cell decreases, then the cell and/or node should not enter the energy saving mode and/or should not transfer the load to the neighboring cell whose network performance decreases and/or should not switch users to the neighboring cell whose network performance decreases.

Next, FIG. 8 shows a schematic diagram of a first node 800 according to embodiments of the present disclosure.

As shown in FIG. 8, a first node (or first node device) 800 according to embodiments of the present disclosure may include a transceiver 810 and a processor 820. The transceiver 810 may be configured to transmit and receive signals. The processor 820 may be coupled to the transceiver 810 and may be configured to (e.g., control the transceiver 810 to) perform methods performed by a first node according to embodiments of the present disclosure.

FIG. 9 shows a schematic diagram of a second node 900 according to embodiments of the present disclosure.

As shown in FIG. 9, a second node (or second node device) 900 according to embodiments of the present disclosure may include a transceiver 910 and a processor 920. The transceiver 910 may be configured to transmit and receive signals. The processor 920 may be coupled to the transceiver 910 and may be configured to (e.g., control the transceiver 910 to) perform methods performed by a second node according to embodiments of the present disclosure. A processor may also be called a controller.

FIG. 10 illustrates a block diagram of a terminal (or a user equipment (UE)), according to embodiments of the present disclosure.

As shown in FIG. 10, a terminal according to an embodiment may include a transceiver 1010, a memory 1020, and a processor (or a controller) 1030. The transceiver 1010, the memory 1020, and the processor (or controller) 1030 of the terminal may operate according to a communication method of the terminal described above. However, the components of the terminal are not limited thereto. For example, the terminal may include more or fewer components than those described in FIG. 10. In addition, the processor (or controller) 1030, the transceiver 1010, and the memory 1020 may be implemented as a single chip. Also, the processor (or controller) 1030 may include at least one processor. Furthermore, the UE of FIG. 10 corresponds to the UE of FIG. 1, FIG. 2, FIG. 5C, FIG. 5D, FIG. 6B, or FIG. 6C.

The transceiver 1010 collectively refers to a terminal station receiver and a terminal transmitter, and may transmit/receive a signal to/from a base station or another terminal. The signal transmitted or received to or from the terminal may include control information and data. The transceiver 1010 may include a RF transmitter for up-converting and amplifying a frequency of a transmitted signal, and a RF receiver for amplifying low-noise and down-converting a frequency of a received signal. However, this is only an example of the transceiver 1010 and components of the transceiver 1010 are not limited to the RF transmitter and the RF receiver.

Also, the transceiver 1010 may receive and output, to the processor (or controller) 1030, a signal through a wireless channel, and transmit a signal output from the processor (or controller) 1030 through the wireless channel.

The memory 1020 may store a program and data required for operations of the terminal. Also, the memory 1020 may store control information or data included in a signal obtained by the terminal. The memory 1020 may be a storage medium, such as read-only memory (ROM), random access memory (RAM), a hard disk, a CD-ROM, and a DVD, or a combination of storage media.

The processor (or controller) 1030 may control a series of processes such that the terminal operates as described above. For example, the processor (or controller) 1030 may receive a data signal and/or a control signal, and the processor (or controller) 1030 may determine a result of receiving the signal transmitted by the base station and/or the other terminal.

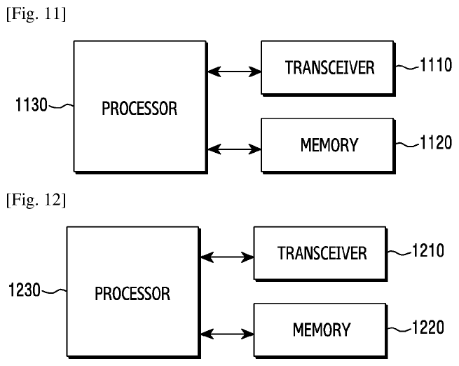

FIG. 11 illustrates a block diagram of a base station, according to embodiments of the present disclosure.

As shown in FIG. 11 is, the base station of the present disclosure may include a transceiver 1110, a memory 1120, and a processor (or, a controller) 1130. The transceiver 1110, the memory 1120, and the processor (or controller) 1130 of the base station may operate according to a communication method of the base station described above. However, the components of the base station are not limited thereto. For example, the base station may include more or fewer components than those described in FIG. 11. In addition, the processor (or controller) 1130, the transceiver 1110, and the memory 1120 may be implemented as a single chip. Also, the processor (or controller) 1130 may include at least one processor. Furthermore, the base station of FIG. 11 corresponds to the BS (eg., Node B of UTRAN, eNB of E-UTRAN 102) of FIG. 1 or gNB-CU or gNB-DU of FIG. 5D, FIG. 6C, gNB1-CU or gNB1-DU of FIG. 6D.

The transceiver 1110 collectively refers to a base station receiver and a base station transmitter, and may transmit/receive a signal to/from a terminal, another base station, and/or a core network function(s) (or entity(s)). The signal transmitted or received to or from the base station may include control information and data. The transceiver 1110 may include a RF transmitter for up-converting and amplifying a frequency of a transmitted signal, and a RF receiver for amplifying low-noise and down-converting a frequency of a received signal. However, this is only an example of the transceiver 1110 and components of the transceiver 1110 are not limited to the RF transmitter and the RF receiver.

Also, the transceiver 1110 may receive and output, to the processor (or controller) 1130, a signal through a wireless channel, and transmit a signal output from the processor (or controller) 1130 through the wireless channel.

The memory 1120 may store a program and data required for operations of the base station. Also, the memory 1120 may store control information or data included in a signal obtained by the base station. The memory 1120 may be a storage medium, such as ROM, RAM, a hard disk, a CD-ROM, and a DVD, or a combination of storage media.

The processor (or controller) 1130 may control a series of processes such that the base station operates as described above. For example, the processor (or controller) 1130 may receive a data signal and/or a control signal, and the processor (or controller) 1130 may determine a result of receiving the signal transmitted by the terminal and/or the core network function.

FIG. 12 is a block diagram illustrating a structure of a network entity according to an embodiment of the disclosure.

As shown in FIG. 12, the network entity of the present disclosure may include a transceiver 1210, a memory 1220, and a processor 1230. The transceiver 1210, the memory 1220, and the processor 1230 of the network entity may operate according to a communication method of the network entity described above. However, the components of the terminal are not limited thereto. For example, the network entity may include more or fewer components than those described above. In addition, the processor 1230, the transceiver 1210, and the memory 1220 may be implemented as a single chip. Also, the processor 1230 may include at least one processor. Furthermore, the network entity illustrated in FIG. 12 may correspond to the network entity (e.g., AMF entity (203) or SMF entity (205) illustrated in FIG. 2).

The transceiver 1210 collectively refers to a network entity receiver and a network entity transmitter, and may transmit/receive a signal to/from a base station or a UE. The signal transmitted or received to or from the base station or the UE may include control information and data. In this regard, the transceiver 1210 may include a RF transmitter for up-converting and amplifying a frequency of a transmitted signal, and a RF receiver for amplifying low-noise and down-converting a frequency of a received signal. However, this is only an example of the transceiver 1210 and components of the transceiver 1210 are not limited to the RF transmitter and the RF receiver.

Also, the transceiver 1210 may receive and output, to the processor 1230, a signal through a wireless channel, and transmit a signal output from the processor 1230 through the wireless channel.

The memory 1220 may store a program and data required for operations of the network entity. Also, the memory 1220 may store control information or data included in a signal obtained by the network entity. The memory 1220 may be a storage medium, such as ROM, RAM, a hard disk, a CD-ROM, and a DVD, or a combination of storage media.

The processor 1230 may control a series of processes such that the network entity operates as described above. For example, the transceiver 1210 may receive a data signal including a control signal, and the processor 1230 may determine a result of receiving the data signal.

The methods according to the embodiments described in the claims or the detailed description of the present disclosure may be implemented in hardware, software, or a combination of hardware and software.

When the electrical structures and methods are implemented in software, a computer-readable recording medium having one or more programs (software modules) recorded thereon may be provided. The one or more programs recorded on the computer-readable recording medium are configured to be executable by one or more processors in an electronic device. The one or more programs include instructions to execute the methods according to the embodiments described in the claims or the detailed description of the present disclosure.

The programs (e.g., software modules or software) may be stored in random access memory (RAM), non-volatile memory including flash memory, read-only memory (ROM), electrically erasable programmable read-only memory (EEPROM), a magnetic disc storage device, compact disc-ROM (CD-ROM), a digital versatile disc (DVD), another type of optical storage device, or a magnetic cassette. Alternatively, the programs may be stored in a memory system including a combination of some or all of the above-mentioned memory devices. In addition, each memory device may be included by a plural number.

The programs may also be stored in an attachable storage device which is accessible through a communication network such as the Internet, an intranet, a local area network (LAN), a wireless LAN (WLAN), or a storage area network (SAN), or a combination thereof. The storage device may be connected through an external port to an apparatus according the embodiments of the present disclosure. Another storage device on the communication network may also be connected to the apparatus performing the embodiments of the present disclosure.

In the afore-described embodiments of the present disclosure, elements included in the present disclosure are expressed in a singular or plural form according to the embodiments. However, the singular or plural form is appropriately selected for convenience of explanation and the present disclosure is not limited thereto. As such, an element expressed in a plural form may also be configured as a single element, and an element expressed in a singular form may also be configured as plural elements.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Embodiments of the present disclosure also provide a computer-readable medium having stored thereon computer-readable instructions which, when executed by a processor, implement any method according to embodiments of the present disclosure.

Various embodiments of the present disclosure may be implemented as computer-readable codes embodied on a computer-readable recording medium from a specific perspective. A computer-readable recording medium is any data storage device that can store data readable by a computer system. Examples of computer-readable recording media may include read-only memory (ROM), random access memory (RAM), compact disk read-only memory (CD-ROM), magnetic tape, floppy disk, optical data storage device, carrier wave (e.g., data transmission via the Internet), etc. Computer-readable recording media can be distributed by computer systems connected via a network, and thus computer-readable codes can be stored and executed in a distributed manner. Furthermore, functional programs, codes and code segments for implementing various embodiments of the present disclosure can be easily explained by those skilled in the art to which the embodiments of the present disclosure are applied.

It will be understood that the embodiments of the present disclosure may be implemented in the form of hardware, software, or a combination of hardware and software. The software may be stored as program instructions or computer-readable codes executable on a processor on a non-transitory computer-readable medium. Examples of non-transitory computer-readable recording media include magnetic storage media (such as ROM, floppy disk, hard disk, etc.) and optical recording media (such as CD-ROM, digital video disk (DVD), etc.). Non-transitory computer-readable recording media may also be distributed on computer systems coupled to a network, so that computer-readable codes are stored and executed in a distributed manner. The medium can be read by a computer, stored in a memory, and executed by a processor. Various embodiments may be implemented by a computer or a portable terminal including a controller and a memory, and the memory may be an example of a non-transitory computer-readable recording medium suitable for storing program(s) with instructions for implementing embodiments of the present disclosure. The present disclosure may be realized by a program with code for concretely implementing the apparatus and method described in the claims, which is stored in a machine (or computer)-readable storage medium. The program may be electronically carried on any medium, such as a communication signal transmitted via a wired or wireless connection, and the present disclosure suitably includes its equivalents.

What has been described above is only the specific implementation of the present disclosure, but the scope of protection of the present disclosure is not limited thereto. Anyone who is familiar with this technical field may make various changes or substitutions within the technical scope disclosed in the present disclosure, and these changes or substitutions should be covered within the scope of protection of the present disclosure. Therefore, the scope of protection of the present disclosure should be based on the scope of protection of the claims.

1. A method performed by a first central unit (CU) of a base station in a wireless communication system, the method comprising:
transmitting, to a distributed unit (DU) of the base station, a first message for a configuration update for the CU, the first message including a first list of at least one synchronization signal and physical broadcast channel block (SSB) to be activated; and
receiving, from the DU of the base station, a second message for acknowledging the configuration update for the CU, the second message including a second list of at least one SSB activated based on the first message.

2. The method of claim 1, wherein the first list of the at least one SSB includes an index for each of the at least one SSB to be activated, and wherein the second list of the at least one SSB includes an index for each of the at least one SSB activated based on the first message.

3. The method of claim 1, wherein the first message further includes information for deactivating a cell for energy saving.

4. The method of claim 1, further comprising:
transmitting, to a second CU, a third message for a cell activation for the second CU, the third message including a third list of at least one SSB to be activated; and
receiving, from the second CU, a fourth message for responding to the cell activation for the second CU, the fourth message including a fourth list of at least one SSB activated based on the third message.

5. A method performed by a distributed unit (DU) of a base station in a wireless communication system, the method comprising:
receiving, from a central unit (CU) of the base station, a first message for a configuration update for the CU, the first message including a first list of at least one synchronization signal and physical broadcast channel block (SSB) to be activated; and
transmitting, to the CU of the base station, a second message for acknowledging the configuration update for the CU, the second message including a second list of at least one SSB activated based on the first message.

6. The method of claim 5, wherein the first list of the at least one SSB includes an index for each of the at least one SSB to be activated, and wherein the second list of the at least one SSB includes an index for each of the at least one SSB activated based on the first message.

7. The method of claim 5, wherein the first message further includes information for deactivating a cell for energy saving.

8. A first central unit (CU) of a base station in a wireless communication system, the first CU comprising:
a transceiver; and
a controller coupled with the transceiver and configured to:
transmit, to a distributed unit (DU) of the base station, a first message for a configuration update for the CU, the first message including a first list of at least one synchronization signal and physical broadcast channel block (SSB) to be activated, and
receive, from the DU of the base station, a second message for acknowledging the configuration update for the CU, the second message including a second list of at least one SSB activated based on the first message.

9. The first CU of claim 8, wherein the first list of the at least one SSB includes an index for each of the at least one SSB to be activated, and wherein the second list of the at least one SSB includes an index for each of the at least one SSB activated based on the first message.

10. The first CU of claim 8, wherein the first message further includes information for deactivating a cell for energy saving.

11. The first CU of claim 8, wherein the controller is further configured to:
transmit, to a second CU, a third message for a cell activation for the second CU, the third message including a third list of at least one SSB to be activated; and
receive, from the second CU, a fourth message for responding to the cell activation for the second CU, the fourth message including a fourth list of at least one SSB activated based on the third message.

12. A distributed unit (DU) of a base station in a wireless communication system, the DU comprising:
a transceiver; and
a controller coupled with the transceiver and configured to:
receive, from a central unit (CU) of the base station, a first message for a configuration update for the CU, the first message including a first list of at least one synchronization signal and physical broadcast channel block (SSB) to be activated, and
transmit, to the CU of the base station, a second message for acknowledging the configuration update for the CU, the second message including a second list of at least one SSB activated based on the first message.

13. The DU of claim 12, wherein the first list of the at least one SSB includes an index for each of the at least one SSB to be activated, and wherein the second list of the at least one SSB includes an index for each of the at least one SSB activated based on the first message.

14. The DU of claim 12, wherein the first message further includes information for deactivating a cell for energy saving.

15. The DU of claim 12, wherein a third message for a cell activation for another CU is delivered from the CU to the other CU, wherein a fourth message for responding to the cell activation is delivered from the other CU to the CU, and wherein the third message includes a third list of at least one SSB to be activated, and the fourth message includes a fourth list of at least one SSB activated based on the third message.
